(19) United States
(12) Patent Application Publication
(10) Pub. No.: US 2015/0045288 A1
(43) Pub. Date: Feb. 12, 2015

(54) COMPOSITION

(71) Applicant: DuPont Nutrition Biosciences ApS, Copenhagen K (DK)

(72) Inventors: Tina Mygind, Arhus (DK); George H. Weber, Eugene, OR (US); Connie Benfeldt, Beder (DK); Ashley Ann Hibberd, Saint Louis, MO (US); Rebecca Joy Landrum, Antioch, IL (US); Panagiotis Chanos, Tilst (DK); Gregory R. Siragusa, Waukesha, WI (US); Matthew James Hundt, Brookfield, WI (US)

(21) Appl. No.: 14/379,897

(22) PCT Filed: Feb. 20, 2013
(86) PCT No.: PCT/US2013/026830

§ 371 Date: Aug. 20, 2014

Related U.S. Application Data
(60) Provisional application No. 61/601,154, filed on Feb. 21, 2012.

(51) Int. Cl. A01N 63/02; A23L 3/3463; C09D 5/14

(52) U.S. Cl. CPC A01N 63/02; C09D 5/14; A23L 3/34635; A23V 2002/00
USPC 514/2.8; 514/2.4; 514/2.9; 530/329; 530/321; 548/204; 426/532

(57) ABSTRACT

The present invention relates to anti-contaminant composition comprising a cell-free fermentation product of one or more Bacillus subtilis strains (e.g., selected from the group consisting of: 22C-P1, 15A-P4, 3A-P4, LSSA01, ABP278, BS 2084 and BS 18); wherein said fermentation product comprises one or more compounds selected from the group consisting of: a lipopeptide, a polyketide, a bacillibactin, a bacilysin, an anticapsin, a plantazolicin, a LCI, a homologue of a plantazolicin and a homologue of a LCI. In addition, the present invention further relates to methods of preparing the compositions, methods of using the composition, products comprising the composition and uses thereof.

### CLAIM OF PRIORITY

This application claims priority to U.S. Patent Application No. 61/601,154, filed on Feb. 21, 2012, which is incorporated by reference in its entirety.

### FIELD OF THE INVENTION

The present invention relates to anti-contaminant compositions, methods of making same and uses thereof to prevent microbial contamination of products such as foodstuffs, surface coating materials and agricultural products. In particular, the present invention relates to anti-contaminant compositions which comprise a fermentation product of B. subtilis strains such as 22C-P1, 15A-P4, 3A-P4, LSSA01, ABP278, BS 2084 and BS18.

### BACKGROUND OF THE INVENTION

Microbial contaminant of products is a problem in a number of industries.

For example in the paint industry water-based paints are prone to microbial contamination (e.g. spoilage) in the wet-state. Such contamination can result in discoloration, gassing, malodour, viscosity loss, ropiness (i.e. slime) and phase separation in the paint.

In the food, feed and agricultural industries, due to their composition, food, feed, crops and seeds are susceptible to act as a culture medium for microorganisms, and this constitutes a possible risk to human and/or animal health. Thus, such products require protection against microbiological contamination.

Often microbial contaminant occurs by external environmental influences during storage or manipulation.

One conventional way to prevent this has been to use external barriers. These barriers are physical and, in some cases, chemical.

Among physical barriers, other than packaging, plastic polymer and copolymer coatings are used, such as polyvinyl, polyacrylate, polyester, polyamide and polyether coatings, natural and synthetic elastomer and rubber coatings, waxy coatings, cellulosic coatings and hydrocolloidal polymer coatings, such as alginates, carrageenans, xanthan/locust bean gums mixtures, agars, gelatins and pectins.

However, many products e.g., foodstuffs need to exchange humidity or flavours with the environment during storage, such as in some meat and cheese products. For such products the use of non-porous physical barriers is not appropriate. However, when porous barriers are used microorganisms can cross the barrier and proliferate.

Furthermore, in use packaging may be opened and/or removed for a significant period prior to complete consumption or application of the product. For example, in some dried products e.g., dried foodstuffs (such as pet food) the period of time between the user first opening the product and the final consumption may be extended enabling microbes to contaminate the product.

The chemical barriers which have been used to protect such products have been applied on the surface of the product itself, dispersed in a solution or contained in a coating polymer suspension, solution or molten mix, with other components such as pigments, antioxidants, thickenings, oils, jellying agents, solubilizers, emulsifiers, flavours or opacifiers. The coatings are often dried or solidified to be fixed. Some of the chemical compounds used in the chemical barriers are sorbates, benzoates, sulphur-derived compounds, nitrites, nitrates, propionates, lactates, acetates, borates and parabens.

However, there is a need for the use of more natural compounds to prevent the contamination and/or spoilage of products, such as agricultural products, foodstuffs, surface coating materials and emulsions.

### BRIEF DESCRIPTION OF THE DRAWINGS

FIG. 1 shows the effects of pH and different heat treatments on the activity against E. coli for a cell-free fermentate of DCS1579 (B. subtilis strain 22C-P1).

FIG. 2 shows the effects of pH and different heat treatments on the activity against E. coli for a cell-free fermentate of DCS1580 (B. subtilis strain 15A-P4).

FIG. 3 shows the effects of pH and different heat treatments on the activity against E. coli for a cell-free fermentate of DCS1581 (B. subtilis strain 3A-P4).

FIG. 4 shows the effects of pH and different heat treatments on the activity against E. coli for a cell-free fermentate of DCS1582 (B. subtilis strain LSSAO1).

FIG. 5 shows the effects of pH and different heat treatments on the activity against E. coli for a cell-free fermentate of DCS1583 (B. subtilis strain ABP278).

FIG. 6 shows the effects of pH and different heat treatments on the activity against E. coli for a cell-free fermentate of DCS1584 (B. subtilis strain BS18).

FIG. 7 shows the effects of pH and different heat treatments on the activity against L. monocytogenes for a cell-free fermentate of DCS1579 (B. subtilis strain 22C-P1).

FIG. 8 shows the effects of pH and different heat treatments on the activity against L. monocytogenes for a cell-free fermentate of DCS1580 (B. subtilis strain 15A-P4).

FIG. 9 shows the effects of pH and different heat treatments on the activity against L. monocytogenes for a cell-free fermentate of DCS1581 (B. subtilis strain 3A-P4).

FIG. 10 shows the effects of pH and different heat treatments on the activity against L. monocytogenes for a cell-free fermentate of DCS1582 (B. subtilis strain LSSAO1).

FIG. 11 shows the effects of pH and different heat treatments on the activity against L. monocytogenes for a cell-free fermentate of DCS1583 (B. subtilis strain ABP278).

FIG. 12 shows the effects of pH and different heat treatments on the activity against L. monocytogenes for a cell-free fermentate of DCS1584 (B. subtilis strain BS18).

FIG. 13 shows the effects of incubation of fermentates with various enzymes on the activity against E. coli DCS 229, expressed as (%) of residual activity compared to untreated sample.

FIG. 14 shows the effects of incubation of fermentates with various enzymes on the activity against L. mono DCS1081, expressed as (%) of residual activity compared to untreated sample.

FIG. 15 shows the genomic similarity of the draft genomes from B. subtilis strains BS8, 15A-P4, 22C-P1, 3AP-4, and BS2084.

FIG. 16 shows a plot of average optical density (the negative control subtracted) against time of incubation at 30° C.

FIG. 17 shows the extrapolation of x values corresponding to y=0.1 for each one of the curves along with the natural logarithms (lm) of the derived x values plotted against the concentration of sample that each of the curves represents.

FIG. 18 shows a linear correlation of ln(time to reach OD of 0.1) and concentration of sample.

FIG. 19 shows a schematic representation of the method used for assaying different fermentate preparations.

FIG. 20 shows the average activities of fermentates from strain Bacillus DCS1580 against several target microorganisms. Data are derived from three biological replicates of fermentate production. Bars show ±1 SD.

FIG. 21 shows the average activities of fermentate from strain Bacillus DCS1581 against several target microorganisms. Data are derived from three biological replicates of fermentate production. Bars show ±1 SD.

FIG. 22 shows the average activities of fermentate from strain Bacillus DCS1582 against several target microorganisms. Data are derived from three biological replicates of fermentate production. Bars show ±1 SD.

FIG. 23 shows the average activities of fermentate from strain Bacillus DCS1584 against several target microorganisms. Data are derived from three biological replicates of fermentate production. Bars show ±1 SD.

FIG. 24. shows the average activity of the different liquid fermentate preparations following storage at −20° C. for 14 days.

FIG. 25 shows the average activity of the different freeze dried fermentate preparations following storage at 4° C. for 21 days.

FIG. 26 shows the antimicrobial activity of fermentate from Bacillus DCS1580 (F 1580) against an E. coli pool in UHT milk compared to an untreated control sample. Error bars indicate ±1 SD.

FIG. 27 shows the antimicrobial activity of fermentate from Bacillus DCS1580 (F 1580) against a Salmonella spp. pool in UHT milk. Error bars indicate ±1 SD compared to an untreated control sample.

FIG. 28 shows the antimicrobial activity of fermentate from Bacillus DCS1581 (F 1581) against an E. coli pool in UHT milk compared to an untreated control sample. Error bars indicate ±1 SD.

FIG. 29 shows the antimicrobial activity of fermentate from Bacillus DCS1581 (F 1581) against a Salmonella spp. pool in UHT milk compared to an untreated control sample. Error bars indicate ±1 SD.

FIG. 30 shows the antimicrobial activity of fermentate from Bacillus DCS1582 (F1582) against an E. coli pool in UHT milk compared to an untreated control sample. Error bars indicate ±1 SD.

FIG. 31 shows the antimicrobial activity of fermentate from Bacillus DCS1582 (F1582) against a Salmonella spp. pool in UHT milk compared to an untreated control sample. Error bars indicate ±1 SD.

FIG. 32 shows the antimicrobial activity of fermentate from Bacillus DCS1584 (F1584) against an E. coli pool in UHT milk compared to an untreated control sample and freeze dried CASO additive. Error bars indicate ±1 SD.

FIG. 33 shows the antimicrobial activity of fermentate from Bacillus DCS1584 (F1584) against a Salmonella spp. pool in UHT milk compared to an untreated control sample and freeze dried CASO additive. Error bars indicate ±1 SD.

FIG. 34 shows a dendrogram of Salmonella enterica subsp. enterica strains isolated from a pet food facility.

FIG. 35 shows the effect of fermentates from BS18 and 15AP4 on Salmonella enterica subsp. enterica strains isolated from a pet food facility when tested in an inhibition broth assay. Data are shown for 10% v/v and 50% v/v fermentate to target organism culture. Results are presented as a percent inhibition value calculated versus a negative control (no fermentate).

FIG. 36 shows the effect of fermentates from BS18 and 15AP4 on characterised Salmonella enterica subsp. enterica strains implicated in outbreak/recalls of a variety of pet foods when tested in an inhibition broth assay. Data are shown for 10% v/v and 50% v/v fermentate to target organism culture. Results are presented as a percent inhibition value calculated versus a negative control (no fermentate).

FIG. 37 shows the effect of fermentates from 22CP1, LSSA01, 3AP4 and BS2084 on Salmonella enterica subsp. enterica strains isolated from a pet food facility when tested in an inhibition broth assay. Data are shown for 10% v/v and 50% v/v fermentate to target organism culture. Results are presented as a percent inhibition value calculated versus a negative control (no fermentate).

FIG. 38 shows the effect of fermentates from 22CP1, LSSA01, 3AP4 and BS2084 on characterised Salmonella enterica subsp. enterica strains implicated in outbreak/recalls of a variety of pet foods when tested in an inhibition broth assay. Data are shown for 10% v/v and 50% v/v fermentate to target organism culture. Results are presented as a percent inhibition value calculated versus a negative control (no fermentate).

FIG. 39 shows the effect of fermentate from ABP278 on Salmonella enterica subsp. enterica strains isolated from a pet food facility when tested in an inhibition broth assay. Data are shown for 10% v/v and 50% v/v fermentate to target organism culture. Results are presented as a percent inhibition value calculated versus a negative control (no fermentate).

FIG. 40 shows the effect of fermentate from ABP278 on characterised Salmonella enterica subsp. enterica strains implicated in outbreak/recalls of a variety of pet foods when tested in an inhibition broth assay. Data are shown for 10% v/v and 50% v/v fermentate to target organism culture. Results are presented as a percent inhibition value calculated versus a negative control (no fermentate).

FIG. 41 shows the antimicrobial activities against a pool of Salmonella spp of 4 different freeze-dried Bacillus subtilis fermentates (15A-P4 (DCS1580), 3A-P4 (DCS1581), LSSAO1 (DCS1582), and BS18 (DCS1584)), which had been coated onto dog kibbles. This is compared to a negative control in which the dog kibbles had not been coated with a fermentate. The Log₁₀ (CFU/g) reduction of Salmonella spp. is shown over time (days). Error bars indicate ±1 SD.

### SUMMARY OF THE INVENTION

A seminal finding of the present invention is that cell-free fermentation products of B. subtilis strains have exemplary utility to prevent contaminant and/or contamination by microorganisms.

For the first time the present inventors have shown that a cell-free fermentate obtained by culturing any of B. subtilis strains 22C-P1, 15A-P4, 3A-P4, LSSA01, ABP278, BS 2084 and BS18 or combinations thereof has a broad spectrum of activity against Gram-positive bacteria, Gram-negative bacteria and fungi.

A further surprising finding of the present invention is that compounds in the fermentate can be maintained in a metabolically active state during storage.

The present invention is predicated upon the surprising finding that such cell-free fermentates (i.e. isolated from viable bacteria) can be made storage stable and have utility as anti-contaminant compositions in a wide range of applications.

Based on these findings, we provide an anti-contaminant composition which has one or more of the following advantages: it is a natural anti-contaminant composition; it is easy to prepare; it is cost-effective to produce; and/or it has a broad spectrum of anti-contaminant activity.

### STATEMENTS OF THE INVENTION

In a first aspect, the present invention provides an anti-contaminant composition comprising a cell-free fermentation product of one or more Bacillus subtilis strains selected from the group consisting of: 22C-P1, 15A-P4, 3A-P4, LSSA01, ABP278, BS 2084 and BS18.

In a first aspect, the present invention provides an anti-contaminant composition comprising a cell-free fermentation product of one or more Bacillus subtilis strains selected from the group consisting of: 22C-P1, 15A-P4, 3A-P4, LSSA01, ABP278, BS2084 and BS18; wherein said fermentation product comprises one or more compounds selected from the group consisting of: a lipopeptide, a polyketide, a bacillibactin, a bacilysin, an anticapsin, a plantazolicin, a LCI, a homologue of a plantazolicin and a homologue of a LCI.

Advantageously, it has been found that such compositions may have a broad spectrum of inhibitory activity against contaminant microorganisms.

Furthermore, such compositions may be highly desirable in various industries, such as the food industry where consumers are demanding the use of more natural preservatives.

In another aspect, the anti-contaminant compositions of the present invention further comprise one or more additional components, such as carrier, adjuvant, solubilizing agent, suspending agent, diluent, oxygen scavenger, antioxidant or a food material. Suitably, one additional component may be an oxygen scavenger and/or an antioxidant.

Advantageously, the use of an oxygen scavenger and/or antioxidant may increase the storage stability of the anti-contaminant compositions of the present invention and/or may extend the shelf-life of a product to which the anti-contaminant composition is applied.

In one aspect, the anti-contaminant composition of the present invention comprises a plurality of compounds selected from the group consisting of a lipopeptide, a polyketide, a bacillibactin, a bacilysin, an anticapsin, a plantazolicin, a LCI, a homologue of a plantazolicin and a homologue of a LCI.

In one aspect, the anti-contaminant composition of the present invention comprises one or more partially isolated compounds selected from the group consisting of a lipopeptide, a polyketide, a bacillibactin, a bacilysin, an anticapsin, a plantazolicin, a LCI, a homologue of a plantazolicin and a homologue of a LCI.

In another aspect, the cell-free fermentation product or the anti-contaminant compositions of the present invention may be a cell-free fermentate. Advantageously, this aspect may provide a cost-effective and/or easy to produce anti-contaminant composition. Additionally, or in the alternative, this aspect may provide a broad spectrum of inhibitory activity against contaminant microorganisms.

In one aspect, the cell-free fermentation product or the anti-contaminant composition of the present invention may comprise one or more additional anti-contaminant agents.

In one aspect, compositions of the present invention may be effective against one or more of a Gram-negative bacterium, a Gram-positive bacterium or a fungus. Preferably, compositions of the present invention may be effective against a plurality of microorganisms, e.g., microorganisms selected from the group consisting of: Gram-negative bacteria, Gram-positive bacteria and fungi.

In one aspect, a composition of the present invention is effective against one or more Gram-negative bacteria from a genus selected from the group consisting of: Salmonella; Escherichia; Hafnia; Klebsiella; Pseudomonas; Shigella and Yersinia.

In one aspect, a composition of the present invention is effective against one or more of: Salmonella enterica; Escherichia coli; Hafnia alvei; Klebsiella oxytoca; Pseudomonas fluorescens; Pseudomonas putida; Salmonella typhimurium; Shigella flexneri; Shigella sonnei and Yersinia enterocolitica.

In one aspect, a composition of the present invention is effective against a Salmonella enterica strain.

Suitably the composition of the present invention may be effective against one or more of: Salmonella enterica ser. Anatum, Salmonella enterica ser. Braenderup, Salmonella enterica ser. Derby, Salmonella enterica ser. Enteritidis; Salmonella enterica ser. Hadar, Salmonella enterica ser. Infantis; Salmonella enterica ser. Kedougou, Salmonella enterica ser. Mbandaka, Salmonella enterica ser. Montevideo, Salmonella enterica ser. Neumuenster, Salmonella enterica ser. Newport, Salmonella enterica ser. Ohio, Salmonella enterica ser. Schwarzengrund, Salmonella enterica ser. Senftenberg, Salmonella enterica ser. Tennessee, Salmonella enterica ser. Thompson and Salmonella enterica ser. Typhimurium.

Suitably the composition of the present invention may be effective against Escherichia (e.g. Escherichia coli).

Suitably the composition of the present invention may be effective against one or more of: E. coli DCS15 (e.g. E. coli 0157:H7), E. coli DCS 492, E. coli DCS 493, E. coli DCS 494, E. coli DCS 495, E. coli DCS 496, E. coli DCS 497, E. coli DCS 546, E. coli DCS 558, E. coli DCS 1336 and E. coli DCS1396.

In one aspect, a composition of the present invention is effective against one or more Gram-positive bacteria from a genus selected from the group consisting of: Listeria; Bacillus; Brochothrix; Clostridium; Enterococcus; Lactobacillus; Leuconostoc and Staphylococcus.

In one aspect, a composition of the present invention is effective against one or more of: Listeria monocytogenes; Bacillus coagulans spores; Bacillus licheniformis; Bacillus licheniformis spores; Bacillus subtilis spores; Brochothrix thermosphacta; Clostridium perfringens; Clostridium sporogenes spores; Enterococcus faecalis; Enterococcus gallinarum; Lactobacillus farciminis; Lactobacillus fermentum; Lactobacillus plantarum; Lactobacillus sakei; Leuconostoc mesenteroides; Listeria innocua; Staphylococcus aureus and Staphylococcus epidermidis.

In one aspect, a composition of the present invention is effective against one or more fungi from a genus selected from the group consisting of: Aspergillus; Candida; Debaryomyces; Kluyveromyces; Penicillium; Pichia; Rhodotorula; Saccharomyces and Zygosaccharomyces.

In one aspect, a composition of the present invention is effective against one or more of: Aspergillus parasiticus; Aspergillus versicolor; Candida parapsilosis; Candida tropicalis; Citrobacter freundii; Debaryomyces hansenii; Kluyveromyces marxianus; Penicillium commune; Pichia anomala; Rhodotorula glutinis; Rhodotorula mucilaginosa; Saccharomyces cerevisiae and Zygosaccharomyces bailiff.

In one aspect, a composition of the present invention is in a solid, semi-solid, liquid, or gel form, such as, for example, tablets, pills, capsules, powders, liquids, suspensions, dispersions, or emulsions.

In one aspect, a composition of the present invention is sealed.

In one aspect, a composition of the present invention is hermetically sealed.

In another aspect, the present invention provides a method of producing an anti-contaminant composition comprising:
a) culturing one or more bacteria comprising at least one Bacillus subtilis strain selected from the group consisting of: 22C-P1, 15A-P4, 3A-P4, LSSA01, ABP278, BS 2084 and BS18, on, or in a substrate to produce a fermentate comprising at least one anti-contaminant compound, such as a compound selected from the group consisting of a lipopeptide, a polyketide, a bacillibactin, a bacilysin, an anticapsin, a plantazolicin, a LCI, a homologue of a plantazolicin and a homologue of a LCI; and
b) separating and/or inactivating viable cells.

Suitably, bacterial spores may also be separated from the fermentate and/or inactivated.

Suitably, culturing of the B. subtilis strains in accordance with the present invention may be carried out at a pH in the pH range of 5 to 9.

In addition or in the alternative, the pH of the fermentation product may be adjusted to a pH in the range of pH 6 to 10.

Surprisingly, it has been found that culturing or storing the anti-contaminant composition of the present invention at neutral and or alkaline pH increases the storage stability of the anti-contaminant composition and/or stabilises the anti-contaminant activity of the composition.

In one aspect, the fermentate may undergo one or more (further) separation and/or isolation steps to produce a supernatant of the fermentate or a fraction or component thereof. Suitably the fraction or component thereof may comprise at least one compound selected from the group consisting of: a lipopeptide, a polyketide, a bacillibactin, a bacilysin, an anticapsin, a plantazolicin, a LCI, a homologue of a plantazolicin and a homologue of a LCI.

In another aspect, at least one compound selected from the group consisting of: a lipopeptide, a polyketide, a bacillibactin, a bacilysin, an anticapsin, a plantazolicin, a LCI, a homologue of a plantazolicin and a homologue of a LCI is isolated and/or purified. Suitably, a plurality of the compounds may be isolated and/or purified.

Suitably, the composition of the present invention may comprise 2 or more, suitably 3 or more, suitably 4 or more of the compounds a lipopeptide, a polyketide, a bacillibactin, a bacilysin, an anticapsin, a plantazolicin, a LCI, a homologue of a plantazolicin and a homologue of a LCI.

In one aspect, the culturing step is at a temperature in the temperature range of about 10 to about 55° C.

In one aspect, a substrate for the culture comprises any suitable nutrient media that allow growth of the bacteria. For example, a substrate may comprise, non-fat dry milk, vegetables (e.g., corn potatoes, cabbage), starch, grains (e.g., rice, wheat, barley, hops), fruit (e.g., grapes, apples, oranges), sugar, sugarcane, meat (e.g., beef, poultry, pork, sausage), heart infusion, cultured dextrose, combinations thereof, and media containing proteins, carbohydrates, and minerals necessary for optimal growth.

In another aspect, a substrate for the culture may comprise any one of the following: a carbohydrate, a peptone, a phosphate, a salt, a buffering salt or combinations thereof.

By way of example only, the substrate for the culture may comprise TSB or CASO medium (e.g. CASO broth) or a combination thereof.

In one embodiment the substrate for the culture is CASO medium, suitably CASO broth.

In one aspect, the substrate may include one or more of starch, soy, yeast extracts and salts.

In one aspect, culturing is carried out using a plurality of Bacillus subtilis strains selected from the group consisting of: 22C-P1, 15A-P4, 3A-P4, LSSA01, ABP278, BS 2084 and BS18.

In one aspect, the culture may comprise one or more additional bacteria.

In one aspect, the culturing step is carried out for about 1 to about 48 hours.

In one aspect, the method for producing an anti-contaminant composition in accordance with the present invention comprises the addition of an oxygen scavenger and/or an antioxidant.

Examples of antioxidants include: ascorbic acid, polyphenols, vitamin E, beta-carotene, rosemary extract, mannitol and BHA.

In one aspect, the method for producing an anti-contaminant composition of the present invention comprises the step of sealing (preferably hermetically sealing) the fermentate or supernatant, fraction or component thereof, e.g. in a container such as a package. The container e.g. package may also comprise a compound which scavenges oxygen.

In one aspect, the present invention relates to anti-contaminant compositions produced by a method of the present invention.

In another aspect, the present invention relates to a method of preventing and/or reducing microbial contaminant of a product comprising the step of contacting at least one constituent of the product, the product per se and/or the packaging of the product with an anti-contaminant composition according to the present invention or prepared by a method according to the present invention.

The term “product” as used herein includes: foodstuffs (such as meat products, animal feed and pet food); surface coating material (such as paint), and agricultural products (such as crops and seeds).

In one aspect, a constituent of the product or the product per se is admixed with an anti-contaminant composition of the present invention.

In another aspect, the anti-contaminant composition of the present invention is applied to the surface of a product, a constituent thereof and/or the packaging of a product.

In one aspect, the method of preventing and/or reducing microbial contamination of a product of the present invention results in the prevention and/or reduction of microbial contamination by one or more of a Gram-positive bacteria, a Gram-negative bacteria or a fungus.

In one aspect, the method of preventing and/or reducing microbial contamination of a product of the present invention results in the prevention and/or reduction of microbial contamination by at least one Gram-positive bacteria, at least one Gram-negative bacteria and at least one fungus.

In another aspect, the present invention relates to a product comprising an anti-contaminant composition of the present invention or a product prepared in accordance with the present invention and/or a product having reduced microbial contaminant as a result of carrying out a method of the present invention.

In one aspect, an anti-contaminant composition in accordance with the present invention is a crop protectant or is formulated as a crop protectant, e.g. a fungicide or bactericide.

In another aspect, the present invention relates to the use an anti-contaminant composition in accordance with the present invention to prevent microbial contamination of a product.

Suitably, the product is any one of the following: The term “product” as used herein includes: foodstuffs (such as meat products, animal feed and pet food); surface coating materials (such as paint), and agricultural products (such as crops, seeds and the like).

In yet another aspect, the present invention relates to a method for screening for an anti-contaminant composition effective against a contaminant microorganism or contaminant microorganisms of interest comprising:
a) culturing one or more bacteria comprising at least one Bacillus subtilis strain selected from the group consisting of: 22C-P1, 15A-P4, 3A-P4, LSSA01, ABP278, BS 2084 and BS18 on, or in, a substrate to produce a fermentation product;
b) separating and/or inactivating viable cells and, optionally, spores;
c) testing the antimicrobial activity of the fermentation product against a contaminant microorganism of interest; and
d) selecting a fermentation product which has antimicrobial activity against the contaminant microorganism of interest;
   wherein step b) can occur prior to, during, and/or after steps c) and d).

Such a method may also comprise one or more (further) separation and/or isolation steps.

In one aspect, an anti-contaminant composition or the fermentation product or the cell-free fermentation product is considered effective against a contaminant microorganism(s) if following the “Plate Diffusion Assay” protocol taught herein an inhibition zone/halo of at least 2 mm is observed.

In another aspect, an anti-contaminant composition or the fermentation product or the cell-free fermentation product is considered effective against a contaminant microorganism(s) if it has at least about 20% inhibition in the “Inhibition Broth Assay” taught herein.

In another aspect, an anti-contaminant composition or the fermentation product or the cell-free fermentation product is considered effective against a contaminant microorganism(s) if it has an effective concentration of at least about 100% (v/v) when measured by the “Effective Concentration Assay” taught herein.

In another aspect, an anti-contaminant composition or the fermentation product or the cell-free fermentation product is considered effective against a microorganism if it has more than one, preferably all three, of the following activities: if following the “Plate Diffusion Assay” protocol an inhibition zone of at least 2 mm is observed; at least about 20% inhibition in the “Inhibition Broth Assay”; an effective concentration of at least about 100% (v/v) measured by the “Effective Concentration Assay”.

In one embodiment the fermentation product of the present invention may comprise an analogue of the one or more compounds selected from the group consisting of: a lipopeptide, a polyketide, a bacillibactin, a bacilysin, an anticapsin, a plantazolicin and a LCI.

Suitably the analogue may be an analogue of one or more of the compounds selected from the group consisting of: a lipopeptide, a polyketide, a bacillibactin, a bacilysin, an anticapsin. In one embodiment the fermentation product of the present invention may comprise a homologue of the one or more compounds selected from the group consisting of: a lipopeptide, a polyketide, a bacillibactin, a bacilysin, an anticapsin, a plantazolicin and a LCI. Suitably the homologue may be a homologue of one or more of the compounds selected from the group consisting of: a plantazolicin (microcin), and a LCI.

In one embodiment, the Bacillus subtilis strain used in the present invention is 22C-P1. Thus suitably the anti-contaminant composition may comprise a cell-free fermentation product of Bacillus subtilis 22C-P1. The cell-free fermentation product of Bacillus subtilis 22C-P1 may comprise one or more compounds selected from the group consisting of: a lipopeptide, a polyketide, a bacillibactin, a bacilysin, an anticapsin, a plantazolicin, a LCI, a homologue of a plantazolicin and a homologue of a LCI.

In one embodiment, the Bacillus subtilis strain used in the present invention is 15A-P4. Thus suitably the anti-contaminant composition may comprise a cell-free fermentation product of Bacillus subtilis 15A-P4. The cell-free fermentation product of Bacillus subtilis 15A-P4 may comprise one or more compounds selected from the group consisting of: a lipopeptide, a polyketide, a bacillibactin, a bacilysin, an anticapsin, a plantazolicin, a LCI, a homologue of a plantazolicin and a homologue of a LCI.

In one embodiment, the Bacillus subtilis strain used in the present invention is 3A-P4. Thus suitably the anti-contaminant composition may comprise a cell-free fermentation product of Bacillus subtilis 3A-P4. The cell-free fermentation product of Bacillus subtilis 3A-P4 may comprise one or more compounds selected from the group consisting of: a lipopeptide, a polyketide, a bacillibactin, a bacilysin, an anticapsin, a plantazolicin, a LCI, a homologue of a plantazolicin and a homologue of a LCI.

In one embodiment, the Bacillus subtilis strain used in the present invention is LSSA01. Thus suitably the anti-contaminant composition may comprise a cell-free fermentation product of Bacillus subtilis LSSA01. The cell-free fermentation product of Bacillus subtilis LSSA01 may comprise one or more compounds selected from the group consisting of: a lipopeptide, a polyketide, a bacillibactin, a bacilysin, an anticapsin, a plantazolicin, a LCI, a homologue of a plantazolicin and a homologue of a LCI.

In one embodiment, the Bacillus subtilis strain used in the present invention is ABP278. Thus suitably the anti-contaminant composition may comprise a cell-free fermentation product of Bacillus subtilis ABP278. The cell-free fermentation product of Bacillus subtilis ABP278 may comprise one or more compounds selected from the group consisting of: a lipopeptide, a polyketide, a bacillibactin, a bacilysin, an anticapsin, a plantazolicin, a LCI, a homologue of a plantazolicin and a homologue of a LCI.

In one embodiment, the Bacillus subtilis strain used in the present invention is BS2084. Thus suitably the anti-contaminant composition may comprise a cell-free fermentation product of Bacillus subtilis BS2084. The cell-free fermentation product of Bacillus subtilis BS2084 may comprise one or more compounds selected from the group consisting of: a lipopeptide, a polyketide, a bacillibactin, a bacilysin, an anticapsin, a plantazolicin, a LCI, a homologue of a plantazolicin and a homologue of a LCI.

In one embodiment, the Bacillus subtilis strain used in the present invention is BS18. Thus suitably the anti-contaminant composition may comprise a cell-free fermentation product of Bacillus subtilis BS18. The cell-free fermentation product of Bacillus subtilis BS18 may comprise one or more compounds selected from the group consisting of: a lipopeptide, a polyketide, a bacillibactin, a bacilysin, an anticapsin, a plantazolicin, a LCI, a homologue of a plantazolicin and a homologue of a LCI.

In one embodiment, the fermentation product comprises a lipopeptide (e.g. a surfactin, a bacilomycin (e.g. bacillomycin D), a fengycin or combinations thereof).

In one embodiment, the fermentation product comprises a polyketide (e.g. a difficidin, a macrolactin, a Bacillaene or combinations thereof).

In one embodiment, the fermentation product comprises a bacillibactin.

In one embodiment, the fermentation product comprises a bacilysin.

In one embodiment, the fermentation product comprises an anticapsin.

In one embodiment, the fermentation product comprises a plantazolicin.

In one embodiment, the fermentation product comprises a LCI.

In one embodiment, the fermentation product comprises a homologue of a plantazolicin.

In one embodiment, the fermentation product comprises a homologue of a LCI.

In one embodiment, the present invention provides an anti-contaminant composition comprising a cell-free fermentation product of one or more Bacillus subtilis strains selected from the group consisting of: LSSA01, ABP278, BS2084 and BS18; wherein said fermentation product comprises one or more compounds selected from the group consisting of: a lipopeptide, a polyketide, a bacillibactin, a bacilysin, an anticapsin, a plantazolicin, a LCI, a homologue of a plantazolicin and a homologue of a LCI.

In one embodiment, a lipopeptide of the present invention is selected from the group consisting of: a surfactin, a bacilomycin (e.g. bacillomycin D), a fengycin or combinations thereof.

In another embodiment, a polyketide of the present invention is selected from the group consisting of: a difficidin, a macrolactin, a bacillaene or combinations thereof.

### DETAILED DISCLOSURE OF THE PREFERRED EMBODIMENTS OF THE INVENTION

Unless defined otherwise, all technical and scientific terms used herein have the same meaning as commonly understood by one of ordinary skill in the art to which this disclosure belongs. Singleton, et al., DICTIONARY OF MICROBIOLOGY AND MOLECULAR BIOLOGY, 20 ED., John Wiley and Sons, New York (1994), and Hale & Marham, THE HARPER COLLINS DICTIONARY OF BIOLOGY, Harper Perennial, NY (1991) provide one of skill with a general dictionary of many of the terms used in this disclosure.

This disclosure is not limited by the exemplary methods and materials disclosed herein, and any methods and materials similar or equivalent to those described herein can be used in the practice or testing of embodiments of this disclosure. Numeric ranges are inclusive of the numbers defining the range.

The headings provided herein are not limitations of the various aspects or embodiments of this disclosure which can be had by reference to the specification as a whole. Accordingly, the terms defined immediately below are more fully defined by reference to the specification as a whole.

Other definitions of terms may appear throughout the specification. Before the exemplary embodiments are described in more detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within this disclosure. The upper and lower limits of these smaller ranges may independently be included or excluded in the range, and each range where either, neither or both limits are included in the smaller ranges is also encompassed within this disclosure, subject to any specifically excluded limit in the stated range. Where the stated range includes one or both of the limits, ranges excluding either or both of those included limits are also included in this disclosure.

It must be noted that as used herein and in the appended claims, the singular forms “a”, “an”, and “the” include plural referents unless the context clearly dictates otherwise. Thus, for example, reference to “a fermentation product” includes a plurality of such candidate agents and reference to “the feed” includes reference to one or more feeds and equivalents thereof known to those skilled in the art, and so forth.

The publications discussed herein are provided solely for their disclosure prior to the filing date of the present application. Nothing herein is to be construed as an admission that such publications constitute prior art to the claims appended hereto.

The term “cell-free fermentation product” as used herein means a composition which results from culturing (e.g. fermenting) one or more of B. subtilis strains 22C-P1, 15A-P4, 3A-P4, LSSA01, ABP278, BS2084 and BS18 in a suitable media once some or all of the bacterial cells (including preferably spores) have been removed and/or in activated; or a supernatant or a fraction or a component thereof. In one aspect, the cell-free fermentation product comprises at least one or more metabolites selected from the group consisting of a lipopeptide, a polyketide, a bacillibactin, a bacilysin, an anticapsin, a plantazolicin, a LCI, a homologue of a plantazolicin and a homologue of a LCI. Suitably, the compound(s) is/are a metabolite(s) of the bacteria being cultured (e.g. fermented).

In one embodiment, the anti-contaminant composition is a cell-free fermentation product. For example, the anti-contaminant composition of the present invention may simply be a fermentate which has been modified to remove and/or to inactivate bacterial cells to provide a cell-free fermentate.

As used herein the term “fermentate” refers to the mixture of constituents present following (e.g. at the end of) the culturing of one or more of B. subtilis strains 22C-P1, 15A-P4, 3A-P4, LSSA01, ABP278, BS 2084 and BS18. Hence, the term “fermentate” as used herein can include one or more anti-contaminant compounds (such as a lipopeptide (e.g. a surfactin, a bacilomycin (e.g. bacillomycin D), a fengycin or combinations thereof), a polyketide (e.g. a difficidin, a macrolactin, a bacillaene or combinations thereof), a bacillibactin, a bacilysin, an anticapsin, a plantazolicin, a LCI, a homologue of a plantazolicin and a homologue of a LCI) as well as other components such as particulate matter, solids, substrates not utilised during culturing, debris, media, cell waste, etc. In one aspect, bacterial cells (and, preferably, spores) are removed from the fermentate and/or inactivated to provide a cell-free fermentate.

The term “cell-free” as used herein means that the fermentation product (preferably the fermentate) is substantially free of viable bacterial cells, typically containing less than about 10⁵ viable bacterial cells/mL fermentation product, less than about 10⁴ viable bacterial cells/mL fermentation product, less than about 10³ viable bacterial cells/mL fermentation product, less than about 10² viable bacterial cells/mL fermentation product, or less than about 10 viable bacterial cells/mL fermentation product. Preferably, the fermentation product is substantially free of cells, typically containing less than about 10⁵ cells/mL fermentation product, less than about 10⁴ cells/mL fermentation product, less than about 10³ cells/mL fermentation product, less than about 10² cells/mL fermentation product, or less than about 10 cells/mL fermentation product.

Suitably, the fermentation product (preferably the fermentate) may be substantially free of viable bacterial cells, typically containing less than about 10² viable cells/mL fermentation product.

Suitably, the fermentation product (preferably the fermentate) may be substantially free of viable bacterial cells, typically containing less than about 10 viable cells/mL fermentation product.

Suitably, the fermentation product (preferably the fermentate) may be substantially free of viable bacterial cells, typically containing zero (or substantially) viable cells/mL fermentation product.

In some aspects, the term “cell-free” means that the fermentation product is substantially free of viable spores in addition to viable cells, typically containing less than about 10⁵ viable spores/mL fermentation product, less than about 10⁴ viable spores/mL fermentation product, less than about 10³ viable spores/mL fermentation product, less than about 10² viable spores/mL fermentation product, or less than about 10 viable spores/mL fermentation product. Preferably, the fermentation product is substantially free of spores, typically containing less than about 10⁵ spores/mL fermentation product, less than about 10⁴ spores/mL fermentation product, less than about 10³ spores/mL fermentation product, less than about 10² spores/mL fermentation product, or less than about 10 spores/mL fermentation product.

Suitably, the fermentation product (preferably the fermentate) may be substantially free of viable spores, typically containing less than about 10² viable spores/mL fermentation product.

Suitably, the fermentation product (preferably the fermentate) may be substantially free of viable spores, typically containing less than about 10 viable spores/mL fermentation product.

Suitably, the fermentation product (preferably the fermentate) may be substantially free of viable spores, typically containing zero (or substantially zero) viable spores/mL fermentation product.

In one aspect, the term “cell-free” as used herein means that the fermentation product (preferably the fermentate) is substantially free of viable bacterial cells and viable spores, typically containing less than about 10⁵ viable bacterial cells and viable spores/mL fermentation product, less than about 10⁴ viable bacterial cells and viable spores/mL fermentation product, less than about 10³ viable bacterial cells and viable spores/mL fermentation product, less than about 10² viable bacterial cells and viable spores/mL fermentation product, or less than about 10 viable bacterial cells and viable spores/mL fermentation product. Preferably, the fermentation product is substantially free of cells and/or spores, typically containing less than about 10⁵ cells and/or spores/mL fermentation product, less than about 10⁴ cells and/or spores/mL fermentation product, less than about 10³ cells and/or spores/mL fermentation product, less than about 10² cells and/or spores/mL fermentation product, or less than about 10 cells and/or spores/mL fermentation product.

Suitably, the fermentation product (preferably the fermentate) may be substantially free of viable bacterial cells and viable spores, typically containing less than about 10² viable cells and/or viable spores/mL fermentation product.

Suitably, the fermentation product (preferably the fermentate) may be substantially free of viable bacterial cells and viable spores, typically containing less than about 10 viable cells and/or viable spores/mL fermentation product.

Suitably, the fermentation product (preferably the fermentate) may be substantially free of viable bacterial cells and viable spores, typically containing zero (or substantially zero) viable cells and/or viable spores/mL fermentation product.

In some aspects, the fermentation product (preferably the fermentate) of the present invention may be treated (e.g. heat treated or irradiated) so that no cells, or spores, or combinations thereof, remain viable.

The term “viable” as used herein means a microbial cell or spore which is metabolically active or able to differentiate. Thus spores are “viable” when they are dormant and capable of germinating.

The terms “anti-contaminant composition” and “anti-contaminant agent” as used herein refers to any composition/agent which, in use, can counter (i.e. work in opposition to, hinder, oppose, reduce, prevent or inhibit) the growth of pathogenic microorganism and/or which can, in use, counter (e.g. reduce or prevent or inhibit) the spoilage (preferably microbial spoilage) of a product. Thus, an “anti-contaminant” may be anti-pathogenic and/or anti-spoilage. In some aspects, an “anti-contaminant composition” may be a shelf-life extending composition.

The term “contaminant” as used herein means any microorganism, such as a pathogenic microorganism and spoilage microorganism. In one aspect, the term “contaminant” refers to a pathogenic microorganism and/or a spoilage microorganism.

The term “spoilage microorganism” refers to a microorganism which can cause detrimental changes in appearance, flavour, odour, and other qualities of the product, preferably which results from microbial growth. The “spoilage microorganism” may be present at any point in the lifetime of a product, for example, originating from one or more of the following: the environment from which the product was obtained and/or the microbiological quality of the product in its raw or unprocessed state (e.g. native to the product) and/or any handling and/or processing steps and/or the effectiveness/ineffectiveness of packaging and/or storage conditions of the product.

The term “pathogenic microorganism” refers to a microorganism which is capable of causing disease in a human and/or an animal. The “pathogenic microorganism” may be present at any point in the lifetime of a product, for example, originating from one or more of the following: the environment from which the product was obtained and/or the microbiological quality of the product in its raw or unprocessed state (e.g. native to the product) and/or any handling and/or processing steps and/or the effectiveness/ineffectiveness of packaging and/or storage conditions of the product.

The term “inhibit” as used herein means to destroy, prevent, control, decrease, slow or otherwise interfere with the growth or survival of a contaminant microorganism when compared to the growth or survival of the contaminant microorganism in the absence of an anti-contaminant agent/composition. In one aspect, to “inhibit” is to destroy, prevent, control, decrease, slow or otherwise interfere with the growth or survival of a contaminant microorganism by at least about 5% to at least about 100%, or any value in between for example at least about 10%, 15%, 20%, 25%, 30%, 35%, 40%, 45%, 50%, 55%, 60%, 65%, 70%, 75%, 80%, 85%, 90%, 95%, 99%, or 100% when compared to the growth or survival of the contaminant microorganism in the absence of anti-contaminant agent/composition. In another aspect, to “inhibit” is to destroy, prevent, control, decrease, slow or otherwise interfere with the growth or survival of a contaminant microorganism by at least about 1-fold or more, for example, about 1.5-fold to about 100-fold, or any value in between for example by at least about 2.0, 2.5, 3.0, 3.5, 4.0, 4.5, 5.0, 5.5, 6.0, 6.5, 7.0, 7.5, 8.0, 8.5, 9.0, 9.5, 10, 15, 20, 25, 30, 35, 40, 45, 50, 55, 60, 65, 70, 75, 80, 85, 90, 95-fold when compared to the growth or survival of the contaminant microorganism in the absence of anti-contaminant agent/composition.

The term “reducing” as used herein in relation to microbial contaminant means that the level of microbial growth and/or speed at which a product spoils is reduced when compared to a control product to which no anti-contaminant or anti-microbial has been applied. In one aspect, the terms “reduce” and “reducing” may be used interchangeably with the terms “inhibit” and “inhibiting”.

In one aspect, the term “preventing” as used herein means the microbial contamination of a product which comprises an anti-contaminant composition of the present invention or a product to which an anti-contaminant composition of the present invention is applied has an extended shelf-life and/or increased time frame before a specified amount of contaminant is present. In one embodiment, shelf-life and/or time frame is extended and/or increased when compared to a control product which does not have an anti-contaminant composition or anti-microbial applied.

For example, when the contaminant is a pathogenic microorganism (e.g. a pathogen bacterium) the “specified amount of contaminant” may be the level at which a product is deemed not to be safe for use by, for example, the FDA. In some instances, depending on the pathogenic microorganism, the specified amount of contaminant may be zero. This may be the case when the pathogenic microorganism is Listeria spp. for example. In other instances, the specified amount of contaminant may be less than about 100 CFU/g or ml or less than about 10 CFU/g or ml, such as when the pathogenic bacteria is e.g., E. coli spp.

When the contaminant is a non-pathogenic spoilage bacteria the “specified amount of contaminant” may be the level at which the organoleptic conditions are no longer acceptable or the level at which the consumer visualises the spoilage of the product. The specified amount may be dependent on the microorganism. However, in some instances, it may be the presence of e.g., 10³ or 10⁴ CFU/g or CFU/ml.

### Strains

At least one Bacillus (e.g., Bacillus subtilis) strain is used to generate the fermentation product for use in the composition, methods and uses disclosed herein. Suitably, at least one strain may be a B. subtilis strain selected from the group consisting of 3A-P4 (PTA-6506); 15A-P4 (PTA-6507); 22C-P1 (PTA-6508); LSSA01 (NRRL-B-50104); BS27 (NRRL B-50105); BS18 (NRRL B-50633); BS 2084 (NRRL B-500130) and ABP 278 (NRRL B-50634).

There has been some suggestion in the prior art that B. subtilis strains 3A-P4 (PTA-6506); 15A-P4 (PTA-6507); 22C-P1 (PTA-6508); LSSA01 (NRRL-B-50104); BS27 (NRRL B-50105); BS18 (NRRL B-50633); BS 2084 (NRRL B-500130) and ABP 278 (NRRL B-50634) may be reclassified as B. amyloliquefaciens subspecies plantarum. For the avoidance of doubt, should any of these strains be reclassified to B. amyloliquefaciens such strain(s) are still encompassed by the present invention.

Strains 3A-P4 (PTA-6506), 15A-P4 (PTA-6507) and 22C-P1 (PTA-6508) are publically available from American Type Culture Collection (ATCC).

Strains BS 2084 (NRRL B-500130) and LSSA01 (NRRL-B-50104) are publically available from the Agricultural Research Service Culture Collection (NRRL). Strain Bacillus subtilis LSSA01 is sometimes referred to as B. subtilis 8 or BS8.

These strains are taught in U.S. Pat. No. 7,754,469 B2.

Bacillus subtilis BS18 and Bacillus subtilis BS 278 were deposited by Andy Madisen of W227 N752 Westmound Dr. Waukesha, Wis. 53186, USA or Danisco USA Inc. of W227 N752 Westmound Dr. Waukesha, Wis. 53186, USA under the Budapest Treaty at the Agricultural Research Service Culture Collection (NRRL) at 1815 North University Street, Peoria, Ill. 61604, United States of America, under deposit numbers NRRL B-50633 and NRRL B-50634, respectively on 9 Jan. 2012. Strain BS 278 is also referred to herein as ABP 278.

Andy Madisen of W227 N752 Westmound Dr. Waukesha, Wis. 53186, USA and Danisco USA Inc. of W227 N752 Westmound Dr. Waukesha, Wis. 53186, USA authorise DuPont Nutrition Biosciences ApS (formerly Danisco A/S) of Langebrogade 1, PO Box 17, DK-1001, Copenhagen K, Denmark to refer to these deposited biological materials in this patent application and have given unreserved and irrevocable consent to the deposited material being made available to the public.

In one aspect, a plurality of Bacillus subtilis strains are used to generate the fermentation product for use in the composition, methods and uses disclosed herein. Suitably, the plurality of B. subtilis strains may be selected from the group consisting of 3A-P4 (PTA-6506); 15A-P4 (PTA-6507); 22C-P1 (PTA-6508); LSSA01 (NRRL-B-50104); BS27 (NRRL B-50105); BS18 (NRRL B-50633); BS 2084 (NRRL B-500130) and ABP 278 (NRRL B-50634).

Suitably, two or more B. subtilis strains may be used. Suitably at least two of the B. subtilis strains used include any one of the combinations detailed in the table below:

| B. subtilis | Bs 8 | Bs | Bs | ABP | | |
|---|---|---|---|---|---|---|
| strain | LSSAO1 | 3A-P4 | 15A-P4 | 278 | Bs 18 | Bs 22C-P1 |
| Combination | X | X | | | | |
| to be used | X | | X | | | |
| | X | | | X | | |
| | X | | | | X | |
| | X | | | | | X |
| | | X | X | | | |
| | | X | | X | | |
| | | X | | | X | |
| | | X | | | | X |
| | | | X | X | | |
| | | | X | | X | |
| | | | X | | | X |
| | | | | X | X | |
| | | | | X | | X |
| | | | | | X | X |

Suitably, three or more, four or more, or five or more, or all six of the following B. subtilis strains may be used: 3A-P4 (PTA-6506); 15A-P4 (PTA-6507); 22C-P1 (PTA-6508); LSSA01 (NRRL-B-50104); BS27 (NRRL B-50105); BS18 (NRRL B-50633); BS 2084 (NRRL B-500130) and ABP 278 (NRRL B-50634).

Suitably, one or more of the following B. subtilis strains may be used: LSSA01 (NRRL-B-50104); BS27 (NRRL B-50105); BS18 (NRRL B-50633); BS 2084 (NRRL B-500130) and ABP 278 (NRRL B-50634).

In some aspects, additional bacterial and/or fungal strains may be used in the culturing of the fermentation product. In some aspects, no additional bacterial and/or fungal strains may be used in the culturing of the bacterial product.

### Culturing of Strains to Produce the Fermentate

The strain or strains may be cultured under conditions conducive to the production of one or more compounds of interest.

The medium used to cultivate the cells may be any conventional medium suitable for growing the Bacillus strain in question and obtaining a fermentation product comprising a compound of interest.

The culturing can take place with, on, or in the presence of one or more substrates (e.g. a fermentable substrate).

A fermentable substrate is a material that contains an organic compound such as a carbohydrate that can be transformed (i.e., converted into another compound) by the enzymatic action of a bacterium as disclosed herein.

Examples of substrates include, but are not limited to, non-fat dry milk, vegetables (e.g., corn potatoes, cabbage), starch, grains (e.g., rice, wheat, barley, hops), fruit (e.g., grapes, apples, oranges), sugar, sugarcane, meat (e.g., beef, poultry, pork, sausage), heart infusion, cultured dextrose, combinations thereof, and the like and suitable media containing proteins, carbohydrates, and minerals necessary for optimal growth. A non-limiting exemplary medium is TSB or CASO broth

In one aspect, the substrate may include one or more of starch, soy, yeast extracts and salts.

In one aspect, the growth medium may be CASO broth. In another aspect, the growth medium may be TSB broth.

The culturing of a B. subtilis strain can take place for any suitable time conducive to produce a compound of interest. For example, the culturing can take place from about 1 to about 72 hours (h), from about 5 to about 60 h, or from about 10 to about 54 h or from 24 to 48 h. In one aspect the culturing can suitably take place for about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 42, 48, 54, 60 h, where any of the stated values can form an upper or lower endpoint when appropriate. In another aspect, the time for culturing can be greater than or equal to about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60 h. In yet another aspect, the time for culturing can be less than or equal to about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60 6 h. In still another aspect, suitably the culturing occurs for approximately 24 to 48 hours.

Suitably the culturing occurs for approximately 20 to 30 hours.

In one aspect, the culturing can be carried out until nutrient depletion (preferably complete nutrient) occurs.

In one aspect, the culturing is for a time effective to reach the stationary phase of growth of the bacteria.

The temperature during the culturing can be from about 20 to about 55° C. from about 25 to about 40° C., or from about 30 to about 35° C. In one aspect, the temperature during the culturing can be from about 20 to about 30° C. from about 30 to about 40° C., or from about 40 to about 50° C. In another aspect, the culturing can take place at a temperature of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, or 55° C., where any of the stated values can form an upper or lower endpoint when appropriate. In still another aspect, the culturing can take place at a temperature greater than or equal to about, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, or 55° C. In yet another aspect, the culturing can take place at a temperature less than or equal to about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, or 55° C.

In one aspect the culturing can occur from about 30 to about 35° C. In a further aspect, the culturing can occur at about 32° C.

In one aspect, the culturing preferably may take place under aeration. Suitably the level of the aeration is controlled. Aeration levels may be expressed as dissolved oxygen tension (DOT), wherein DOT is a percentage of oxygen saturation in the culture, (e.g. 100% DOT means a culture is fully saturated with oxygen). DOT may be measured as taught in Suresh et al. “Techniques for oxygen transfer measurement in bioreactors: a review” J Chem Technol Biotechnol 2009; 84: 1091-1103 (and references therein), which is incorporated herein by reference, or as taught in Bailey J, Bailey J, 011 is D, “Biochemical Engineering Fundamentals”, 2^{nd} edition, McGraw-Hill, ISBN 0070032122 (and references therein) which is incorporated herein by reference.

Suitably, culturing does not take place under conditions at which oxygen content is limiting. Suitably the level of the aeration is such that the oxygen content in the culture is more than about 20% DOT, more than about 30% DOT, more than about 40% DOT, more than about 50% DOT, more than about 60% DOT, more than about 70% DOT, more than about 80% DOT or more than about 90% DOT. In some aspects the level of aeration is such that the level of the aeration in the culture is about 100% DOT.

Suitably, the level of aeration is such that the oxygen content in the culture may be between about 25% and 50% DOT.

The aeration may be provided by any suitable method.

In some embodiments the aeration may be provided by any means that mixes air with the culture. Thus the aeration may be provided by agitation (e.g. shaking, oscillation, stirring etc.) or by passing air (e.g. oxygen) through the culture media, for example, or combination thereof.

The rate of aeration expressed as vvm (the volume of gas per liquid volume per minute) may be measured as taught in Bailey J, Bailey J, 011 is D, “Biochemical Engineering Fundamentals”, 2^{nd} edition, McGraw-Hill, ISBN 0070032122 (and references therein), which is incorporated herein by reference, for example.

In some embodiments the aeration rate may be in the range of about 0.1 to about 6 vvm. Where the aeration is provided by agitation (e.g. in a stirred fermentor) then the aeration rate may be in the range of about 0.1 to about 3 vvm. Where the aeration is provided by passing air through the culture media (e.g. in an airlift fermentor) then the aeration rate may be in the range of about 3 to about 6 vvm.

In one embodiment, a culture container which is designed or shaped to support or provide aeration may be used. Suitably, the culture container may comprise one or more baffles. The aim of the baffles may be to encourage exposure of the media to oxygen (e.g. air). For example, a culture container with baffles may be used in combination with shaking or oscillation of the culture container. By way of example only the culture container may be the container described in U.S. Pat. No. 7,381,559 (the subject matter of which is incorporated herein by reference).

Suitably, the culture medium may be agitated. This may be affected by any conventional means. Without wishing to be bound by theory, agitation of a culture medium may have a number of beneficial effects when compared to a non-agitated culture medium, including but not limited to: increased growth and/or decreased cell clumping and/or increased nutrient (e.g. carbohydrate) mixing and/or better nutrient distribution and/or increased protein production and/or increased primary metabolite production and/or increased secondary metabolite production etc. In one aspect, the beneficial effects derived from agitating a culture medium may result from the creation of turbulence within the culture medium (e.g. by stirring). In one embodiment the agitation may be stirring. In another embodiment the agitation may be shaking or oscillation.

In one aspect the culture media is agitated by oscillation (e.g. by rotatory shaking). Suitably the speed of rotation may be at about 50 to about 250 rpm, about 60 rpm to about 240 rpm, about 70 rpm to about 230 rpm, about 80 rpm to about 220 rpm, about 80 rpm to about 210 rpm, or about 90 rpm to about 200 rpm.

Suitably the speed of rotation may be at about 100 rpm to about 150 rpm.

Suitably the speed of rotation may be at about 130 rpm.

Preferably the culture medium is agitated in order to increase the level of aeration in the culture media and/or increase nutrient mixing in the culture media.

It has been found that aeration and/or agitation of the culture mixture may result in significant improvements in the fermentate produced. Without wishing to be bound by theory, this improvement may be caused by ensuring the cell density or cell mass in the culture container is such that the protein yield and/or primary metabolite production by the bacteria is enhance in the fermentate.

In one aspect, the culture media may be agitated by stirring. The speed of stirring may suitably be greater than about 50 rpm, for example between about 50 rpm to about 1200 rpm.

The rate at which the culture media may be stirred may be dependent upon the container in which it is held for culturing purposes. If the container comprising the culture media is a small fermentor (e.g. less than 500 L, such as about 100 to about 500 L or even less than 20 L), then the speed of stirring may be at at least about 100 rpm to about 1200 rpm, for example. In some aspects the speed of stirring may be greater than about 1200 rpm. If the container comprising the culture media is an industrial scale fermentor (e.g. great than 500 L, such as about 500 to about 20,000 L), then the speed of stirring may be at least about 50 rpm to about 150 rpm or may be greater than about 150 rpm, for example.

In another aspect, agitation of a culture media during culturing may be represented as power input by agitation, for example. Power input by agitation is a representation of the amount of energy provided per litre of liquid volume. The power input by agitation can be calculated by first determining the power in Newton using the following formula:

P₀=N₀ρN³D⁵

where: N₀ is a dimensionless number (Newton number); ρ is the density of the liquid (kg/m³); N (s⁻¹) is the rotational frequency and D is the impeller diameter (m). P₀ is the power drawn by an agitator when the culture is not aerated. Calculation of power input by agitation in the presence of aeration is taught in Olmos et al. “Effects of bioreactor hydrodynamics on the physiology of Streptomyces”, Bioprocess Biosyst Eng, 2012 Aug. 25 and references therein, which is incorporated herein by reference.

In one aspect, during culturing the power input by agitation per volume may be at least about 0.25 kW/m³.

Suitably, power input by agitation per volume may be in the range of about 0.25 kW/m³ to about 6 kW/m³.

In another aspect, the power input by agitation per volume may be in the range of about 0.25 kW/m³ to about 3 kW/m³.

In another aspect, the culture volume to the container volume may be less than about 1:1 v/v, e.g. 1:2, 1:3, etc.

In some aspects, the ratio of the culture volume to the container volume may be less than about 1:1 v/v, 1:2 v/v, 1:3 v/v, 1:4 v/v, 1:5 v/v, 1:6 v/v, 1:7 v/v, 1:8 v/v, 1:9 v/v, or 1:10 v/v.

In some aspects, the ratio of the culture volume to the container volume may be in the range of about 1:1 v/v to about 1:10 v/v, suitably in the range of 1:3 v/v to about 1:7 v/v.

In some aspects, the ratio of the culture volume to the container volume may be about 1:1 v/v, 1:2 v/v, 1:3 v/v, 1:4 v/v, 1:5 v/v, 1:6 v/v, 1:7 v/v, 1:8 v/v, 1:9 v/v or 1:10 v/v.

Suitably, the ratio of the culture volume to the container volume may be about 1:5 v/v.

In one aspect, the volume of culture may be less than about 100%, less than about 90%, less than about 80%, less than about 70%, less than about 60%, less than about 50%, less than about 40% or less than about 30% that of the container volume, for example.

In another aspect, the volume of the culture may be in the range of about 60% to about 90% that of the container volume, for example.

Suitably, the volume of the culture may be in the range of about 70% to about 85% that of the container volume, for example.

The pH during the culturing can be at a pH from about 5 to about 9, from about 5 to about 6, from about 6 to about 7, from about 7 to about 8, or from about 8 to about 9. In another aspect, the culturing can take place at a pH of about 5, 6, 7, 8, 9, where any of the stated values can form an upper or lower endpoint when appropriate. In one aspect, the pH is at a pH between about 7 and about 8, from about 7 to about 7.5, from about 7.1 to about 7.3 during the culturing. In one aspect, the culturing is at about pH 7.3.

Alternatively, or in addition, the pH may be adjusted after culturing to a pH from about 6 to about 10, or from about 8 to about 10, or from about 9 to 10. Suitably, the pH may be adjusted from about pH 8 to about pH 9. Suitably, the pH may be adjusted to about pH 9. In some aspects, an alkali may be used to increase the pH. Suitably, potassium hydroxide (KOH) may be used.

Suitably, the pH is adjusted after separation of the bacterial cells and culture media (e.g. by centrifugation). Suitably it is the pH of the supernatant which is adjusted.

In one aspect, the culturing step comprises one or more adjustments of the culture conditions (such as an adjustment of pH, temperature and/or substrate) during the culturing phase. Without wishing to be bound by theory, adjusting the culture conditions (e.g. pH, temperature and/or substrate) during the culturing may increase the number of compounds of interest produced during the culturing process. For example, the initial culture conditions may be conducive to produce one compound of interest and the adjustment of the culture conditions may provide favourable conditions to produce a further compound of interest.

Thus, for example, during the culturing process an initial pH of about pH 5 may produce one compound of interest. Subsequent adjustment of the pH to pH 7 during the same culturing process may result in the production of a further compound of interest.

Batch and continuous culturing are known to a person of ordinary skill in the art. The fermentation product of the present invention or a portion thereof comprising compound(s) of interest may be prepared using batch or continuous culturing. Suitably, the fermentation product or a portion thereof may be harvested during or at the end of the culturing process

In one aspect, the fermentation product of the present invention is harvested during or at the end of the exponential phase. In one aspect, the fermentation product of the present invention is harvested at or during the stationary phase.

In one aspect of the present invention, the fermentation product may be produced in a vat under commercial conditions.

The fermentation product of the present invention may be harvested at a suitable time point to increase the yield of a particular compound of interest in the fermentation product. For example, without wishing to be bound by theory, when the Bacillus strains are cultured in complex media, harvesting at the end of the exponential phase of the culture may result in a fermentation product having an optimal amount or one or more compounds of interest such as e.g. a Bacilysin.

In one aspect, the anti-contaminant composition of the present invention may be harvested when the anti-contaminant composition or cell-free fermentation product (e.g. at least one sample thereof) results in an inhibition zone/halo of at least about 2 mm observed when measured by the “Plate Diffusion Assay”. The “Plate Diffusion Assay” is that defined in the section entitled ““Plate Diffusion Assay” Protocol” herein. Suitably, the anti-contaminant composition may be harvested when the anti-contaminant composition (e.g. at least one sample thereof) results in an inhibition zone/halo of at least about 3, 4, 5, 6, 7, 8, 9, 10, 11, 12, 13, 14, 15, 16, 17, 18, 19 or 20 mm observed when measured by the “Plate Diffusion Assay”.

In one aspect, the anti-contaminant composition of the present invention may be harvested when the anti-contaminant composition or cell-free fermentation product (e.g. at least one sample thereof) has at least about 20% inhibition in the “Inhibition Broth Assay”. The “Inhibition Broth Assay” is that defined in the section entitled ““Inhibition Broth Assay” Protocol” herein. Suitably, the anti-contaminant composition may be harvested when the anti-contaminant composition (e.g. at least one sample thereof) has at least about 30%, at least about 40%, at least about 50%, at least about 60%, at least about 70%, at least about 80%, at least about 90% or 100% inhibition in the “Inhibition Broth Assay”.

In another aspect, the anti-contaminant composition of the present invention may be harvested when the anti-contaminant composition or cell-free fermentation product (e.g. at least one sample thereof) has an effective concentration of at least about 100% (v/v) when measured by the “Effective Concentration Assay”. The “Effective Concentration Assay” is that defined in the section entitled ““Effective Concentration Assay” Protocol” in Example 8 herein. Suitably, the anti-contaminant composition may be harvested when the anti-contaminant composition (e.g. at least one sample thereof) has an effective concentration of at least about 100% (v/v), at least about 90% (v/v), at least about 80% (v/v), at least about 70% (v/v), at least about 60% (v/v), at least about 50% (v/v),at least about 40% (v/v), at least about 30% (v/v), at least about 20% (v/v) or at least about 10% (v/v) when measured by the “Effective Concentration Assay”. Suitably, the anti-contaminant composition (e.g. at least one sample thereof) may have an effective concentration of less than about 10% (v/v) when measured by the “Effective Concentration Assay”.

In one aspect the anti-contaminant composition of the present invention may be harvested when more than one (preferably all three) of the following is observed: the anti-contaminant composition results in an inhibition zone/halo of at least about 2 mm to be observed when measured by the “Plate Diffusion Assay”; the anti-contaminant composition has at least about 20% inhibition in the “Inhibition Broth Assay”; or the anti-contaminant composition has an effective concentration of at least about 100% (v/v) when measured by the “Effective Concentration Assay”.

In one aspect, the culture is agitated and/or stirred during culturing (e.g. during fermentation).

In one aspect, the level of oxygenation is monitored and/or controlled during the culturing.

An example of culture conditions conducive to produce a compound of interest are provided in Examples 1, 8, 9 and 10.

Separating One or More Cells and/or Spores from the Fermentation Product

In one aspect, one or more cells and/or one or more spores) may be separated from the fermentation product (e.g., fermentate). Such separation may be achieved by any means known in the art including by centrifuging and/or filtering. For example, the fermentation product can be filtered (one or several times in a multistep process) to remove such components as particulate matter, cells, spores and the like. Alternatively or in addition, one or more cells and/or one of more spores may be separated from the fermentation product (e.g. fermentate) by centrifugation, thus producing a supernatant. Depending on the speed and duration of the centrifugation, the supernatant can be cell free (i.e., a cell-free supernatant) or the supernatant can contain cells, which can be filtered or further centrifuged to provide a cell-free supernatant.

In one aspect, the method of separation is or includes centrifugation.

Centrifugation is well known in the art. Centrifugation may be carried out at, for example, about 5,000 rpm, 10,000 rpm, 15,000 rpm, 20,000 rpm, 25,000 rpm, or 30,000 rpm. In one aspect, the speed of the centrifugation can be at least about 5,000 rpm.

Suitably, centrifugation may be carried out between about 5,000 rpm to between about 15,000 rpm.

In one aspect, centrifugation may be carried out at about 5,000×g to about 15,000×g, or at about 10,000×g to about 20,000×g.

Suitably, centrifugation may be carried out at about 9,000×g to about 12,000×g. Suitably, at about 11,000×g to about 14,000×g.

The time of centrifugation can be from about 5 minutes to 1 h, from about 10 minutes to about 45 minutes, or about 30 minutes. In one aspect, the time of the centrifugation is at least about 10 minutes, or at least about 15 minutes.

Suitably, the time of centrifugation can be from about 20 to 40 minutes.

In another aspect the time of centrifugation can be from about 5 to about 15 minutes.

In some aspects, centrifugation is performed two or more times, using either the same or different centrifugation conditions.

In one aspect, one or more cells and/or one or more spores can be separated from the fermentate or supernatant (e.g., after centrifugation), by filtration. Various filters can be used to filter the fermentate or a supernatant containing cells and/or spores. For example, a microfilter with a pore size of from about 0.01 to about 1 μm, from about 0.05 to about 0.5 μm, or from about 0.1 to about 0.2 μm. In another aspect, the filter can have a pore size of about 0.01, 0.02, 0.03, 0.04, 0.05, 0.06, 0.07, 0.08, 0.09, 0.1, 0.2, 0.3, 0.4, 0.5, 0.6, 0.8, 0.9, or 1 μm, where any of the stated values can form an upper or lower endpoint when appropriate. In yet another aspect, the filter can have a pore size of greater than or equal to about 0.01, 0.02, 0.03, 0.04, 0.05, 0.06, 0.07, 0.08, 0.09, 0.1, 0.2, 0.3, 0.4, 0.5, 0.6, 0.8, 0.9, or 1 μm. In still another aspect, the filter can have a pore size of less than or equal to about 0.01, 0.02, 0.03, 0.04, 0.05, 0.06, 0.07, 0.08, 0.09, 0.1, 0.2, 0.3, 0.4, 0.5, 0.6, 0.8, 0.9, or 1 μm. In a further aspect, the filter can have a pore size of about 0.2 μm, such as is available from Millipore (Billerica, Mass.). The fermentate can, in one aspect, be filtered with a sterilizing filter.

In one aspect, the fermentate or supernatant may be filtered, e.g. with a sterilizing filter. Suitably, the filter (e.g. the sterilizing filter) may have a pore size of about 0.1 μm to about 0.3 μm. Suitably, the filter may have a pore size of about 0.2 μm. The resultant product may be considered a cell-free fermentation product in accordance with the present invention.

Suitably the anti-contaminant composition or cell-free fermentate in accordance with the present invention may be freeze-dried. Freeze-drying can be carried out by any suitable freeze-drying procedure. Freeze-drying may be carried out for between about 1 hour to about 10 days, between about 1 days to about 8 days, suitably between about 1 day to about 5 days.

In one aspect the method for culturing the strain or strains to obtain the cell-free fermentation product and/or the anti-contaminant composition of the present invention comprises the steps:
(a). inoculating any suitable liquid growth medium (e.g. CASO broth) with a strain or strains in accordance with the present invention (e.g. wherein the ratio of the volume of liquid growth medium to the volume of the container is between about 1:1 v/v to about 1:7 v/v) and incubating at about 25° C. to about 40° C., e.g. 32° C. (suitably for about 20 to about 35 hours, e.g. 24 hours), with aeration (e.g. rotary shaking at 100 rpm to about 150 rpm);
(b). centrifuging the composition of step (a) at least once (e.g. between about 9,000×g to about 12,000×g or between about 11,000×g to about 14,000×g for between about 20 minutes to about 40 minutes or between about 5,000 rpm to about 15,000 rpm for between about 5 minutes to about 15 minutes) to obtain a supernatant;
(c). adjusting the pH of the supernatant in step (b) to between about pH 8 to about pH 10, e.g. pH 9, for example by the addition of an alkali (e.g. KOH); and
(d). adding between about 600 ppm to about 900 ppm of an antioxidant to the supernatant of step (c), wherein the pH of the supernatant is between about pH 7 and pH 10;
(e). filtering (e.g. filter sterilizing) the supernatant of step (d);
(f). freeze-drying the resultant product (e.g. the cell-free fermentation product) of step (e);
wherein steps (c), (d) and (f) may be optional and step (d) may be performed before step (c).

Other steps which may be optional in any method according to the present invention may be as follows:
(a). reviving the strain or strains in or on any suitable growth medium, e.g. incubating the strain or strains on any suitable agar aerobically at between about 30° C. to about 35° C. for between about 20 to about 35 hours (for example, this may be necessary if the strain or strains are stored as a frozen stock);
(b). inoculating one or more colonies of the strain or strains of step (a) in any suitable liquid growth medium (suitably the ratio of the volume of growth medium to the volume of the container is between about 1:3 v/v to about 1:7 v/v);
(c). incubating the culture of step (b) at about 25° C. to about 40° C. for about 20 to about 35 hours with aeration (e.g. rotary shaking at about 100 rpm to about 150 rpm); and
(d). using this culture or a portion thereof as a starter culture (e.g. to induce the bacterial growth in a different (e.g. larger) culture or culture container).
   Inactivating One or More Cells and/or Spores

Methods for the inactivation of viable cells are well known in the art and include heat-treatment and irradiation. Any known means for inactivating viable cells may be employed provided that they would not also inactivate the compound or compounds of interest in accordance with the present invention.

In one aspect, inactivation of viable cells can be achieved using heat-treatment. Suitable methods of heat treatment are known in the art and include the following conditions:
LTLT pasteurization (e.g. 63° C. for 30 minutes);
HTST pasteurization (e.g. 72-75° C. for 15-20 seconds or >80° C. for 1-5 seconds);
Ultra pasteurization (e.g. 125-138° C. for 2-4 seconds);
UHT flow sterilization (e.g. 135-140° C. for 1-2 seconds), and
Sterilization in a container (e.g. 115-120° C. for 20-30 minutes).

Such methods of heat treatment may be combined with vacuum or reduced pressure.

In one aspect, inactivation of spores may be achieved using heat treatment such as using the UHT flow sterilization or Sterilization in a container conditions provided above.

Separation and/or inactivation of spores may be by filter sterilization of the culture supernatant after centrifugation and discharge of the pellet containing the cells and spores.

Alternatively or additionally, double pasteurization could be used. For example, this could comprise a first pasteurisation step (e.g. using the UHT flow sterilization or Sterilization in a container conditions provided above), incubation of a product at a temperature and for a time which induces spore germination; and a second pasteurization to heat inactivate the new vegetative forms of cells.

### Compounds of Interest

The strain or strains may be cultured under conditions conducive to the production of one or more compounds of interest.

The term “compounds of interest” in this context refers to any compound having an anti-contaminant effect. “Compounds of interest” include a lipopeptide (e.g. a surfactin, a bacilomycin (e.g. bacillomycin D), a fengycin or combinations thereof), a polyketide (e.g. a difficidin, a macrolactin, a bacillaene or combinations thereof), a bacillibactin, a bacilysin, an anticapsin, a plantazolicin, a LCI, a homologue of a plantazolicin and a homologue of a LCI

By way of example, “compounds of interest” may include non-ribosomal peptides, polyketides and ribosome dependent compounds including the following compounds: a difficidin, a surfactin, a bacillomycin (e.g. bacillomycin D), a fengycin, a bacillibactin, a bacilysin, an anticapsin, a plantazolicin (microcin) a macrolactin, a bacillaene and a LCI, or a homologue thereof or an analogue thereof. In some aspects, the compounds of interest are a difficidin, a surfactin, a bacillomycin (e.g. bacillomycin D), a fengycin, a bacillibactin, a bacilysin, an anticapsin, a plantazolicin (microcin) a macrolactin, a bacillaene and a LCI, or a homologue thereof or an analogue thereof.

The term “analogue”, as used herein, is a compound having a structure similar to one or more of the compounds selected from the group consisting of: a difficidin, a surfactin, a bacillomycin (e.g. a bacillomycin D), a fengycin, a bacillibactin, a bacilysin, an anticapsin, a plantazolicin (microcin), a macrolactin, a bacillaene, a LCI, but differing from said compound(s) in one or more atoms, functional groups, or substructures. In one embodiment, the one or more atoms, functional groups, or substructures may be replaced with one or more different atoms, groups (e.g. functional groups), or substructures. In one embodiment, the analogue is an anti-contaminant agent (e.g. an anti-microbial agent). Suitably, the analogue has the same or similar or better anti-contaminant activity compared with the compound of which it is an analogue.

In one embodiment, the analogue is an analogue of a non-ribosomal peptide (e.g. a surfactin, a bacillomycin (e.g. bacillomycin D), a fengycin, a bacillibactin, a bacilysin, or an anticapsin) and/or polyketide (e.g. a difficidin, a macrolactin or a bacillaene).

In another embodiment, the analogue is an analogue of a ribosomal dependent compound (e.g. a plantazolicin, or a LCI).

A plantazolicin analogue, for example, refers to a peptide having structure similar to a plantazolicin and/or a peptide having structure overlapping plantazolicin, for example: a peptide having one or more amino acids deleted, substituted, or added from plantazolicin; a peptide having one or more amino acids conservatively substituted from the amino acids of plantazolicin; a modified form of plantazolicin; a fragment of plantazolicin having plantazolicin activity; and an elongated plantazolicin having plantazolicin activity etc.

A LCI analogue, for example, refers to a peptide having structure similar to a LCI and/or a peptide having structure overlapping a LCI, for example: a peptide having one or more amino acids deleted, substituted, or added from a LCI; a peptide having one or more amino acids conservatively substituted from the amino acids of a LCI; a modified form of a LCI; a fragment of a LCI having a LCI activity; and an elongated LCI having LCI activity etc.

In one aspect, the fermentation product and/or anti-contaminant composition comprises a compound(s) of interest present in a range of about 50 ppm to about 1000 ppm, from about 75 to about 950 ppm, or from about 100 to about 900 ppm wherein the recited values are for each compound of interest or for the combined total of compounds of interest. In one aspect, the fermentation product and/or anti-contaminant composition comprises one or more compounds of interest present at an amount of 50, 60, 70, 80, 90, 100, 110, 120, 130, 140, 150, 160, 170, 180, 190, 200, 210, 220, 230, 240, 250, 300, 350, 400, 450, 500, 550, 600, 650, 700, 750, 800, 850, 900, 950 or 1000 ppm where any of the stated values can form an upper or lower endpoint when appropriate and wherein the recited values are for each compound of interest or for the combined total of compound(s) of interest. In still another aspect, the fermentation product and/or anti-contaminant composition comprises one or more compounds of interest present at an amount of 50, 60, 70, 80, 90, 100, 110, 120, 130, 140, 150, 160, 170, 180, 190, 200, 210, 220, 230, 240, 250, 300, 350, 400, 450, 500, 550, 600, 650, 700, 750, 800, 850, 900, 950 or 1000 ppm, wherein the recited values are for each compound of interest or for the combined total of compounds of interest.

In one aspect, the culture conditions produce from about 2 to 11 or from about 2 to about 8 or from 2 to 4 compounds of interest. In one aspect the culture conditions produce greater than or equal to about 1, 2, 3, 4, 5, 6, 7, 8, 9, 10, 11 compounds of interest. In yet another aspect, the culture conditions produce less than or equal to about 1, 2, 3, 4, 5, 6, 7, 8, 9, 10, 11 compounds of interest.

In one aspect, a difficidin is produced and/or the fermentation product comprises a difficidin.

Suitably, the strain or strains may be cultured under conditions which result in the production of a plurality of compounds of interest.

In one aspect, the culture conditions are effective to produce at least one compound of interest having anti-contaminant activity against a Gram-negative bacterium. In one aspect, the culture conditions are effective to produce at least one compound of interest having anti-contaminant activity against a Gram-positive bacterium. In one aspect, the culture conditions produce at least one compound of interest having anti-contaminant activity against a fungus.

Suitably the compound(s) of interest either alone or in combination may have a broad spectrum of activity against Gram-positive bacteria, Gram-negative bacteria, fungi and combinations thereof.

A compound of interest has (or compounds of interest have) a “broad spectrum of activity” if either alone or combined they have anti-contaminant activity against one or more microorganisms from greater than or equal to about 2, 3, 4, 5, 6, 7, 8, 9, 10, 11, 12, 13, 14, 15, 20, 25, 30, 35, 40, 45, 50 or 60 different genera. Alternatively or in addition, as used herein a compound(s) of interest has/have “a broad spectrum of activity” if used either alone or combined they have anti-contaminant activity against a Gram-negative bacterium and a Gram-positive bacterium; or a Gram-negative bacterium and a fungus; or a Gram-positive bacterium and a fungus; or a Gram-positive bacterium and a Gram-negative bacterium and a fungus.

In one aspect, a compound of interest has anti-contaminant activity against a microorganism if following the “Plate Diffusion Assay” protocol an inhibition zone/halo of at least about 2, 3, 4, 5, 6, 7, 8, 9, 10, 11, 12, 13, 14, 15, 16, 17, 18, 19 or 20 mm is observed.

In one aspect, a compound of interest has anti-contaminant activity against a microorganism if it has at least about 20% inhibition activity in the “Inhibition Broth Assay”. Suitably, a compound of interest has anti-contaminant activity against a microorganism if at least about 30%, at least about 40%, at least about 50%, at least about 60%, at least about 70%, at least about 80%, at least about 90% or 100% inhibition is observed.

In one aspect, a compound of interest has anti-contaminant activity against a microorganism if it has an effective concentration of at least about 100% (v/v) measured by the “Effective Concentration Assay”. Suitably, a compound of interest has anti-contaminant activity against a microorganism it has an effective concentration of at least about 100% (v/v), at least about 90% (v/v), at least about 80% (v/v), at least about 70% (v/v), at least about 60% (v/v), at least about 50% (v/v), at least about 40% (v/v), at least about 30% (v/v), at least about 20% (v/v) or at least about 10% (v/v) measured by the “Effective Concentration Assay”. Suitably, a compound of interest may have anti-contaminant activity against a microorganism if it has an effective concentration of less than about 10% (v/v) measured by the “Effective Concentration Assay”.

Suitably, a compound of interest has anti-contaminant activity against a microorganism if it has more than one, preferably all three, of the following activities: if following the “Plate Diffusion Assay” protocol an inhibition zone of at least 2 mm is observed; at least about 20% inhibition in the “Inhibition Broth Assay”; an effective concentration of at least about 100% (v/v) measured by the “Effective Concentration Assay”.

Compositions and/or fermentation product of the present invention comprise at least one compound of interest. In one aspect, the “compound” or “compound of interest” may be a difficidin, a surfactin, a bacillomycin (e.g. bacillomycin D), a fengycin, a bacillibactin, a bacilysin, an anticapsin, a plantazolicin (microcin), a macrolactin, a bacillaene, a LCI or a homologue thereof or an analogue thereof, or any combination thereof.

In one aspect, the composition and/or fermentation product referred to herein comprises at least one non-ribosomal peptide (NRP) and/or the method of culturing a B. subtilis strain taught herein is conducive to produce at least one NRP. Examples of NRPs include: a surfactin, a bacillomycin D, a fengycin, a bacillibactin and a bacilysin, an anticapsin, or a homologue thereof or an analogue thereof. In this aspect, any combination of NRPs may be used.

Advantageously, NRPs may have a broad spectrum of activity against contaminant microorganisms.

Advantageously, it has surprisingly been found that B. subtilis strains 15A-P4, 2C-P1, 3A-P4 and LSSA01 can produce the following NRPs: a surfactin, a bacillomycin D, a fengycin, a bacillibactin and a bacilysin, an anticapsin e.g. under appropriate culture conditions.

In one aspect, the composition and/or fermentation product of the present invention comprises at least 1, 2, 3, 4, 5, or 6 NRPs and/or the method of culturing a B. subtilis strain may produce at least 1, 2, 3, 4, 5, or 6 NRPs.

In one aspect, the compound of interest may be a lipopeptide. As used herein “lipopeptide” includes compounds with cyclic structure consisting of a β-amino or β-hydroxy fatty acid and a peptide moiety. The amino-acid sequence and the branching of the fatty acids can group lipopeptides into 3 families—the surfactin family, the iturin A family (including lipopeptides like bacilomycin and mycosubtilin) and the fengycin family (Romero et al., 2007).

Surfactins are biosurfactants and exhibit general, broad spectrum antimicrobial activity. For example, a surfactin may have utility against bacteria (Gram+/−), fungi, and viruses. Peypoux et al., (1999) discloses information regarding the genetics, chemical and the emulsifying properties of surfactins.

Iron and manganese may have a stimulatory effect on the production of a surfactin (Cooper et al., 1981). Different fermentation media compositions have been examined through the years for the optimization of production reviewed by Peypoux et al., (1999) with limited success. In contrast oxygen limitation seemed to boost the production of a surfactin in a defined minimum medium (Kim et al., 1997).

A bacillomycin D is part of the iturin family having mainly anti-fungal activity. It is hemolytic and may also have some antibacterial activity.

Fengycins may be specifically active against filamentous fungi and may inhibit phospholipase A2. Fengycins may work synergistically with a bacillomycin D against fungi.

Bacilysins have a broad spectrum of antibacterial activity (Gram+/−) and also have some anti-yeast activity (e.g. against Candida albicans). A bacilysin is an antimicrobial di-peptide which has been reported to have an antimicrobial activity against Staph. aureus, Staph. epidermidis, Micrococcus tetragenus NCTC7501, Corynebacterium xerosis NCTC7243, Bacillus megatherium de Bary, Sarcina lutea NCTC 8340, Salm. typhi, Salm. gallinarum, Ser. marcescens and Proteus vulgaris NCTC 4636 and Candida albicans. On minimal agar E. coli was highly sensitive to a bacilysin (Kenig & Abraham, 1976). Tests against phytopathogenic bacteria revealed that crude bacilysin is also active against Saccharomyces cereviciae (Loeffler et al., 1986).

In one aspect, the composition and/or fermentation product referred to herein comprises at least one polyketide and/or the method of culturing a B. subtilis strain taught herein may produce at least one polyketide. Examples of polyketides include: a difficidin, a macrolactin and a bacillaene. In this aspect, any combination of polyketides may be used.

Advantageously, polyketides may have a broad spectrum of activity against contaminant microorganisms.

Advantageously, it has also surprisingly been found that B. subtilis strains 15A-P4, 2C—P1, 3A-P4, 2084 and LSSA01 can all produce a difficidin, a macrolactin and a bacillaene.

In one aspect, the composition and/or fermentation product of the present invention comprises at least 1, 2 or 3 polyketides and/or the method of culturing a B. subtilis strain may produce at least 1, 2 or 3 polyketides.

A bacillaene may be a broad-spectrum inhibitory substance that inhibits prokaryotic protein biosynthesis (bacteriostatic). A bacillaene is a polyene inhibitory substance, found in 1995 in fermentation broth from Bacillus subtilis. Its nominal molecular weight was calculated to 580 Da and its empirical formula was C₃₅H₄₈O₇. A bacillaene is active against a broad range of bacteria but not against Candida albicans which differentiates it from Bacilysins. Its activity against E. coli is bacteriostatic (Patel et al., 1995). Bacillaenes may be an extremely labile compound (Butcher et al., 2007).

A difficidin is a broad-spectrum inhibitory substance that inhibits prokaryotic protein biosynthesis (bacteriostatic). It may be used to inhibit Erwinia amylovara (which causes fire blight disease in apple, pear, and rosaceous plants). A difficidin is a triene macrolide (C₃₁H₄₉O₆P) has a molecular weight of 544 Da and m/z of 688.3471 as calculated by EI-MS (Wilson et al., 1987). A difficidin was found to be active against a broad range of Gram-positive and Gram-negative aerobic and anaerobic bacteria (Wilson et al., 1987; Zimmerman et al., 1987). With regards to its physicochemical properties, difficidin is sensitive to pH, temperature and oxygen. In 50% ethanol solutions difficidin had a t₉₀ (time at which 90% of the inhibitory substance remains as tested by HPLC) of 2 hours at pH 3.5 and 17 hours at pH 11 at room temperature. The inhibitory substance undergoes isomerisation at elevated temperatures but the process is reversible while the isomeric forms themselves are significantly less potent. It is also sensitive to air oxidation, particularly when stored as solids.

A macrolactin is also a bacteriostatic antibacterial and an anti-viral. Without wishing to be bound by theory it may work by inhibiting cell division of a contaminant microorganism. Macrolactins are polyene macrolides with a 24 membered lactone ring (Gustafson et al., 1989). More than 18 different macrolactins have been isolated and chemically characterized. They are considered to originate mostly from marine bacteria. A review of the biological activities of different macrolactins has been published by Lu et al., (2008). Based on the limited data available on their antimicrobial potency, macrolactins have been shown to be effective against Staphylococcus aureus and Bacillus subtilis. Macrolactins V and W have been reported to possess significant antibacterial activity and macrolactin T antifungal activity (Mojid Mondol et al., 2011).

In one aspect, the composition and/or fermentation product referred to herein comprises at least one ribosome dependent compound of interest (such as a plantazolicin and/or a LCI) and/or the method of culturing a B. subtilis strain taught herein may produce at least one ribosome dependent compound of interest (such as a plantazolicin and/or a LCI). The structure of the LCI protein family is taught in Gong et al Biochemistry 2011, 50 (18) pp 3621-3627 which is herein incorporated by reference. A LCI as referred to herein may be any protein in the LCI protein family. The plantazolicin may be a microcin, such as microcin B17 (as taught in Scholz et al J. Bacteriol. 2011, January: 193(1): 215-24, which is incorporated herein by reference), or a plantazolicin A or a plantazolicin B (for example as taught in Kalyon et al Org. Lett. 20111, June 17; 13(12), 2996-9).

In one aspect, the composition and/or fermentation product referred to herein comprises one or more of bacilysin or anticapsin. Without wishing to be bound by theory, Bacillus subtilis produces the antibiotic anticapsin as an L-ala-L anticapsin dipeptide precursor known as bacilysin.

In one aspect, composition and/or fermentation product referred to herein comprises at least two or more (i.e. a plurality) of types of compounds of interest selected from the group consisting of: NRPs, polyketides and ribosome dependent compounds. In addition or in the alternative, the method of culturing a B. subtilis strain taught herein is conducive to produce two or more (i.e. a plurality) of types of compounds of interest selected from the group consisting of: NRPs, polyketides and ribosome dependent compounds.

Any combination of compounds of interest is envisioned. A person of ordinary skill in the art can as a matter of routine adapt the culture conditions for the B. subtilis strains taught herein to produce the required combination of compounds of interest in one or more fermentates.

Thus, advantageously, a person of ordinary skill in the art can adapt the culture conditions such that compounds of interest having activity against contaminant organisms applicable to the desired application are produced. For example, in one aspect, if anti-contaminant composition is to be formulated as an anti-contaminant protectant for orchards, a person of ordinary skill in the art may wish to adapt the culture conditions such that they produce a difficidin to protect e.g., apple and pears trees from Erwinia amylovara.

In one aspect, a compound of interest in accordance with the present invention includes ribosomally synthesized compounds such as bacteriocins and other Bacteriocin-Like Substances (BLIS). Bacteriocins from Bacillus spp. are divided into 3 classes, in general following the classification scheme of bacteriocins from lactic acid bacteria. Therefore post-translationally modified peptides belong to class I and non post-translationally modified peptides to class II. A third class of Bacillus bacteriocins contains the big protein complexes. For a review on the known and characterized bacteriocins from Bacillus spp up to date, see Abriouel et al., (2011).

In one aspect, a ribosomally synthesized compound is not a “compound of interest” in accordance with the present invention.

In another aspect, bacteriocin is not a “compound of interest” in accordance with the present invention. In one aspect the anti-contaminant composition and/or the cell-free fermentation product does not comprise bacteriocin.

In one aspect, compound(s) of interest in a fermentation product (e.g. fermentate) may be partially isolated and/or purified.

Suitably, the partial isolation or purification of a compound of interest may comprise the use of catalase and/or lysozyme.

### Contaminant Microorganisms

In one aspect, the contaminant microorganisms may be a Gram-negative bacterium, a Gram-positive bacterium or a fungus. In some aspects, the contaminant microorganisms may be a plurality of microorganisms, e.g., microorganisms selected from the group consisting of: Gram-negative bacteria, Gram-positive bacteria and fungi.

In another aspect, the contaminant microorganisms may be one or more Gram-negative bacteria from a genus selected from the group consisting of: Salmonella; Escherichia; Hafnia; Klebsiella; Pseudomonas; Shigella and Yersinia.

In one aspect, the contaminant microorganisms may be one or more of: Salmonella enterica; Escherichia coli; Hafnia alvei; Klebsiella oxytoca; Pseudomonas fluorescens; Pseudomonas putida; Salmonella typhimurium; Shigella flexneri; Shigella sonnei and Yersinia enterocolitica.

In one aspect, a composition of the present invention is effective against a Salmonella enterica strain.

Suitably the contaminant microorganisms may be selected from one or more of: Salmonella enterica ser. Anatum, Salmonella enterica ser. Braenderup, Salmonella enterica ser. Derby, Salmonella enterica ser. Enteritidis; Salmonella enterica ser. Hadar, Salmonella enterica ser. Infantis; Salmonella enterica ser. Kedougou, Salmonella enterica ser. Mbandaka, Salmonella enterica ser. Montevideo, Salmonella enterica ser. Neumuenster, Salmonella enterica ser. Newport, Salmonella enterica ser. Ohio, Salmonella enterica ser. Schwarzengrund, Salmonella enterica ser. Senftenberg, Salmonella enterica ser. Tennessee, Salmonella enterica ser. Thompson and Salmonella enterica ser. Typhimurium.

Suitably the contaminant microorganism may be Escherichia.

Suitably the contaminant microorganism may be Escherichia coli.

Suitably the contaminant microorganisms may be selected from one or more of: E. coli DCS 15 (e.g. E. coli 0157:H7), E. coli DCS 492, E. coli DCS 493, E. coli DCS 494, E. coli DCS 495, E. coli DCS 496, E. coli DCS 497, E. coli DCS 546, E. coli DCS 558, E. coli DCS1336 and E. coli DCS1396.

In one aspect, the contaminant microorganisms may be one or more Gram-positive bacteria from a genus selected from the group consisting of: Listeria; Bacillus; Brochothrix; Clostridium; Enterococcus; Lactobacillus; Leuconostoc and Staphylococcus.

In another aspect, the contaminant microorganisms may be one or more of: Listeria monocytogenes; Bacillus coagulans spores; Bacillus licheniformis; Bacillus licheniformis spores; Bacillus subtilis spores; Brochothrix thermosphacta; Clostridium perfringens; Clostridium sporogenes spores; Enterococcus faecalis; Enterococcus gallinarum; Lactobacillus farciminis; Lactobacillus fermentum; Lactobacillus plantarum; Lactobacillus sakei; Leuconostoc mesenteroides; Listeria innocua; Staphylococcus aureus and Staphylococcus epidermidis.

In one aspect, the contaminant microorganisms may be one or more fungi from a genus selected from the group consisting of: Aspergillus; Candida; Debaryomyces; Kluyveromyces; Penicillium; Pichia; Rhodotorula; Saccharomyces and Zygosaccharomyces.

In one aspect, the contaminant microorganisms may be one or more of: Aspergillus parasiticus; Aspergillus versicolor; Candida parapsilosis; Candida tropicalis; Citrobacter freundii; Debaryomyces hansenii; Kluyveromyces marxianus; Penicillium commune; Pichia anomala; Rhodotorula glutinis; Rhodotorula mucilaginosa; Saccharomyces cerevisiae and Zygosaccharomyces bailii.

Examples of Gram-positive contaminant microorganisms include bacteria from the genera: Listeria; Bacillus; Brochothrix; Clostridium; Enterococcus; Lactobacillus; Leuconostoc and Staphylococcus. Such as Listeria monocytogenes; Bacillus coagulans spores; Bacillus licheniformis; Bacillus licheniformis spores; Bacillus subtilis spores; Brochothrix thermosphacta; Clostridium perfringens; Clostridium sporogenes spores; Enterococcus faecalis; Enterococcus gallinarum; Lactobacillus farciminis; Lactobacillus fermentum; Lactobacillus plantarum; Lactobacillus sakei; Leuconostoc mesenteroides; Listeria innocua; Staphylococcus aureus and Staphylococcus epidermidis.

Examples of fungal contaminant microorganisms include bacteria from the genera: Aspergillus; Candida; Debaryomyces; Kluyveromyces; Penicillium; Pichia; Rhodotorula; Saccharomyces and Zygosaccharomyces. Such as Aspergillus parasiticus; Aspergillus versicolor; Candida parapsilosis; Candida tropicalis; Citrobacter freundii; Debaryomyces hansenii; Kluyveromyces marxianus; Penicillium commune; Pichia anomala; Rhodotorula glutinis; Rhodotorula mucilaginosa; Saccharomyces cerevisiae and Zygosaccharomyces bailii.

In one embodiment preferably the contaminant microorganism is selected from one or more the following genera: Salmonella and Escherichia.

For example, the contaminant microorganism may be selected from one or more of the following species: Salmonella enterica or Escherichia coli.

In some aspects the contaminant microorganism may be selected from: Salmonella enterica subsp. enterica strains, e.g. Salmonella enterica ser. Anatum, Salmonella enterica ser. Braenderup, Salmonella enterica ser. Derby, Salmonella enterica ser. Enteritidis; Salmonella enterica ser. Hadar, Salmonella enterica ser. Infantis; Salmonella enterica ser. Kedougou, Salmonella enterica ser. Mbandaka, Salmonella enterica ser. Montevideo, Salmonella enterica ser. Neumuenster, Salmonella enterica ser. Newport, Salmonella enterica ser. Ohio, Salmonella enterica ser. Schwarzengrund, Salmonella enterica ser. Senftenberg, Salmonella enterica ser. Tennessee, Salmonella enterica ser. Thompson and Salmonella enterica ser. Typhimurium.

Depending on the product that the anti-contaminant composition is being used with, then the contaminant microorganism(s) may vary.

By way of example, if the product is pet food (e.g. semi-moist pet food, e.g. kibble form or other other forms of pet food, or pet treats), then the contaminant microorganism may be from the genus Salmonella, e.g. from the species Salmonella enterica for example.

For example, if the product is pet food, e.g. kibble, then the contaminant microorganism may be Salmonella enterica ser.: Infantis or Tennessee, Salmonella enterica ser.: Senftenberg or Montevideo, for example.

For example, if the product kibble form pet food then the contaminant microorganism may be Salmonella enterica ser.: Infantis or Tennessee.

If the product is pet food then the contaminant microorganism may be Salmonella enterica ser.: Senftenberg or Montevideo, for example.

If the product is a pet treat then the contaminant microorganism may be Salmonella enterica ser.: Typhimurium, Newport, Anatum, Ohio, Senftenberg, Thompson or Neumuenster, for example.

If the product is raw pet food then the contaminant microorganism may be Salmonella enterica ser.: Hadar, Braenderup or Schwarzengrund, for example.

If the product is frozen pet food then the contaminant microorganism may be Salmonella enterica ser. Mbandaka, for example.

If the product is pig ear treats then the contaminant microorganism may be Salmonella enterica ser. Infantis, for example.

If the contaminant microorganism originates from a pet food plant then the contaminant microorganism may be Salmonella enterica ser. Derby, for example.

If the product is a foodstuff (e.g. a human foodstuff) then the contaminant microorganism(s) may vary.

If the product is a human food product (e.g. a dairy product, e.g. a milk based product) then the contaminant microorganism may be selected from one or more of the following genera: Escherichia and Salmonella.

In some aspects, when the product is a foodstuff (e.g. a human foodstuff) then the contaminant microorganism may be Salmonella.

Suitably when the product is a foodstuff, the contaminant microorganism may be a Salmonella enterica, for example.

Suitably, when the product is a foodstuff the contaminant may be selected from one or more Salmonella enterica subsp. enterica strains: Salmonella enterica ser. Anatum, Salmonella enterica ser. Braenderup, Salmonella enterica ser. Derby, Salmonella enterica ser. Enteritidis; Salmonella enterica ser. Hadar, Salmonella enterica ser. Infantis; Salmonella enterica ser. Kedougou, Salmonella enterica ser. Mbandaka, Salmonella enterica ser. Montevideo, Salmonella enterica ser. Neumuenster, Salmonella enterica ser. Newport, Salmonella enterica ser. Ohio, Salmonella enterica ser. Schwarzengrund, Salmonella enterica ser. Senftenberg, Salmonella enterica ser. Tennessee, Salmonella enterica ser. Thompson and Salmonella enterica ser. Typhimurium, for example.

In one aspect, when the product is a foodstuff (e.g. a human foodstuff) then the contaminant microorganism may be Escherichia. Suitably the contaminant microorganism may be Escherichia coli.

In another aspect, when the product is a foodstuff (e.g. a human foodstuff) the contaminant microorganism may be one or more Escherichia coli strain selected from the group consisting of: E. coli DCS15 (e.g. E. coli 0157:H7), E. coli DCS 492, E. coli DCS 493, E. coli DCS 494, E. coli DCS 495, E. coli DCS 496, E. coli DCS 497, E. coli DCS 546, E. coli DCS 558, E. coli DCS1336 and E. coli DCS1396.

If the product is a dairy product, e.g. a milk based product, then the contaminant microorganism may be selected from one or more of the following genera species: Escherichia coli and Salmonella enterica, e.g. Salmonella enterica ser.: Typhimurium, Senftenberg, or Enteritidis.

### “Plate Diffusion Assay” Protocol

A sample of a cell-free fermentate, a supernatant, or a component thereof can be tested to determine if it comprises a “compound of interest” or is “effective” against a contaminant microorganism of interest in accordance with the present invention using the “Plate Diffusion Assay” protocol below.

Plates for each contaminant organism of interest are made as follows: 30 ml of molten agar media including 3 ml 2M sodium phosphate pH 6.5 is inoculated with 150 μl of a fully grown overnight culture of the contaminant organism of interest and mixed well. The suspension is poured into omnitrays and is left to set for 30 minutes.

Wells are cut with into the agar and left to dry open in a LAF bench for another 30 minutes.

Wells are filled with 100 μl of the sample and incubated for 24 to 48 hours under optimal growth conditions for the contaminant microorganism of interest. After the incubation time, the halo diameters (i.e. the inhibition zones visualised as clearer halos) are measured.

The sample is considered to comprise a compound of interest and/or is considered effective against the contaminant microorganism used if a halo diameter of at least about 2, 3, 4, 5, 6, 7, 8, 9, 10, 11, 12, 13, 14, 15, 16, 17, 18, 19 or 20 mm is measured against the contaminant microorganism tested.

In one aspect, E. coli may be used as the contaminant microorganism, for example E. coli may be used as an indicator to test the presence of effective activity against a Gram-negative bacterium.

In one aspect, L. monocytogenes may be used as the contaminant microorganism, for example L. monocytogenes may be used as an indicator to test the presence of effective activity against a Gram-positive bacterium.

In one aspect, S. cerevisiae may be used as the contaminant microorganism, for example S. cerevisiae may be used as an indicator to test the presence of effective activity against a fungus.

### “Inhibition Broth Assay” Protocol

A sample of a cell-free fermentate, a supernatant, or a component thereof can be tested to determine if it comprises a “compound of interest” or is “effective” against a contaminant microorganism of interest in accordance with the present invention using the “Inhibition Broth Assay” protocol below.

Single well isolated colonies of contaminant organism are picked into a suitable nutrition broth (e.g. brain-heart infusion broth (Becton, Dickenson U.K. Ltd (BD) Product No. 238400) and grown at 37° C. for 24 hours and serve as the target organisms.

In order to set up the broth assay, wells of a 96-well microtiter plate are filled each with 0.18 ml of a suitable nutrition broth (e.g. brain-heart infusion broth (BD Product No. 238400)), set up in duplicate, with the cell-free fermentate, a supernatant, or a component thereof and without at 10% (v/v) and 50% (v/v) concentration.

All wells are inoculated with 1% (v/v) of the target organism and the 96-well plates are incubated at 37° C. for 24 hours. The OD₅₉₅ is measured and a percent inhibition value is reported for the treated versus the control results.

The sample is considered to comprise a compound of interest and/or is considered effective against the contaminant microorganism used if at least about 20% inhibition is measured against the contaminant microorganism tested.

In one aspect, E. coli may be used as the contaminant microorganism, for example E. coli may be used as an indicator to test the presence of effective activity against a Gram-negative bacterium.

In one aspect, L. monocytogenes may be used as the contaminant microorganism, for example L. monocytogenes may be used as an indicator to test the presence of effective activity against a Gram-positive bacterium.

In one aspect, S. cerevisiae may be used as the contaminant microorganism, for example S. cerevisiae may be used as an indicator to test the presence of effective activity against a fungus.

### Additional Component(s)

In one aspect of the present invention, the composition of the present invention may comprise one or more additional component(s). Preferably, any additional component(s) do not materially affect the anti-contaminant properties of the composition of the present invention.

Suitably, the additional component(s) may be a carrier, an adjuvant, a solubilizing agent, a suspending agent, a diluent, an oxygen scavenger, an antioxidant, a food material, an anti-contaminant agent or combinations thereof.

Suitably, the additional component(s) may be required for the application to which the antimicrobial is to be utilised. For example, if the anti-contaminant composition is to be utilised to on, or in, an agricultural product, the additional component(s) may be an agriculturally acceptable carrier, excipient or diluent. Likewise, if the anti-contaminant composition is to be utilised to on, or in, a foodstuff the additional component(s) may be an edible carrier, excipient or diluent.

In one aspect, the one or more additional component(s) is a carrier, excipient, diluent, oxygen scavenger, antioxidant and/or a food material.

“Carriers” or “vehicles” mean materials suitable for compound administration and include any such material known in the art such as, for example, any liquid, gel, solvent, liquid diluent, solubilizer, or the like, which is non-toxic and which does not interact with any components of the composition in a deleterious manner.

Examples of nutritionally acceptable carriers include, for example, water, salt solutions, alcohol, silicone, waxes, petroleum jelly, vegetable oils, polyethylene glycols, propylene glycol, liposomes, sugars, gelatin, lactose, amylose, magnesium stearate, talc, surfactants, silicic acid, viscous paraffin, perfume oil, fatty acid monoglycerides and diglycerides, petroethral fatty acid esters, hydroxymethyl-cellulose, polyvinylpyrrolidone, and the like.

Examples of excipients include one or more of: microcrystalline cellulose and other celluloses, lactose, sodium citrate, calcium carbonate, dibasic calcium phosphate, glycine, starch, milk sugar and high molecular weight polyethylene glycols.

Examples of diluents include one or more of: water, ethanol, propylene glycol and glycerin, and combinations thereof.

The other components may be used simultaneously (e.g. when they are in admixture together or even when they are delivered by different routes) or sequentially (e.g. they may be delivered by different routes).

The composition or its diluent may also contain chelating agents such as EDTA, citric acid, tartaric acid, etc. Moreover, the composition or its diluent may contain active agents selected from fatty acids esters such as mono- and diglycerides, non-ionic surfactants such as polysorbates, phospholipids, etc. Emulsifiers may enhance the stability of the composition, especially after dilution.

### Anti-Contaminant Agents

In one aspect, the anti-contaminant composition of the present invention may comprise one or more additional anti-contaminant agent.

The term “additional anti-contaminant agent” refers to an anti-contaminant agent which is not produced by culturing any one of B. subtilis 3A-P4; 15A-P4; 22C-P1; LSSA01; BS18; ABP 278 or combinations thereof.

Such “additional anti-contaminant agents” may include anti-microbial agents, anti-bacterial agents; anti-fungal agents and/or anti-viral agents.

In one embodiment the additional anti-contaminant agent is a food grade anti-contaminant.

In one embodiment the additional anti-contaminant agent (or food grade anti-contaminant agent) is one or more of the group consisting of: food grade organic acids; a plant antimicrobial, for example a catechin (e.g. from Green tea), an allylisothiocyanate (e.g. from mustard oil); a phenol (e.g. from rosemary); a plant essential oil; a bacteriocin; an anti-microbial emulsifier, fatty acid, or their esters.

### Oxygen Scavenger

In one aspect of the present invention, the composition of the present invention or cell-free fermentation product may comprise an oxygen scavenger and/or the containing (e.g. packaging) of the products and/or compositions of the present invention may comprise a compound which scavenges oxygen.

Without wishing to be bound by theory, an oxygen scavenger may serve to preserve an anti-contaminant activity of the anti-contaminant composition or cell-free fermentation product of the present invention. Preservation of the anti-contaminant activity may be achieved by inhibition of oxidation of components within the anti-contaminant composition or cell-free fermentation product.

Regulating the exposure of the fermentation product (or composition comprising the fermentation product) to oxygen (such as through the use of an oxygen scavenger or antioxidant) advantageously helps to maintain the anti-contaminant activity. Thus, the “shelf-life” of the product to which an anti-contaminant composition is applied may advantageously be extended. For example, by limiting the exposure of oxygen sensitive food products to oxygen in a packaging system, the quality or freshness of food may be maintained, contaminant reduced, and/or the food shelf life extended.

In the food packaging industry, several means for regulating oxygen exposure are known including modified atmosphere packaging (MAP) and oxygen barrier film packaging.

Regulation of oxygen exposure may be achieved by “active packaging”, whereby the package containing the food product is modified in some manner to regulate the food's exposure to oxygen. One form of active packaging uses oxygen-scavenging sachets which contain a composition which scavenges the oxygen through oxidation reactions. One type of sachet contains iron-based compositions which oxidize to their ferric states. Another type of sachet contains unsaturated fatty acid salts on a particulate adsorbent. Yet another sachet contains metal/polyamide complex.

Another type of active packaging involves incorporating an oxygen scavenger into the packaging structure itself. A more uniform scavenging effect through the package is achieved by incorporating the scavenging material in the package instead of adding a separate scavenger structure (e.g., a sachet) to the package. This may be especially important where there is restricted airflow inside the package. In addition, incorporating the oxygen scavenger into the package structure provides a means of intercepting and scavenging oxygen as it permeates the walls of the package (herein referred to as an “active oxygen barrier”), thereby maintaining the lowest possible oxygen level in the package.

Any known oxygen scavenger may be used in accordance with the present invention. A person of ordinary skill in the art can select an oxygen scavenger appropriate to the intended use of the anti-contaminant composition. For example, for food applications a person of ordinary skill in the art may use an oxygen scavenger which has GRAS approval.

Compounds which can be present or incorporated in the packaging material which scavenge oxygen include:
iron powder oxidation (such as commercially available products Ageless®, ATCO® O₂-absorber, Freshilizer®, Vitalon®, and Freshpax®);
ascorbic acid oxidation;
enzymatic oxidation (e.g. glucose oxidase and alcohol oxidase) including commercially available products such as Bioka O₂-absorber;
unsaturated fatty acids (e.g. oleic acid or linolenic acid); and
immobilized yeast on a solid material.

Suitably, such compounds can be used in conjunction with modified atmosphere packaging. In one aspect at least one oxygen scavenger may be added after culturing of the one or more Bacillus subtilis strains in accordance with the present invention.

Suitably the at least one oxygen scavenger may be added to the cell-free fermentation product or a supernatant or a fraction or a component thereof.

### Antioxidant

In one aspect of the present invention, the composition of the present invention or cell-free fermentation product may comprise an antioxidant and/or the containing (e.g. packaging) of the products and/or compositions of the present invention may comprise a compound which is an antioxidant.

Suitably, an antioxidant may be used in the compositions and product of the present invention.

In one aspect, an antioxidant may be used in the methods of the present invention. For example, an antioxidant may be added prior to, during or after culturing. Without wishing to be bound by theory, an antioxidant may serve to preserve an anti-contaminant activity of the anti-contaminant composition or cell-free fermentation product of the present invention. Preservation of the anti-contaminant activity may be achieved by inhibition of oxidation of components within the anti-contaminant composition or cell-free fermentation product.

The term “antioxidant” as used herein refers to a molecule capable of inhibiting the oxidation of other molecules.

In one aspect at least one antioxidant may be added after culturing of the one or more Bacillus subtilis strains in accordance with the present invention.

Suitably the at least one antioxidant may be added to the cell-free fermentation product or a supernatant or a fraction or a component thereof.

Antioxidants are widely known and commercially available. A person or ordinary skill in the art is able to select an antioxidant appropriate for the desired end use. For example, where the anti-contaminant composition is to be used in foodstuffs natural antioxidants such as ascorbic acid, tocopherols, butylated hydroxyanisole and butylated hydroxytoluene may be used.

In one aspect, a suitable antioxidant may be selected from the group consisting of: ascorbic acid, polyphenols, vitamin E, beta-carotene, rosemary extract, mannitol and BHA.

In one aspect, between about 0 ppm to about 900 ppm of an antioxidant may be added to the anti-contaminant composition of the present invention, about 0 ppm to about 100 ppm, about 100 ppm to about 200 ppm, about 200 ppm to about 300 ppm, about 300 ppm to about 400 ppm, about 400 ppm to about 500 ppm, about 500 ppm to about 600 ppm, about 600 ppm to about 700 ppm, about 700 ppm to about 800 ppm, about 800 ppm to about 900 ppm. In other aspects more than about 900 ppm of an antioxidant may be added.

In another aspect, between about 600 ppm to about 900 ppm of an antioxidant may be added to the anti-contaminant composition of the present invention.

Suitably, between about 600 ppm to about 900 ppm of ascorbic acid may be added to the anti-contaminant composition of the present invention.

### Products

Products which comprise an anti-contaminant composition of the present inventions are provided.

Any product which is susceptible to contaminant (preferably microbial contaminant) is encompassed herein. Such products include foodstuffs, surface coating materials and agricultural products.

### Foodstuff

The compositions of the present invention may be used as—or in the preparation of—a food. Here, the term “foodstuff” is used in a broad sense—and covers food for humans as well as food for animals (i.e. a feedstuff).

In one preferred embodiment the term “foodstuff” means “human foodstuff”. In other words in a preferred embodiment the term foodstuff may exclude food for animals (e.g. a feedstuff). Suitably, the term foodstuff means either a human foodstuff and/or a pet food.

Suitably, the term “foodstuff” as used herein may mean a foodstuff in a form which is ready for consumption. Alternatively or in addition, however, the term “foodstuff” as used herein may mean one or more food materials which are used in the preparation of a foodstuff.

The terms “foodstuff” and “food product” as used herein are interchangeable

The food may be in the form of a solution or as a solid—depending on the use and/or the mode of application and/or the mode of administration.

When used in the preparation of a foodstuff, the anti-contaminant composition of the present invention may be used in conjunction with one or more of: a nutritionally acceptable carrier, a nutritionally acceptable diluent, a nutritionally acceptable excipient, a nutritionally acceptable adjuvant or a nutritionally active ingredient.

The anti-contaminant composition of the present invention may be used reduce or prevent microbial contaminant of various foodstuffs. Suitably, a foodstuff or food product in accordance with the present invention may be or may include raw meat, cooked meat, raw poultry products, cooked poultry products, raw seafood products, cooked seafood products, ready-to-eat food, ready-made meals, pasta sauces, pasteurised soups, mayonnaise, salad dressings, oil-in-water emulsions, margarines, low fat spreads, water-in-oil emulsions, eggs, egg-based products, dairy products, cheese spreads, processed cheese, dairy desserts, flavoured milks, cream, fermented milk products, cheese, butter, condensed milk products, ice cream mixes, soya products, pasteurised liquid egg, bakery products, confectionery products, fruit, fruit products, canned foods and foods with fat-based or water-containing fillings.

In one aspect, the foodstuff is a ready-to-eat food. The term “ready-to-eat food” as used in herein means a foodstuff which is edible without further preparation to achieve food safety. Such products include chopped vegetables, pre-washed salads, prepared and pre-washed fruits and processed meats.

In one aspect, the foodstuff is a ready-made meal. The term “ready-made meal” refers to a food which has undergone one or more preparation steps prior to being sold. Ready-made meals include refrigerated and frozen ready meals that may simply be heated prior to consumption.

In one aspect, the foodstuff may be a packaged foodstuff such as a packaged salad, ready-meal, a packaged meat product and the like. In this aspect, the anti-contaminant composition of the present invention may be applied, in or on, the food product. In addition, or in the alternative, the anti-contaminant composition may be used in, or on, the packaging. For example, the anti-contaminant composition may be applied to the packaging.

In one aspect, the food stuff is or includes a ready-made meal.

In one aspect, the foodstuff may be an egg, a liquid egg or an egg-based product. Egg-based products may include, but are not limited to cake, mayonnaise, salad dressings, sauces, ice creams and the like.

The term “constituent” refers to the use of one or more materials used to prepare the product. Thus, in the context of a foodstuff, the “constituent” will be one or more food materials used in the preparation of the foodstuff. Suitably, the anti-contaminant composition of the present invention can be used in, or on, a constituent of the foodstuff.

The term “human foodstuff” as used herein, refers to a foodstuff which is for consumption (or primarily for consumption) by humans. In one embodiment, the term human foodstuff as used herein excludes feedstuffs for animal consumption as defined herein.

### Culinary Product

In one aspect, the foodstuff (e.g. human foodstuff) may be or may include a culinary product.

In one aspect, the culinary product may be a sauce, salad dressing, spices, seasonings and/or soup.

In one aspect the foodstuff (e.g. human foodstuff) may be or may include a sauce such as a table sauce (including sauces that are used as table sauces and sauces that are multi-purpose and can be used as table sauces), a marinade and/or a cooking sauce (e.g. during stir-frying, steaming, etc.).

In one aspect, the sauce may be or may include a fermented sauce. Various types of fermented sauces exist in different regions and different variants are included for each country. Examples include brown sauce, chilli, Worcester, plum, mint sauce for meat, tartar sauce, apple sauce for meat, horse radish, cranberry sauce for meat, etc. and oyster, hoisin, etc.

In one aspect, the sauce may be or may include a soy based sauces or a soy-based fermented sauce. Examples include dark soy sauce and light soy sauce blended soy-based sauces, e.g.—teriyaki (soy sauce blended with added sugar and mirin)—sukiyaki (with added sugar, mirin and stock)—yakitori (with added mirin, sake, sugar).

In one aspect, the sauce may be or may include a pasta sauces. Pasta sauces include sauces either added directly to cooked pasta or heated up for a few minutes beforehand, or alternatively added to fresh ingredients, e.g. meat or vegetables, and heated up to make a sauce which will then be added to cooked pasta. Examples include Bolognese, carbonara, mushroom, tomato, vegetable, pesto, etc.

In one aspect, the foodstuff (e.g. human foodstuff) is or includes a wet/cooking sauces such as Liquid (i.e. non-dehydrated) recipe cooking sauces/pastes that are added to ingredients (meat and/or vegetables) to produce a meal. This also includes recipe sauces/pastes that could be added before the cooking process (marinades) and/or during the cooking process (e.g. steaming, grilling, stir-frying, stewing, etc.).

In one aspect, the foodstuff (e.g. human foodstuff) may be or may include dry sauces/powder mixes. Such sauces include dry sauces to which boiling water or milk is added before consumption; dry recipe powder mixes and dry powder marinades. Some dry sauces may require heating over the stove for the sauce to thicken after water/milk is added. Examples include Hollandaise sauce, white sauce, pepper sauce, sweet and sour sauce, spaghetti bolognaise, etc.

In one aspect, the foodstuff (e.g. human foodstuff) may be or may include a salad dressing. Suitable the dressing may include regular salad dressings (Standard ready-made) and/or dried salad dressings (i.e. powders packaged in sachets that are mixed with oil/vinegar).

Examples include oil-based products, thousand island, blue cheese, Caesar, salad cream, etc.

Suitably, the dressing may include: low fat salad dressings (examples include oil-based products, thousand island, blue cheese, Caesar, salad cream, etc.); and vinaigrettes includes all vinegar-based salad dressings such as vinaigrette

Other sauces, dressings and condiments Examples include 1) Non-fermented table sauces 2) Wasabi 3) Non-recipe purees, pastes (e.g. garlic purees/pastes) 4) Dry marinades 5) Dry recipe powder mixes (e.g. fajita spice mix) 5) Dehydrated recipe batter/coating (used for cooking e.g. deep frying, grilling, baking).

In one aspect, the foodstuff (e.g. human foodstuff) may be or may include a soup such as canned soup, ready-to-eat soup, dehydrated soup, instant soup, chilled soup, UHT soup and frozen soup.

Canned soup—Includes all varieties of canned soup in ready-to-eat or condensed (with water to be added) form. Ready-to-eat or condensed soup in bricks” or retort pouches are also categorised as UHT soup. Examples include mixed vegetables, pea, leek, fish, mushrooms, tomato, chicken soup, meat soup, beef soup, chicken & mushrooms, Eintöpfe, etc.

Dehydrated soup—Powdered soup to which water is added, and then cooked for a number of minutes before consumption.

Instant soup—Powdered soup to which boiling water is added just before consumption.

Chilled soup—Soup made from fresh ingredients and stored in chilled cabinets. These products usually have a limited shelf life

UHT soup—Includes all varieties of soup in ready-to-eat or condensed (with water to be added) form sold ambient (i.e. not stored in chilled cabinets) Product types include mixed vegetables, pea, leek, fish, mushrooms, tomato, chicken soup, meat soup, beef soup, chicken & mushrooms

Frozen soup—Includes all varieties of soup sold in frozen form. Product types include mixed vegetables, pea, leek, fish, mushrooms, tomato, chicken soup, meat soup, beef soup, chicken & mushrooms, Eintöpfe, etc.

### Meat Based Food Product

A meat based foodstuff (e.g. human foodstuff) according to the present invention is any product based on meat.

The meat based foodstuff is suitable for human and/or animal consumption as a food and/or a feed.

In one embodiment of the invention the meat based food product is a feed product for feeding animals, such as for example a pet food product.

In another embodiment of the invention the meat based food product is a food product for humans.

A meat based food product may comprise non-meat ingredients such as for example water, salt, flour, milk protein, vegetable protein, starch, hydrolysed protein, phosphate, acid, spices, colouring agents and/or texturising agents.

A meat based food product in accordance with the present invention preferably comprises between 5-90% (weight/weight) meat. In some embodiments the meat based food product may comprise at least 30% (weight/weight) meat, such as at least 50%, at least 60% or at least 70% meat.

In some embodiments the meat based food product is a cooked meat, such as ham, loin, picnic shoulder, bacon and/or pork belly for example.

The meat based food product may be one or more of the following:

Dry or semi-dry cured meats—such as fermented products, dry-cured and fermented with starter cultures, for example dry sausages, salami, pepperoni and dry ham;

Emulsified meat products (e.g. for cold or hot consumption), such as mortadella, frankfurter, luncheon meat and pâté;

Fish and seafood, such as shrimps, salmon, reformulated fish products, frozen cold-packed fish;

Fresh meat muscle, such as whole injected meat muscle, for example loin, shoulder ham, marinated meat;

Ground and/or restructured fresh meat—or reformulated meat, such as upgraded cut-away meat by cold setting gel or binding, for example raw, uncooked loin chops, steaks, roasts, fresh sausages, beef burgers, meat balls, pelmeni;

Poultry products—such as chicken or turkey breasts or reformulated poultry, e.g. chicken nuggets and/or chicken sausages; and

Retorted products—autoclaved meat products, for example picnic ham, luncheon meat, emulsified products.

In one embodiment of the present invention the meat based food product is a processed meat product, such as for example a sausage, bologna, meat loaf, comminuted meat product, ground meat, bacon, polony, salami or pate.

A processed meat product may be for example an emulsified meat product, manufactured from a meat based emulsion, such as for example mortadella, bologna, pepperoni, liver sausage, chicken sausage, wiener, frankfurter, luncheon meat, meat pate.

The meat based emulsion may be cooked, sterilised or baked, e.g. in a baking form or after being filled into a casing of for example plastic, collagen, cellulose or a natural casing. A processed meat product may also be a restructured meat product, such as for example restructured ham. A meat product of the invention may undergo processing steps such as for example salting, e.g. dry salting; curing, e.g. brine curing; drying; smoking; fermentation; cooking; canning; retorting; slicing and/or shredding.

In one embodiment the meat to be contacted with the anti-contaminant compositing may be minced meat.

In another embodiment the foodstuff may be an emulsified meat product.

### Meat

The term “meat” as used herein means any kind of tissue derived from any kind of animal.

The term meat as used herein may be tissue comprising muscle fibres derived from an animal. The meat may be an animal muscle, for example a whole animal muscle or pieces cut from an animal muscle.

In another embodiment the meat may comprise inner organs of an animal, such as heart, liver, kidney, spleen, thymus and brain for example.

The term meat encompasses meat which is ground, minced or cut into smaller pieces by any other appropriate method known in the art.

The meat may be derived from any kind of animal, such as from cow, pig, lamb, sheep, goat, chicken, turkey, ostrich, pheasant, deer, elk, reindeer, buffalo, bison, antelope, camel, kangaroo; horse, rodent, chinchilla, any kind of fish e.g. sprat, cod, haddock, tuna, sea eel, salmon, herring, sardine, mackerel, horse mackerel, saury, round herring, Pollack, flatfish, anchovy, pilchard, blue whiting, pacific whiting, trout, catfish, bass, capelin, marlin, red snapper, Norway pout and/or hake; any kind of shellfish, e.g. clam, mussel, scallop, cockle, periwinkle, snail, oyster, shrimp, lobster, langoustine, crab, crayfish, cuttlefish, squid, and/or octopus.

In one embodiment the meat is beef, pork, chicken, lamb and/or turkey.

### Feedstuff

In one aspect, the “product” or the “foodstuff” may be a feedstuff.

The term “feedstuff” as used herein means food suitable for animal consumption, such as for cows, pigs, lamb, sheep, goats, chickens, turkeys, ostriches, pheasants, deer, elk, reindeer, buffalo, bison, antelope, camels, kangaroos; horses, fish; cats, dogs, guinea pigs, rodents e.g. rats, mice, gerbils and chinchillas.

The anti-contaminant composition may be added to the feedstuff or a component in a manner known per se.

Preferably the feed may be a fodder, or a premix thereof, a compound feed, or a premix thereof. In one embodiment anti-contaminant composition according to the present invention may be admixed with, and/or applied onto, a compound feed, a compound feed component or to a premix of a compound feed or to a fodder, a fodder component, or a premix of a fodder.

The term fodder as used herein means any food which is provided to an animal (rather than the animal having to forage for it themselves). Fodder encompasses plants that have been cut.

The term fodder includes hay, straw, silage, compressed and pelleted feeds, oils and mixed rations, and also sprouted grains and legumes.

Fodder may be obtained from one or more of the plants selected from: alfalfa (lucerne), barley, birdsfoot trefoil, brassicas, Chau moellier, kale, rapeseed (canola), rutabaga (swede), turnip, clover, alsike clover, red clover, subterranean clover, white clover, grass, false oat grass, fescue, Bermuda grass, brome, heath grass, meadow grasses (from naturally mixed grassland swards, orchard grass, rye grass, Timothy-grass, corn (maize), millet, oats, sorghum, soybeans, trees (pollard tree shoots for tree-hay), wheat, and legumes.

The term “compound feed” means a commercial feed in the form of a meal, a pellet, nuts, cake or a crumble. Compound feeds may be blended from various raw materials and additives. These blends are formulated according to the specific requirements of the target animal.

Compound feeds can be complete feeds that provide all the daily required nutrients, concentrates that provide a part of the ration (protein, energy) or supplements that only provide additional micronutrients, such as minerals and vitamins.

The main ingredients used in compound feed are the feed grains, which include corn, soybeans, sorghum, oats, and barley.

Suitably a premix as referred to herein may be a composition composed of microingredients such as vitamins, minerals, chemical preservatives, inhibitory substances, fermentation products, and other essential ingredients. Premixes are usually compositions suitable for blending into commercial rations.

Any feedstuff of the present invention may comprise one or more feed materials selected from the group comprising a) cereals, such as small grains (e.g., wheat, barley, rye, oats and combinations thereof) and/or large grains such as maize or sorghum; b) by products from cereals, such as corn gluten meal, Distillers Dried Grain Solubles (DDGS), wheat bran, wheat middlings, wheat shorts, rice bran, rice hulls, oat hulls, palm kernel, and citrus pulp; c) protein obtained from sources such as soya, sunflower, peanut, lupin, peas, fava beans, cotton, canola, fish meal, dried plasma protein, meat and bone meal, potato protein, whey, copra, sesame; d) oils and fats obtained from vegetable and animal sources; e) minerals and vitamins.

A feedstuff of the present invention may contain at least 30%, at least 40%, at least 50% or at least 60% by weight corn and soybean meal or corn and full fat soy, or wheat meal or sunflower meal.

In addition or in the alternative, a feedstuff of the present invention may comprise at least one high fibre feed material and/or at least one by-product of the at least one high fibre feed material to provide a high fibre feedstuff. Examples of high fibre feed materials include: wheat, barley, rye, oats, by products from cereals, such as corn gluten meal, Distillers Dried Grain Solubles (DDGS), wheat bran, wheat middlings, wheat shorts, rice bran, rice hulls, oat hulls, palm kernel, and citrus pulp. Some protein sources may also be regarded as high fibre: protein obtained from sources such as sunflower, lupin, fava beans and cotton.

In the present invention the feed may be one or more of the following: a compound feed and premix, including pellets, nuts or (cattle) cake; a crop or crop residue: corn, soybeans, sorghum, oats, barley, corn stover, copra, straw, chaff, sugar beet waste; fish meal; freshly cut grass and other forage plants; meat and bone meal; molasses; oil cake and press cake; oligosaccharides; conserved forage plants: hay and silage; seaweed; seeds and grains, either whole or prepared by crushing, milling etc.; sprouted grains and legumes; yeast extract.

As used herein the term “applied” refers to the indirect or direct application of the composition of the present invention to the product (e.g. the feed). Examples of the application methods which may be used, include, but are not limited to, treating the product in a material comprising the anti-contaminant composition, direct application by admixing the anti-contaminant composition with the product, spraying the anti-contaminant composition onto the product surface or dipping the product into a preparation of the anti-contaminant composition or coating the product with the anti-contaminant composition.

In one embodiment the anti-contaminant composition of the present invention is preferably admixed with, or applied onto, the product (e.g. feedstuff). Alternatively, the anti-contaminant composition may be included in the emulsion or raw ingredients of a feedstuff.

### Pet Food

Microbial contamination is an increasing concern in the pet food industry due to an increased incidence of recalls.

In one aspect, the product may preferably be a pet food. The term “pet food” as used herein means a food suitable for consumption by a domesticated animal such as a dog, cat, horse, pig, fish, bird, hamster, gerbil, guinea pig, rodent e.g. rat, mouse, rabbit and chinchilla.

In one aspect, the term “pet food” as used herein means a food suitable for consumption by a domesticated dog or cat.

Pet foods are subject to contaminant by microorganisms such as Salmonella, Listeria, E. coli and Clostridium. For example, dried pet food may be particularly susceptible to microbial contaminant in the post processing phase.

The present invention has advantageously provided an anti-contaminant composition for use in pet food which has one or more of the following advantages: safe, palatable, cost-effective and stable, as well as effective.

The anti-contaminant composition may be applied on, or in, the pet food itself and/or constituent(s) (e.g. ingredients) of the pet food. For example, the anti-contaminant composition may be applied on, or in, a palatant.

Examples of typical constituents found in dog and cat food include palatants, Whole Grain Corn, Soybean Mill Run, Chicken By-Product Meal, Powdered Cellulose, Corn Gluten Meal, Soybean Meal, Chicken Liver Flavor, Soybean Oil, Flaxseed, Caramel Color, Iodized Salt, L-Lysine, Choline Chloride, Potassium Chloride, vitamins (L-Ascorbyl-2-Polyphosphate (source of vitamin C), Vitamin E Supplement, Niacin, Thiamine Mononitrate, Vitamin A Supplement, Calcium Pantothenate, Biotin, Vitamin B12 Supplement, Pyridoxine Hydrochloride, Riboflavin, Folic Acid, Vitamin D3 Supplement), Vitamin E Supplement, minerals (e.g., Ferrous Sulfate, Zinc Oxide, Copper Sulfate, Manganous Oxide, Calcium Iodate, Sodium Selenite), Taurine, L-Carnitine, Glucosamine, Mixed Tocopherols, Beta-Carotene, Rosemary Extract.

In one aspect, the pet food may be a wet or dry pet food, which may be in the form of a moist pet food (e.g. comprising 18-35% moisture), semi-moist pet food (e.g. 14 to 18% moisture), dry pet food, pet food supplement or a pet treat. Some pet food forms (e.g. moist and semi-moist pet food) are particularly susceptible to contamination due to the fact that the processing conditions for preparing the pet food are not sufficient to kill all microorganisms on, or in, the pet food.

Suitably, the pet food may be in kibble form.

In one aspect, the pet food may be suitable for a dog or a cat.

In one aspect, the pet food may be fish food. A fish food normally contains macro nutrients, trace elements and vitamins necessary to keep captive fish in good health. Fish food may be in the form of a flake, pellet or tablet. Pelleted forms, some of which sink rapidly, are often used for larger fish or bottom feeding species. Some fish foods also contain additives, such as beta carotene or sex hormones, to artificially enhance the color of ornamental fish.

In one aspect, the pet food may be a bird food. Bird food includes food that is used both in birdfeeders and to feed pet birds. Typically bird food comprises of a variety of seeds, but may also encompass suet (beef or mutton fat).

In one aspect, the anti-contaminant composition may be incorporated within the pet food or on the surface of the pet food, such as, by spraying or precipitation thereon.

In one aspect, the anti-contaminant composition is formulated for use in pet food. In this aspect, the anti-contaminant composition may comprise additional anti-contaminant agents such as phosphoric acid, propionic acid and propionates, sulfites, benzoic acid and benzoates, nitrites, nitrates and parabens. Alternatively, the anti-contaminant agent may not comprise any chemicals.

Suitably, the anti-contaminant composition may be added to a pet food or constituent thereof such that the anti-contaminant composition is present at about 0.1% to about 10%, about 0.1 to about 5%, or about 0.1 to about 3% by weight of the pet food. In one aspect the anti-contaminant composition is present at about 0.1, 0.2, 0.3, 0.4, 0.5, 0.6, 0.7, 0.8, 0.9, 1.0, 1.1, 12., 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.5, 4.0, 4.5, or 5.0% by weight of the pet food where any of the stated values can form an upper or lower endpoint when appropriate.

In one aspect, the pet food may be a kibble (e.g. dog kibble). An illustrative method of preparing a kibble comprises the following steps:

a. preconditioning by mixing wet and dry ingredients at elevated temperature to form a kibble dough;
b. extruding the kibble dough at a high temperature and pressure;
c. drying the extruded kibble; and
d. enrobing or coating the dried kibble with topical liquid and/or dry ingredients.

Suitably, the anti-contaminant compositions can be applied to the kibble at any stage in the process, such as at step a and/or d.

Suitably the term “pet food” as used herein does not encompass feed for livestock animals. The term “livestock”, as used herein refers to any farmed animal. Preferably, livestock is one or more of ruminants such as cattle (e.g. cows or bulls (including calves)), mono-gastric animals such as poultry (including broilers, chickens and turkeys), pigs (including piglets), birds, or sheep (including lambs).

### Agricultural Product

As used herein, the term “agricultural products” means fruits, vegetables, crops, seeds, silage, flower bulbs and other agricultural products, which are susceptible to contaminant by microorganisms.

In one aspect, agricultural products can be seed or grain or other propagative plant tissues (e.g. tubers) being stored for future use as seed (sowing). In one aspect, agricultural products can be seed, grain or other plant materials, or plant derived materials for future use as animal feed.

In one aspect, the anti-contaminant composition of the present invention may be used to counter contaminant grass, agricultural crop plants and/or mixed livestock nutrition and the materials used for producing them, such as barley, wheat, rye, oats, corn, rice, oilseed rape, legumes, sunflower seeds, soybeans, sugar beet and sugar cane and residues thereof, hay, straw, peanuts, fishmeal, meat or bonemeal.

### Crops and Crop Protectants

In one aspect, the agricultural product is a crop. Examples of crops include: a cereal, barley, wheat, maize, Triticale, rice, oats, rye, field beans, fruit crops, vegetables, apple, pear, strawberry, pea, tomato, grape, Brassicas, tobacco, lettuce, sorghum, cotton, sugar cane, legumes, ornamentals, pot plants, turf grasses, sugar beet, celery, Crucifers, plantain, banana, grasses, agricultural crops, livestock nutritional plants, oilseed rape, sunflowers, soybean, peanuts, broccoli, cabbage, carrot, citrus, garlic, onion, pepper (Capsicum), potato, and strawberry, including the seeds thereof.

In one aspect of the present invention, the agricultural product is a seed or plant of a cereal, barley, wheat, maize, Triticale, rice, oats, rye, field beans, apple, pear, strawberry, pea, tomato, grape, Brassicas, tobacco, lettuce, sorghum, cotton, sugar cane, legumes, ornamentals, pot plants, turf grasses, sugar beet, celery, Crucifers, plantain, banana, grasses, oilseed rape, sunflower, soybean, and peanut. Preferably the seed or plant material is sugar beet seeds or barley.

In one aspect, the anti-contaminant composition of the present invention is, or is formulated as, a crop protectant.

The term “crop protectant” as used herein refers to an anti-contaminant composition which can be used to counter (for example reduce and/or prevent and/or inhibit) contaminant (preferably microbial contaminant) of a crop.

### Seed Protectants

In one aspect, the agricultural product is a seed.

In seed production, it is important to maintain germination quality and uniformity of seeds.

Advantageously, the anti-contaminant composition of the present invention may be a seed protectant, or formulated as a seed protectant, to prevent contaminant of seeds.

Propagation material to be used as seeds is customarily treated with a protectant coating comprising herbicides, insecticides, fungicides, bactericides, nematicides, molluscicides, or mixtures thereof.

In one aspect, the anti-contaminant composition may be used as a protectant coating for seeds and/or may comprise one or more constituents of a protectant coating foe seeds.

Customarily used protectant coatings comprise compounds such as captan, carboxin, thiram (TMTD & commat), methalaxyl (Apron & commat), and pirimiphos-methyl (Actellic & commat). The anti-contaminant composition may be formulated with any such compounds and/or with further carriers, surfactants or application promoting adjuvants customarily employed in the art of formulation to provide protection against contaminant caused by bacterial, fungal or animal pests.

The anti-contaminant composition or seed protectant of the present invention may be applied by impregnating propagation material with a liquid formulation or by coating with a combined wet or dry formulation. Other methods of application are also possible such as treatment directed at the buds or the fruit.

The seeds may be provided in a bag, container or vessel comprised of a suitable packaging material, the bag or container capable of being closed to contain seeds. The bag, container or vessel may be designed for either short term or long term storage, or both, of the seed. Examples of a suitable packaging material include paper, such as kraft paper, rigid or pliable plastic or other polymeric material, glass or metal. Desirably the bag, container, or vessel is comprised of a plurality of layers of packaging materials, of the same or differing type. In one embodiment the bag, container or vessel is provided so as to exclude or limit water and moisture from contacting the seed. In one example, the bag, container or vessel is sealed, for example heat sealed, to prevent water or moisture from entering. In another example, water absorbent materials are placed between or adjacent to packaging material layers. In one aspect, the anti-contaminant composition of the present invention is applied in, or on, the bag, container or vessel, or packaging material of which it is comprised.

### Silage

In one aspect, the agricultural product is silage.

In one aspect, the anti-contaminant composition may be used in the production of silage (ensiling).

In silage, the required lactic acid fermentation is frequently accompanied by unwanted microbial contaminant, especially by moulds and putrefactive bacteria.

The anti-contaminant composition may be added prior to, during or after the production of silage to counter contaminant, preferably microbial contaminant.

### Surface Contact Material

In one aspect, the product is a surface contact material, such as paint. WO 2009/156851 discloses surface contact materials and uses therefor. The teachings of WO 2009/156851 are disclosed herein by reference.

In one aspect, the present invention relates to a surface contact material as defined in WO 2009/15861 which further comprises, or to which is applied, an anti-contaminant composition of the present invention.

In one aspect, the present invention relates to a method of reducing and/or preventing microbial contaminant of a surface coating material which comprises admixing a surface coating material or a constituent thereof with an anti-contaminant composition of the present invention.

In one aspect, the present invention relates to a method of reducing and/or preventing microbial contaminant of a surface coating material which comprises applying an anti-contaminant composition of the present invention onto a surface coating material or a constituent thereof.

### Forms

The product and/or the composition of the present invention may be used in any suitable form—whether when alone or when present in a composition.

The anti-contaminant composition may be formulated in any suitable way to ensure that the composition comprises a cell-free fermentation product comprising active compound(s) of interest.

In one embodiment, the anti-contaminant composition may be formulated as a liquid, a dry powder or a granule.

The dry powder or granules may be prepared by means known to those skilled in the art, such as, in top-spray fluid bed coater, in a buttom spray Wurster or by drum granulation (e.g. High sheer granulation), extrusion, pan coating or in a microingredients mixer.

Suitably, the anti-contaminant composition may be provided as a spray-dried or freeze-dried powder.

In one aspect, the composition is in a liquid formulation. Such liquid consumption may contain one or more of the following: a buffer, salt, sorbitol and/or glycerol.

In one embodiment the anti-contaminant composition of the present invention may formulated with at least one physiologically acceptable carrier selected from at least one of maltodextrin, limestone (calcium carbonate), cyclodextrin, wheat or a wheat component, sucrose, starch, Na₂SO₄, Talc, PVA, sorbitol, benzoate, sorbiate, glycerol, sucrose, propylene glycol, 1,3-propane diol, glucose, parabens, sodium chloride, citrate, acetate, phosphate, calcium, metabisulfite, formate and mixtures thereof.

### Isolated

In one aspect, preferably one or more compounds according to the present invention are in isolated form. The term “isolated” means that the compound is at least substantially free from at least one other component of the fermentate. The compounds of the present invention may be provided in a form that is substantially free of one or more contaminants with which the compound might otherwise be associated. Thus, for example it may be substantially free of one or more potentially contaminating polypeptides and/or nucleic acid molecules.

In accordance with the present invention a compound is “partially isolated” when at least 10% of other fermentate constituents are removed. Suitably, a compound is partially isolated if greater than or equal to about 10, 15, 20, 25, 30, 35, 40, 45, 50, 55, 60, 65, 70, 75, 80, 85, 90, 91, 92, 93, 94, 95, 96, 97, 98, or 99% of the other fermentate constituents are removed.

### Purified

In one aspect, preferably at least one of the compounds selected from the group consisting of: a difficidin, a surfactin, a bacillomycin (e.g. bacillomycin D), a fengycin, a bacillibactin, a bacilysin, an anticapsin, a plantazolicin (microcin) a macrolactin, a bacillaene and a LCI, or a homologue thereof or an analogue thereof, is in a purified form. The compound is desirably the predominant component present in a fermentation product of the composition. The term “purified” means that the given compound is present at a high level. Preferably, it is present at a level of at least about 90%, or at least about 95% or at least about 98%, said level being determined on a dry weight/dry weight basis with respect to the total fermentation product under consideration.

The term “compound” as used herein refers to a single compound and/or a plurality of compounds. Thus, in one aspect, where there is reference to the amount and/or level of a compound, this refers to the total combined amounts and/or levels of compounds having anti-contaminant activity, preferably the total combined amounts and/or levels of the following compounds: a difficidin, a surfactin, a bacillomycin (e.g. bacillomycin D), a fengycin, a bacillibactin, a bacilysin, an anticapsin, a plantazolicin (microcin) a macrolactin, a bacillaene and a LCI, or a homologue thereof or an analogue thereof.

### Variants/Homologues/Derivatives

The term “variant” and/or “derivative” means an entity having a structural and/or functional similarity with a subject molecule, wherein differences between the subject molecule and the “variant” and/or “derivative” occur at an atomic level.

The present invention also encompasses the use of variants, homologues and derivatives of any amino acid sequence of a polypeptide.

Here, the term “homologue” means an entity having a certain homology with the subject amino acid sequences. Here, the term “homology” can be equated with “identity”.

In the present context, a homologous sequence is taken to include an amino acid sequence which may be at least 75, 80, 85 or 90% identical, preferably at least 95, 96, 97, 98 or 99% identical to the subject sequence. Typically, the homologues will comprise the same active sites etc. as the subject amino acid sequence. Although homology can also be considered in terms of similarity (i.e. amino acid residues having similar chemical properties/functions), in the context of the present invention it is preferred to express homology in terms of sequence identity.

In one embodiment the homologue as taught herein is an amino acid sequence which may be at least 75, 80, 85 or 90% identical, preferably at least 95, 96, 97, 98 or 99% identical to the ribosomally synthesised peptides, e.g. a plantazolicin or LCI.

In one embodiment the plantazolicin may comprise (or consist essentially of or consists of) one of the amino acid sequences MTQIKVPTALIASVHGEGQHLFEPMAARCT CTTIISSSSTF (SEQ ID No. 1) or MTKITIPTALSAKVHGEGQHLFEPMAARCT CTTIISSSSTF (SEQ ID No. 2) or MITTTALPRAAAVTTTVYGEGLHLFEPMAARCTCSTVISTTCTWG (SEQ ID No. 3) or MSTLINKLPPAVSTDSSKIVSEVQAFEPTAARCSCTTIPCCCCCGG (SEQ ID No. 4) or MSTLISKLPPAVSTDSSKIVSEVQAFEPTAARCSCTTLPCCCCSGG (SEQ ID No. 5) or a homologue, derivative or variant thereof.

In one embodiment the homologue as taught herein is an amino acid sequence which may be at least 75, 80, 85 or 90% identical, preferably at least 95, 96, 97, 98 or 99% identical to the one of the amino acid sequences MTQIKVPTALIASVHGEGQHLFEPMAARCT CTTIISSSSTF (SEQ ID No. 1), MTKITIPTALSAKVHGEGQHLFEPMAARCT CTTIISSSSTF (SEQ ID No. 2), MITTTALPRAAAVTTTVYGEGLHLFEPMAARCTCSTVISTTCTWG (SEQ ID No. 3), MSTLINKLPPAVSTDSSKIVSEVQAFEPTAARCSCTTIPCCCCCGG (SEQ ID No. 4), or MSTLISKLPPAVSTDSSKIVSEVQAFEPTAARCSCTTLPCCCCSGG (SEQ ID No. 5).

In one embodiment the homologue as taught herein is an amino acid sequence which may be at least 75, 80, 85 or 90% identical, preferably at least 95, 96, 97, 98 or 99% identical to the one of the amino acid sequences MTQIKVPTALIASVHGEGQHLFEPMAARCT CTTIISSSSTF (SEQ ID No. 1), MTKITIPTALSAKVHGEGQH LFEPMAARCT CTTIISSSSTF (SEQ ID No. 2), MITTTALPRAAAVTTTVYGEGLHLFEPMAARCTCSTVISTTCTWG (SEQ ID No. 3), MSTLINKLPPAVSTDSSKIVSEVQAFEPTAARCSCTTIPCCCCCGG (SEQ ID No. 4), or MSTLISKLPPAVSTDSSKIVSEVQAFEPTAARCSCTTLPCCCCSGG (SEQ ID No. 5), wherein the homologue is an anti-contaminant (e.g. anti-microbial) agent, for example the homologue is functionally equivalent to a plantazolicin.

In one embodiment the LCI may comprise (or consist essentially of or consists of) one of the amino acid sequences MKFKKVLTGSALSLALLMSAAPAFAASPTASVENSPISTKADAGINAIKLVQSPNGNFAASFV LDGTKWIFKSKYYDSSKGYWVGIYESVDK (SEQ ID No. 6); MKFKKVLTGSALSLALLMSAAPAFAASPTASASAENSPISTKADAGINAIKLVQSPNGNFAAS FVLDGTKWIFKSKYYDSSKGYWVGIYESVDK (SEQ ID No. 7); AIKLVQSPNGNFAASFVLDGTKWIFKSKYYDSSKGYWVGIYEVWDRK (SEQ ID No. 8); MFLLVFLCCLHLVISSHTPDESFLCYQPDQVCCFICRGAAPLPSEGECNPHPTAPWCREGA VEWVPYSTGQCRTTCIPYVE (SEQ ID No. 9);MKFKKVLTGSALSLALLMSAAPAFAASPTASASVENSPISTKADAGINAIKLVQSPNGNFA ASFVLDGTKWIFKSKYYDSSKGYWVGIYESVDK (SEQ ID No. 10); MKFKKVLTGSALSLALLMSAAPAFAASPTASASAENSPIS TKADAGINAIKLVQSPNGNFAASFVLDGTTWIFKSKYYDSSKGYWVGIYESVDK (SEQ ID No. 11); or a homologue, derivative or variant thereof.

In one embodiment the homologue as taught herein is an amino acid sequence which may be at least 75, 80, 85 or 90% identical, preferably at least 95, 96, 97, 98 or 99% identical to the one of the amino acid sequences shown herein as SEQ ID No. 6, SEQ ID No. 7, SEQ ID No. 8, SEQ ID No. 9, SEQ ID No. 10 or SEQ ID No. 11.

In one embodiment the homologue as taught herein is an amino acid sequence which may be at least 75, 80, 85 or 90% identical, preferably at least 95, 96, 97, 98 or 99% identical to the one of the amino acid sequences shown herein as SEQ ID No. 6, SEQ ID No. 7, SEQ ID No. 8, SEQ ID No. 9, SEQ ID No. 10 or SEQ ID No. 11, wherein the homologue is an anti-contaminant (e.g. anti-microbial) agent, for example the homologue is functionally equivalent to an LCI.

Homology comparisons can be conducted by eye, or more usually, with the aid of readily available sequence comparison programs. These commercially available computer programs can calculate % homology between two or more sequences.

% homology may be calculated over contiguous sequences, i.e. one sequence is aligned with the other sequence and each amino acid in one sequence is directly compared with the corresponding amino acid in the other sequence, one residue at a time. This is called an “ungapped” alignment. Typically, such ungapped alignments are performed only over a relatively short number of residues.

Although this is a very simple and consistent method, it fails to take into consideration that, for example, in an otherwise identical pair of sequences, one insertion or deletion will cause the following amino acid residues to be put out of alignment, thus potentially resulting in a large reduction in % homology when a global alignment is performed. Consequently, most sequence comparison methods are designed to produce optimal alignments that take into consideration possible insertions and deletions without penalising unduly the overall homology score. This is achieved by inserting “gaps” in the sequence alignment to try to maximise local homology.

However, these more complex methods assign “gap penalties” to each gap that occurs in the alignment so that, for the same number of identical amino acids, a sequence alignment with as few gaps as possible—reflecting higher relatedness between the two compared sequences—will achieve a higher score than one with many gaps. “Affine gap costs” are typically used that charge a relatively high cost for the existence of a gap and a smaller penalty for each subsequent residue in the gap. This is the most commonly used gap scoring system. High gap penalties will of course produce optimised alignments with fewer gaps. Most alignment programs allow the gap penalties to be modified. However, it is preferred to use the default values when using such software for sequence comparisons. For example when using the GCG Wisconsin Bestf it package the default gap penalty for amino acid sequences is −12 for a gap and −4 for each extension.

Calculation of maximum % homology therefore firstly requires the production of an optimal alignment, taking into consideration gap penalties. A suitable computer program for carrying out such an alignment is the GCG Wisconsin Bestfit package (Devereux et al 1984 Nuc. Acids Research 12 p 387). Examples of other software than can perform sequence comparisons include, but are not limited to, the BLAST package (see Ausubel et al., 1999 Short Protocols in Molecular Biology, 4^{th} Ed—Chapter 18), FASTA (Altschul et al., 1990 J. Mol. Biol. 403-410) and the GENEWORKS suite of comparison tools. Both BLAST and FASTA are available for offline and online searching (see Ausubel et al., 1999, Short Protocols in Molecular Biology, pages 7-58 to 7-60). However, for some applications, it is preferred to use the GCG Bestfit program. A new tool, called BLAST 2 Sequences is also available for comparing protein and nucleotide sequence (see FEMS Microbiol Lett 1999 174(2): 247-50; FEMS Microbiol Lett 1999 177(1): 187-8 and tatiana@ncbi.nlm.nih.gov).

Although the final % homology can be measured in terms of identity, the alignment process itself is typically not based on an all-or-nothing pair comparison. Instead, a scaled similarity score matrix is generally used that assigns scores to each pairwise comparison based on chemical similarity or evolutionary distance. An example of such a matrix commonly used is the BLOSUM62 matrix—the default matrix for the BLAST suite of programs. GCG Wisconsin programs generally use either the public default values or a custom symbol comparison table if supplied (see user manual for further details). For some applications, it is preferred to use the public default values for the GCG package, or in the case of other software, the default matrix, such as BLOSUM62.

Alternatively, percentage homologies may be calculated using the multiple alignment feature in DNASIS™ (Hitachi Software), based on an algorithm, analogous to CLUSTAL (Higgins D G & Sharp P M (1988), Gene 73(1), 237-244).

Once the software has produced an optimal alignment, it is possible to calculate % homology, preferably % sequence identity. The software typically does this as part of the sequence comparison and generates a numerical result.

The sequences may also have deletions, insertions or substitutions of amino acid residues which produce a silent change and result in a functionally equivalent substance. Deliberate amino acid substitutions may be made on the basis of similarity in polarity, charge, solubility, hydrophobicity, hydrophilicity, and/or the amphipathic nature of the residues as long as the secondary binding activity of the substance is retained. For example, negatively charged amino acids include aspartic acid and glutamic acid; positively charged amino acids include lysine and arginine; and amino acids with uncharged polar head groups having similar hydrophilicity values include leucine, isoleucine, valine, glycine, alanine, asparagine, glutamine, serine, threonine, phenylalanine, and tyrosine.

Conservative substitutions may be made, for example according to the Table below. Amino acids in the same block in the second column and preferably in the same line in the third column may be substituted for each other:

| | | |
|---|---|---|
| ALIPHATIC | Non-polar | G A P |
| | | I L V |
| | Polar - uncharged | C S T M |
| | | N Q |
| | Polar - charged | D E |
| | | K R |
| AROMATIC | | H F W Y |

The present invention also encompasses homologous substitution (substitution and replacement are both used herein to mean the interchange of an existing amino acid residue, with an alternative residue) that may occur i.e. like-for-like substitution such as basic for basic, acidic for acidic, polar for polar etc. Non-homologous substitution may also occur i.e. from one class of residue to another or alternatively involving the inclusion of unnatural amino acids such as ornithine (hereinafter referred to as Z), diaminobutyric acid ornithine (hereinafter referred to as B), norleucine ornithine (hereinafter referred to as O), pyriylalanine, thienylalanine, naphthylalanine and phenylglycine.

Replacements may also be made by unnatural amino acids include; alpha* and alpha-disubstituted* amino acids, N-alkyl amino acids*, lactic acid*, halide derivatives of natural amino acids such as trifluorotyrosine*, p-Cl-phenylalanine*, p-Br-phenylalanine*, p-l-phenylalanine*, L-allyl-glycine*, β-alanine*, L-α-amino butyric acid*, L-γ-amino butyric acid*, L-α-amino isobutyric acid*, L-ε-amino caproic acid*, 7-amino heptanoic acid*, L-methionine sulfone^{#}*, L-norleucine*, L-norvaline*, p-nitro-L-phenylalanine*, L-hydroxyproline^{#}, L-thioproline*, methyl derivatives of phenylalanine (Phe) such as 4-methyl-Phe*, pentamethyl-Phe*, L-Phe (4-amino)^{#}, L-Tyr (methyl)*, L-Phe (4-isopropyl)*, L-Tic (1,2,3,4-tetrahydroisoquinoline-3-carboxyl acid)*, L-diaminopropionic acid^{#} and L-Phe (4-benzyl)*. The notation * has been utilised for the purpose of the discussion above (relating to homologous or non-homologous substitution), to indicate the hydrophobic nature of the derivative whereas # has been utilised to indicate the hydrophilic nature of the derivative, #* indicates amphipathic characteristics.

Variant amino acid sequences may include suitable spacer groups that may be inserted between any two amino acid residues of the sequence including alkyl groups such as methyl, ethyl or propyl groups in addition to amino acid spacers such as glycine or β-alanine residues. A further form of variation, involves the presence of one or more amino acid residues in peptoid form, will be well understood by those skilled in the art. For the avoidance of doubt, “the peptoid form” is used to refer to variant amino acid residues wherein the α-carbon substituent group is on the residue's nitrogen atom rather than the α-carbon. Processes for preparing peptides in the peptoid form are known in the art, for example Simon R J et al., PNAS (1992) 89(20), 9367-9371 and Horwell D C, Trends Biotechnol. (1995) 13(4), 132-134.

The invention will now be described, by way of example only, with reference to the following Figures and Examples.

### EXAMPLES

### Example 1

### Preparation of the Antibacterial Samples Growth of Antimicrobial Strains

Strains: Bacillus subtilis 22C-P1 (DCS1579), 15A-P4 (DCS1580), 3A-P4 (DCS1581), LSSAO1 (DCS1582), ABP278 (DCS1583) and BS18 (DCS1584) were revived from deep frozen stock cultures on blood agar. An isolated colony of each of the cultures was streaked on CASO agar and incubated aerobically at 32° C. for 24 hours. One colony of each was transferred to 10 ml of CASO broth in a 50 ml SARSTEDT tube and incubated shaking at inclination at 130 rpm at 32° C. for 24 hours. 0.5 ml of the grown culture was transferred to 50 ml of CASO broth in a 250 ml Erlenmeyer flask and incubated shaking at 130 rpm at 32° C. for 24 hours.

### Preparation of the Antibacterial Supernatant Samples

The fully grown cultures were centrifuged twice at 10.000×g for 10 minutes. The supernatant was filter sterilized (using vacuum) and the filtrate was used immediately.

### Example 2

### Inhibition Range Assay

The well diffusion assay was used to assess the inhibitory range of the cell free supernatants (CFSs) prepared in Example 1 against a number of target microorganisms (Table 1). For each indicator microorganism a plate was made. 30 ml of molten agar media including 3 ml 2M sodium phosphate pH 6.5 was inoculated with 150 μl of a fully grown overnight culture and mixed well. The suspension was poured into omnitrays and let set for 30 minutes. 6 wells were cut with into the agar and left to dry open in a LAF bench for another 30 minutes. Each duplicate well were filled with 100 μl of the supernatants as prepared earlier and incubated at the respective temperature, time and conditions as shown in Table 1. After the incubation time, the hallo diameters were assessed and divided into groups of inhibition. For halo diameters, including the well, up to 10 mm activities were marked with a “+”, for halos up to 16 mm with a “++” and for over 16 mm with a “+++”.

TABLE 1
List of indicator microorganisms used for the first inhibition range screening

| Collection | | | | | |
|---|---|---|---|---|---|
| No. | Spec. | Temp. | Conditions | Time | Microorganism |
| DCS 500 | Gram+ | 30° C. | Aerobic | 24 H | Bacillus cereus |
| DCS 782 | Gram+ | | | | Brochothrix thermosphacta |
| DCS 561 | Gram+ | | | | Bacillus licheniformis |
| DCS 413 | Gram+ | 30° C. | Anaerobic | 24 H | Staphylococcus epidermidis |
| DCS 630 | Gram+ | | | | Staphylococcus aureus |
| DCS 489 | Gram+ | 30° C. | Aerobic | 24 H | Listeria monocytogenes |
| DCS 490 | Gram+ | | | | Listeria monocytogenes |
| DCS 17 | Gram+ | | | | Listeria innocua |
| DCS 573 | Gram+ | 30° C. | Microaerophillic | 24 H | Lactobacillus fermentum |
| DCS 609 | Gram+ | | | | Lactobacillus curvatus |
| DCS 608 | Gram+ | | | | Lactobacillus sakei |
| DCS 611 | Gram+ | 30° C. | Microaerophillic | 24 H | Lactobacillus farciminis |
| DCS 189 | Gram+ | | | | Lactobacillus plantarum |
| DCS 512 | Gram+ | | | | Leuconostoc mesenteroides |
| DCS 495 | Gram− | 30° C. | Aerobic | 24 H | Escherichia coli |
| DCS 496 | Gram− | | | | Escherichia coli |
| DCS 497 | Gram− | | | | Escherichia coli |
| DCS 567 | Gram− | 30° C. | Aerobic | 24 H | Klebsiella oxytoca |
| DCS 566 | Gram− | | | | Citrobacter freundii |
| DCS 428 | Gram− | | | | Pseudomonas fluorescens |
| DCS 599 | Y&M | 25° C. | Aerobic | 48 H | Saccharomyces cerevisiae |
| DCS 538 | Y&M | | | | Zygosaccharomyces bailii |
| DCS 1087 | Y&M | | | | Rhodotorula mucilaginosa |
| DCS 606 | Y&M | 25° C. | Aerobic | 48 H | Rhodotorula glutinis |
| DCS 603 | Y&M | | | | Pichia anomala |
| DCS 1089 | Y&M | | | | Kluyveromyces marxianus |
| DCS 1090 | Y&M | 25° C. | Aerobic | 48 H | Candida parapsilosis |
| DCS 604 | Y&M | | | | Candida tropicalis |
| DCS 605 | Y&M | | | | Debaryomyces hansenii |
| DCS 1326 | Y&M | 25° C. | Aerobic | 48 H | Penicillium commune |
| DCS 1069 | Y&M | | | | Aspergillus versicolor |
| DCS 709 | Y&M | | | | Aspergillus parasiticus |
| DCS 1152 | Gram− | 30° C. | Aerobic | 24 H | Salmonella enteritidis |
| DCS 223 | Gram− | | | | Salmonella typhimurium |
| DCS 613 | Gram− | | | | Hafnia alvei |
| DCS 541sp | Gram+ | 37AN° C. | Anaerobic | 24 H | Clostridium sporogenes spores |
| DCS 808sp | Gram+ | | | | Clostridium sporogenes spores |
| DCS 812sp | Gram+ | | | | Clostridium sporogenes spores |
| DCS 500sp | Gram+ | 30° C. | Aerobic | 24 H | Bacillus cereus spores |
| DCS 561sp | Gram+ | | | | Bacillus licheniformis spores |
| DCS 15 | Gram− | 37° C. | Aerobic | 24 H | Escerichia coli (O157:H7) |
| DCS 215 | Gram− | | | | Shigella flexneri |
| DCS 216 | Gram− | | | | Yersinia enterocolitica (Heat |
| | | | | | stbl. Toxin) |
| DCS 225 | Gram− | | | | Salmonella enterica ser. |
| | | | | | Paratyphi |
| DCS 429 | Gram− | | | | Shigella sonnei |
| DCS 492 | Gram− | 37° C. | Aerobic | 24 H | Escherichia coli |
| DCS 493 | Gram− | | | | Escherichia coli |
| DCS 494 | Gram− | | | | Escherichia coli |
| DCS 546 | Gram− | | | | Escherichia coli (Antibiotic |
| | | | | | control str.) |
| DCS 558 | Gram− | | | | Escherichia coli (Q-ctrl. b- |
| | | | | | lactamase) |
| DCS 1130 | Gram− | 42° C. | Microaerophillic | 24-48 H | Campylobacter jejunii |
| DCS 1131 | Gram− | | | | Campylobacter jejunii |
| DCS 1132 | Gram− | | | | Campylobacter jejunii |
| DCS 1133 | Gram− | | | | Campylobacter jejunii |
| DCS 1402 | Gram− | | | | Campylobacter jejunii |
| DCS 1143 | Gram− | 37° C. | Aerobic | 24 H | Salmonella enterica ser. |
| | | | | | Typhimurium |
| DCS 1145 | Gram− | | | | Salmonella enterica ser. |
| | | | | | Kedougou |
| DCS 1147 | Gram− | | | | Salmonella enterica ser. |
| | | | | | Settenberg |
| DCS 1148 | Gram− | | | | Salmonella enterica ser. Infantis |
| DCS 1152 | Gram− | | | | Salmonella enterica ser. |
| | | | | | Enteritidis |
| DCS 1319 | Gram+ | 30° C. | Aerobic | 24 H | Bacillus cereus |
| DCS 1320 | Gram+ | | | | Bacillus cereus |
| DCS 406 | Gram+ | | | | Bacillus cereus |
| DCS 1321 | Gram+ | | | | Bacillus coagulans |
| DCS 724 | Gram+ | | | | Bacillus coagulans |
| DCS 725 | Gram+ | | | | Bacillus coagulans |
| DCS 1322 | Gram+ | | | | Bacillus licheniformis |
| DCS 1323 | Gram+ | | | | Bacillus licheniformis |
| DCS 1324 | Gram+ | | | | Bacillus licheniformis |
| DCS 1622 | Gram+ | | | | Bacillus subtilis |
| DCS 773 | Gram+ | | | | Bacillus subtilis |
| DCS 774 | Gram+ | | | | Bacillus subtilis |
| DCS 800 | Gram+ | 37AN° C. | Anaerobic | 48 H | Clostridium perfringens |
| DCS 801 | Gram+ | | | | Clostridium perfringens |
| DCS 479 | Gram+ | | | | Clostridium tyrobutyricum |
| DCS 480 | Gram+ | | | | Clostridium tyrobutyricum |
| DCS 481 | Gram+ | | | | Clostridium tyrobutyricum |
| DCS 1288 | Gram+ | 37° C. | Aerobic | 24 H | Staphylococcus aureus |
| DCS 1623 | Gram+ | | | | Staphylococcus aureus |
| DCS 232 | Gram+ | | | | Staphylococcus aureus |
| DCS 413 | Gram+ | | | | Staphylococcus epidermidis |
| DCS 1404 | Gram+ | | | | Staphylococcus epidermidis |
| DCS 23 | Gram+ | 37° C. | Aerobic | 24 H | Listeria monocytogenes |
| DCS 1081 | Gram+ | | | | Listeria monocytogenes |
| DCS 1082 | Gram+ | | | | Listeria monocytogenes |
| DCS 376 | Gram+ | | | | Listeria monocytogenes |
| DCS 377 | Gram+ | | | | Listeria monocytogenes |
| DCS 1427 | Gram+ | | | | Listeria monocytogenes |
| DCS 1428 | Gram+ | | | | Listeria monocytogenes |
| DCS 203 | Gram+ | 30° C. | Aerobic | 24 H | Enterococcus faecalis |
| DCS 639 | Gram+ | | | | Enterococcus faecalis |
| DCS 78 | Gram+ | | | | Enterococcus faecalis/faecium |
| DCS 212 | Gram+ | | | | Enterococcus gallinarum |

### Results

The experiments on the inhibition range are shown in Tables 2 to 4 below. The fermentates of all strains tested exhibit inhibitory activity over an extensive range of Gram-positive and Gram-negative bacteria as well as fungi.

TABLE 2
Activity of fermentates against Gram positive bacteria

| Target strain | 3AP4 | 15AP4 | 22CP1 | LSSAO1 |
|---|---|---|---|---|
| Bacillus coagulans spores (3/3) | ++ | ++ | ++ | +/++ |
| Bacillus licheniformis | + | − | + | ++ |
| Bacillus licheniformis spores (4/4) | ++ | +/++ | ++ | ++/+++ |
| Bacillus subtilis spores (2/2) | ++ | ++ | ++ | +/++ |
| Brochothrix thermosphacta | +++ | +++ | +++ | +++ |
| Clostridium perfringens | + | − | − | (++) |
| Clostridium sporogenes spores | − | ++ | + | − |
| Enterococcus faecalis (3/3) | +++/++, hazy | ++, hazy | ++, hazy | ++, hazy |
| Enterococcus gallinarum | hazy | hazy | hazy | hazy |
| Lactobacillus farciminis | ++ | ++ | ++ | ++ |
| Lactobacillus fermentum | +++ | +++ | +++ | ++ |
| Lactobacillus plantarum | ++ | ++ | ++ | + |
| Lactobacillus sakei | +++ | ++ | +++ | − |
| Leuconostoc mesenteroides | ++ | ++ | ++ | ++ |
| Listeria innocua | ++ | ++ | ++ | ++ |
| Listeria monocytogenes (9/9) | ++ | ++ | ++ | +++/++ |
| Staphylococcus aureus (2/2) | +/−, hazy | +/−, hazy | +/−, hazy | +/− |
| Staphylococcus epidermidis | hazy | hazy | hazy | hazy |

TABLE 3
Activity of fermentates against Gram negative bacteria

| Target strain | 3AP4 | 15AP4 | 22CP1 | LSSAO1 |
|---|---|---|---|---|
| Escherichia coli (9/9) | +++/++ | ++ | ++ | +++/++ |
| Hafnia alvei | ++ | ++ | ++ | ++ |
| Klebsiella oxytoca | ++ | + | ++ | ++ |
| Pseudomonas fluorescens | ++ | ++ | ++ | +++ |
| Pseudomonas putida | ++ | + | (++) | ++ |
| Salmonella enterica ser. | +++/++ | ++ | ++ | +++/++ |
| Enteritidis (2/2) | | | | |
| Salmonella enterica ser. Infantis | +++ | ++ | ++ | +++ |
| Salmonella enterica ser. | ++ | ++ | ++ | +++ |
| Kedougou | | | | |
| Salmonella enterica ser. | ++ | (++) | ++ | ++ |
| Settenberg | | | | |
| Salmonella enterica ser. | +++ | ++ | ++ | +++ |
| Typhimurium | | | | |
| Salmonella typhimurium | ++ | ++ | ++ | ++ |
| Shigella flexneri | +++ | +++ | +++ | +++ |
| Shigella sonnei | ++ | ++ | ++ | +++ |
| Yersinia enterocolitica | +++ | +++ | +++ | +++ |

TABLE 4
Activity of fermentates against fungi

| Target strain | 3AP4 | 15AP4 | 22CP1 | LSSAO1 |
|---|---|---|---|---|
| Aspergillus parasiticus | − | − | − | ++ |
| Aspergillus versicolor | − | − | + | ++ |
| Candida parapsilosis | − | − | − | ++ |
| Candida tropicalis | − | − | + | ++ |
| Citrobacter freundii | ++ | ++ | ++ | ++ |
| Debaryomyces hansenii | − | − | − | ++ |
| Kluyveromyces marxianus | − | − | − | ++ |
| Penicillium commune | − | + | ++ | +++ |
| Pichia anomala | + | ++ | ++ | ++ |
| Rhodotorula glutinis | − | − | + | ++ |
| Rhodotorula mucilaginosa | − | − | ++ | ++ |
| Saccharomyces cerevisiae | + | ++ | ++ | ++ |
| Zygosaccharomyces bailii | − | − | ++ | ++ |

### Example 3

### Susceptibility of Activity to Heat Treatment and Various pH

30 ml of the CFS of each strain was divided into 6 aliquots of 5 ml and pH adjusted to pH 4, 5, 6, 7, 8 or 9 using 5M NaOH or 5M HCl. Each pH adjusted 5 ml aliquot was filter-sterilized, divided into 5 aliquots of 0.8 ml and kept at 4° C. until use.

For each CFS heat treatment was applied as described in Table 5. 6 aliquots, one of each pH value, were heat treated at 72° C. for 15 seconds. The temperature was monitored with a temperature probe in an eppendorf tube filled with 0.8 ml of CASO broth through a hole on the lid. The 15 seconds counted from the moment the temperature reached 72° C. Another 6 aliquots were heat treated at 100° C. for 10 minutes. The temperature was monitored with a temperature probe in an eppendorf tube filled with 0.8 ml of CASO broth through a hole on the lid. The 10 minutes counted from the moment the temperature reached 95° C. 6 aliquots were incubated at 37° C. for 24 hours and another 6 were heat treated at 121° C. for 6 minutes. Finally, 6 aliquots were assayed for activity right away using the well diffusion assay. In brief, 27 ml of molten PCA agar mixed with 2.7 ml of 2M sodium phosphate pH 6.5 were tempered and seeded with 0.5% of an overnight grown culture of Listeria monocytogenes DCS1081 or Escherichia coli DCS1396. The suspension was poured into an omnitray disc and let set in a LAF bench. 12 wells were opened in the agar using a borer (2×6) and let dry open for 1 hour at room temperature in a LAF bench. 100 μl of sample was loaded in duplicate wells and let in the LAF bench until all the liquid was absorbed. The plates were then incubated at 37° C. overnight. Any halos around the wells indicated inhibition.

TABLE 5
Heat treatment protocols followed for each of the 6 CFSs

| | pH | | | | | | | Agar plates |
|---|---|---|---|---|---|---|---|---|
| Sample | 4 | 5 | 6 | 7 | 8 | 9 | Target microorganism | needed |
| SAMPLE - no treatment | ✓ | ✓ | ✓ | ✓ | ✓ | ✓ | Listeria monocytogenes | 1 |
| | | | | | | | DCS 1081 | |
| SAMPLE - 37° C. for 24 | ✓ | ✓ | ✓ | ✓ | ✓ | ✓ | Listeria monocytogenes | 1 |
| hours | | | | | | | DCS 1081 | |
| SAMPLE - 72° C. for 15 secs | ✓ | ✓ | ✓ | ✓ | ✓ | ✓ | Listeria monocytogenes | 1 |
| | | | | | | | DCS 1081 | |
| SAMPLE - 100° C. for 10 mins | ✓ | ✓ | ✓ | ✓ | ✓ | ✓ | Listeria monocytogenes | 1 |
| | | | | | | | DCS 1081 | |
| SAMPLE - 121° C. for 6 mins | ✓ | ✓ | ✓ | ✓ | ✓ | ✓ | Listeria monocytogenes | 1 |
| | | | | | | | DCS 1081 | |
| SAMPLE - no treatment | ✓ | ✓ | ✓ | ✓ | ✓ | ✓ | Escherichia coli DCS 1396 | 1 |
| SAMPLE - 37° C. for 24 | ✓ | ✓ | ✓ | ✓ | ✓ | ✓ | Escherichia coli DCS 1396 | 1 |
| hours | | | | | | | | |
| SAMPLE - 72° C. for 15 secs | ✓ | ✓ | ✓ | ✓ | ✓ | ✓ | Escherichia coli DCS 1396 | 1 |
| SAMPLE - 100° C. for 10 mins | ✓ | ✓ | ✓ | ✓ | ✓ | ✓ | Escherichia coli DCS 1396 | 1 |
| SAMPLE - 121° C. for 6 mins | ✓ | ✓ | ✓ | ✓ | ✓ | ✓ | Escherichia coli DCS 1396 | 1 |
| | | | | | | | Total | 10 |

### Results

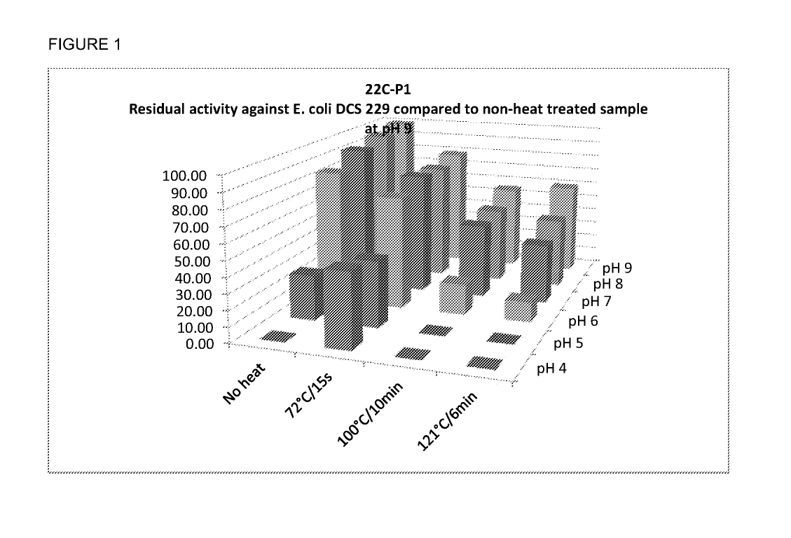

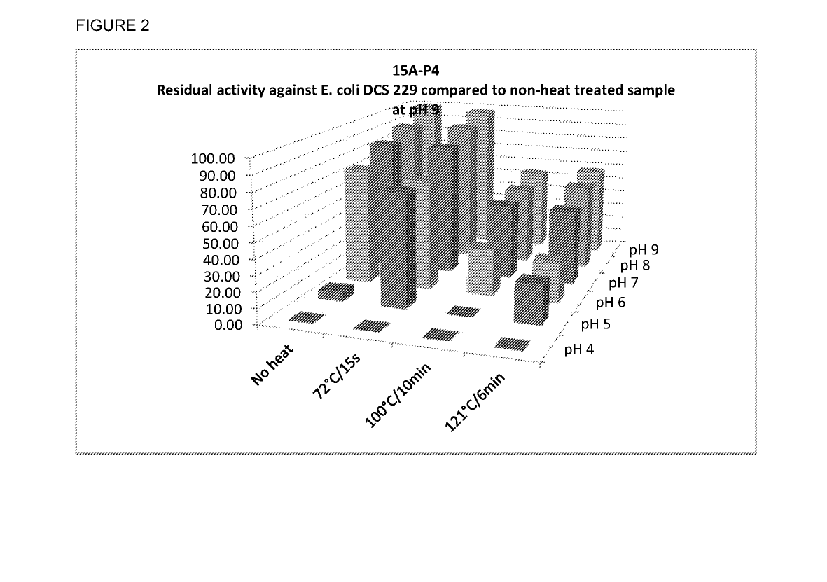

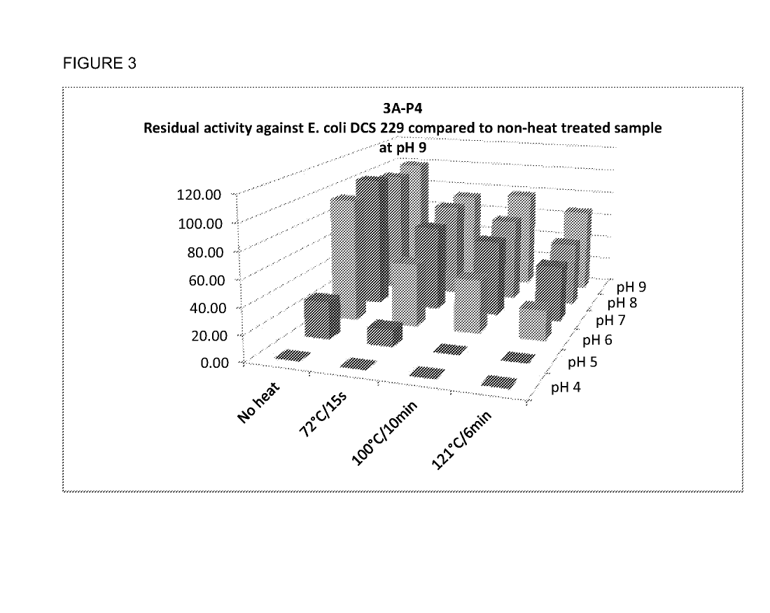

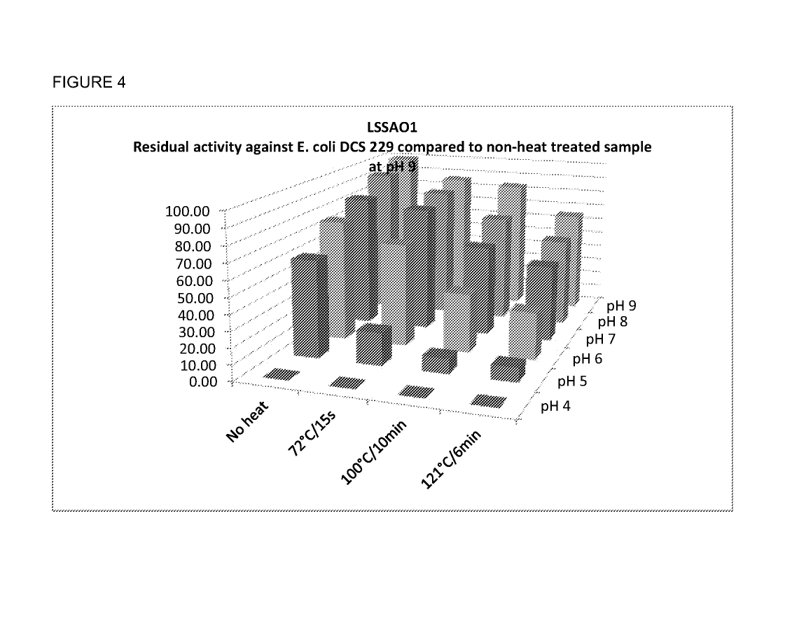

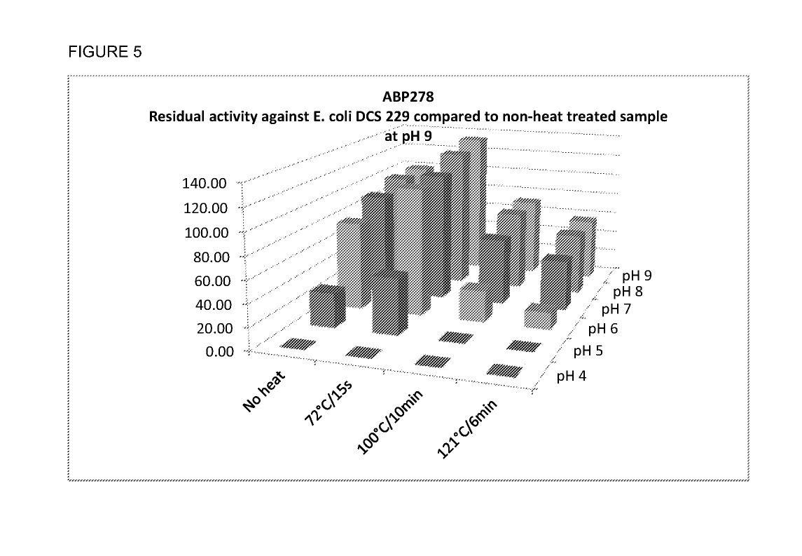

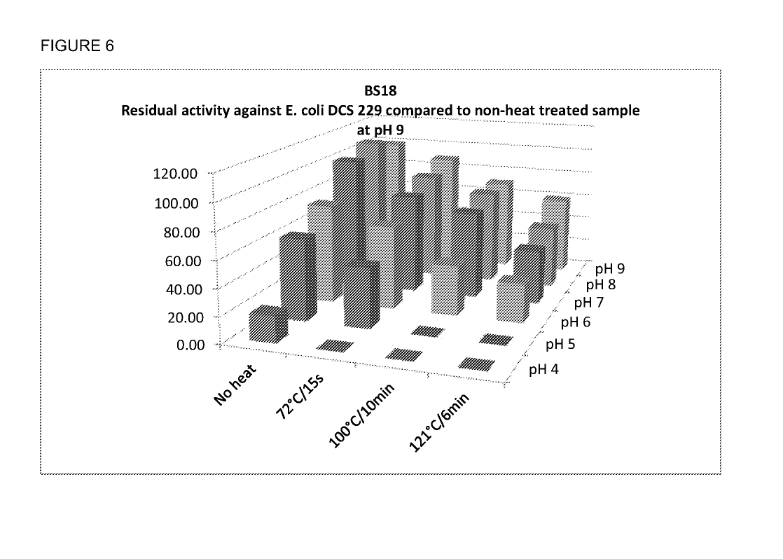

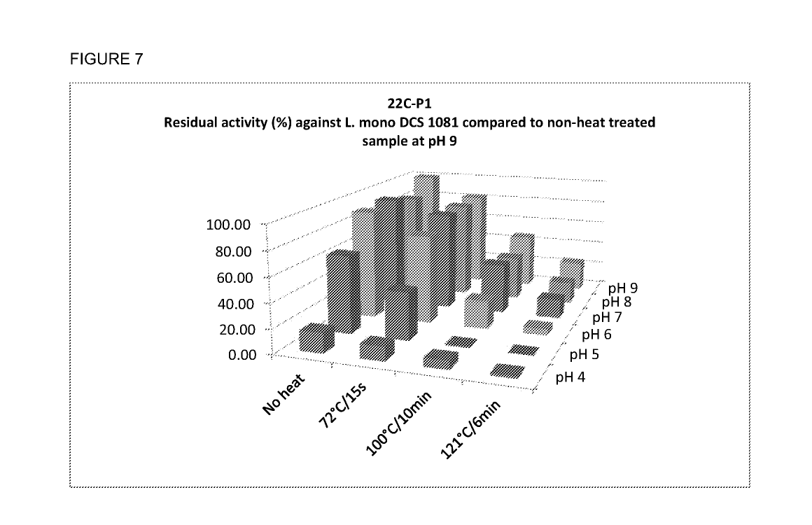

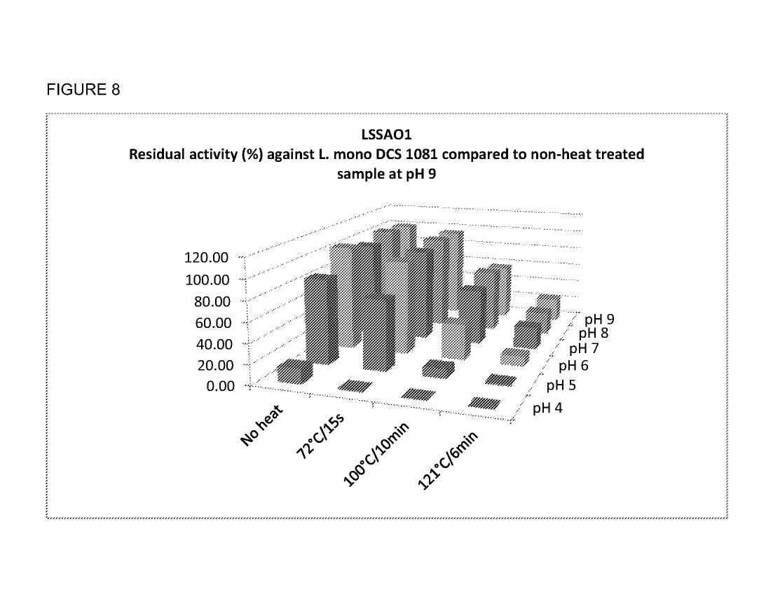

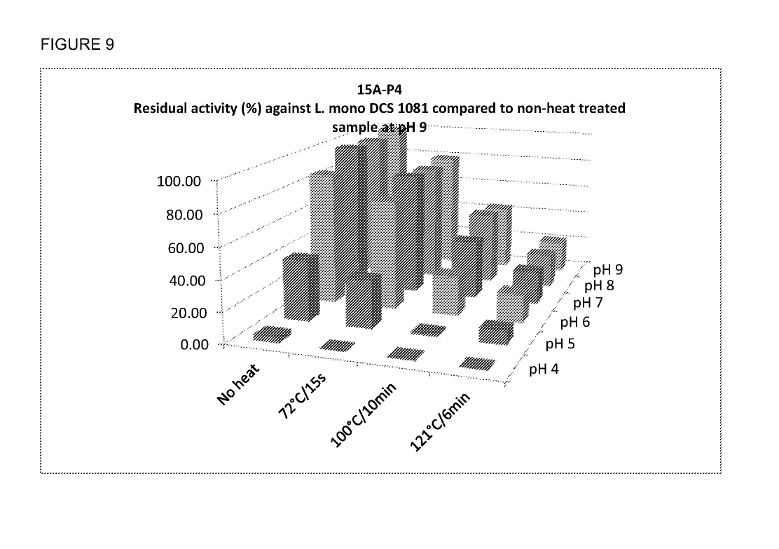

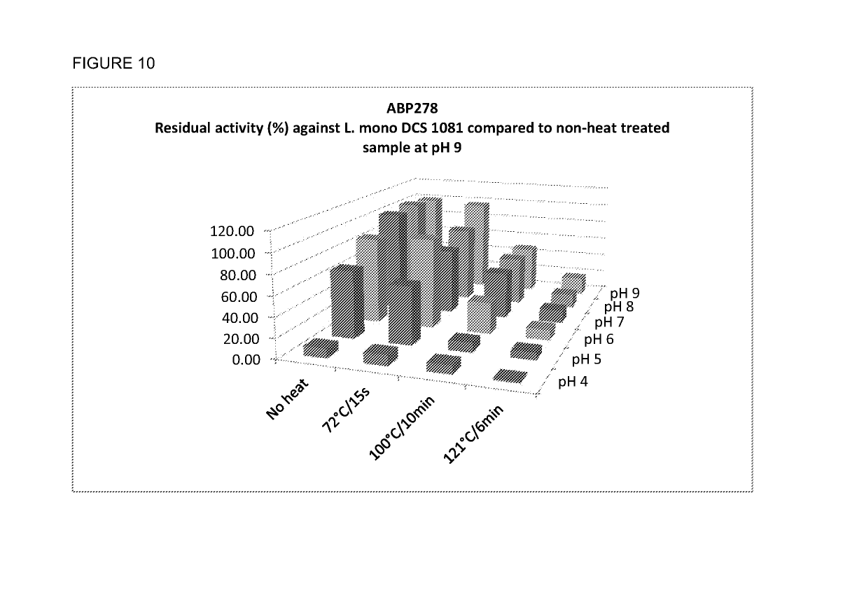

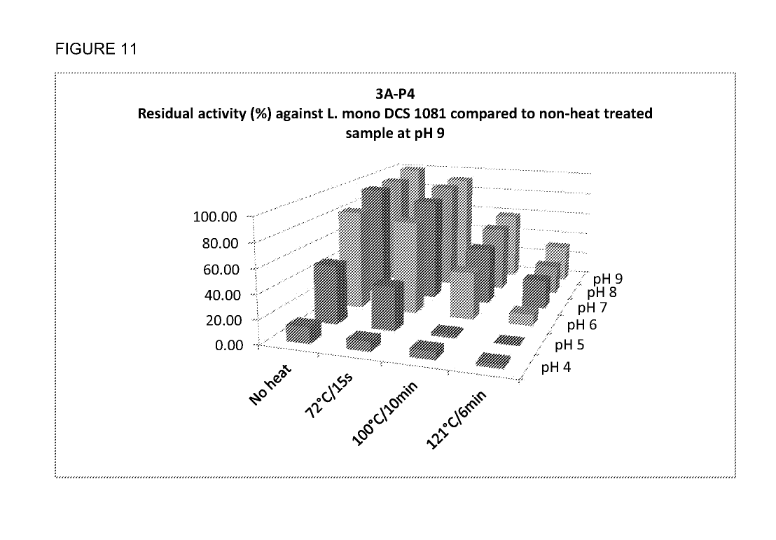

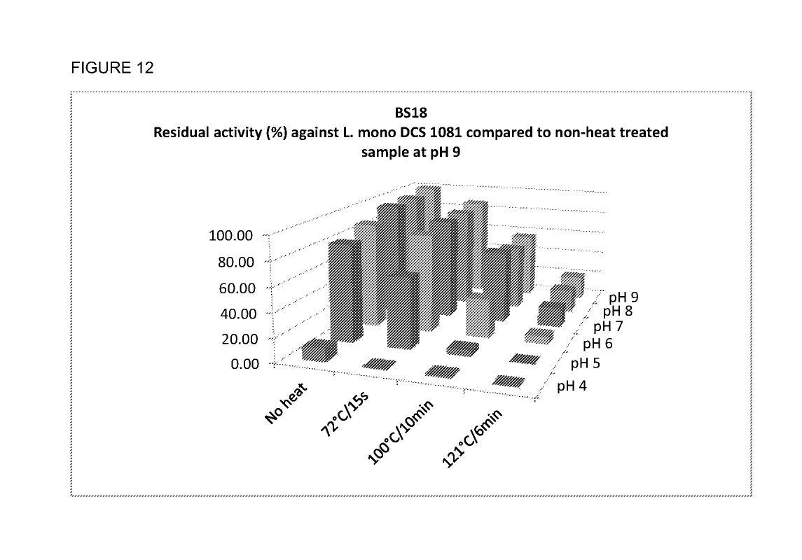

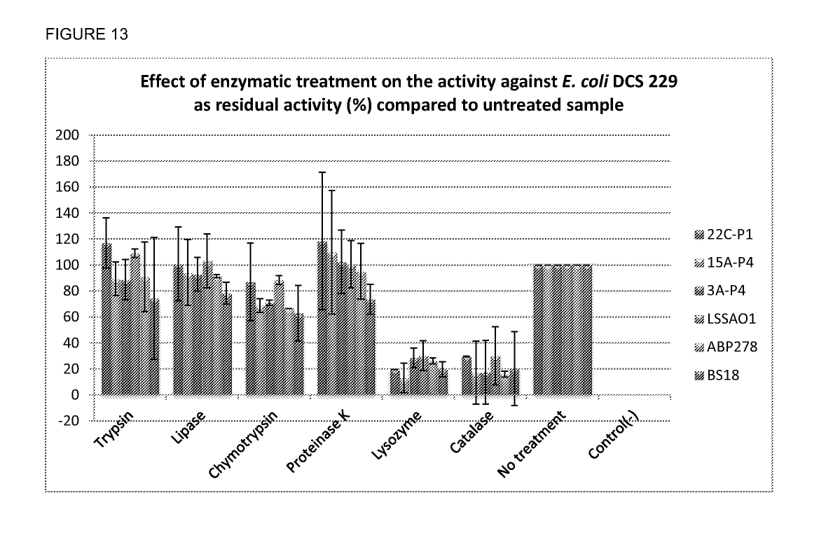

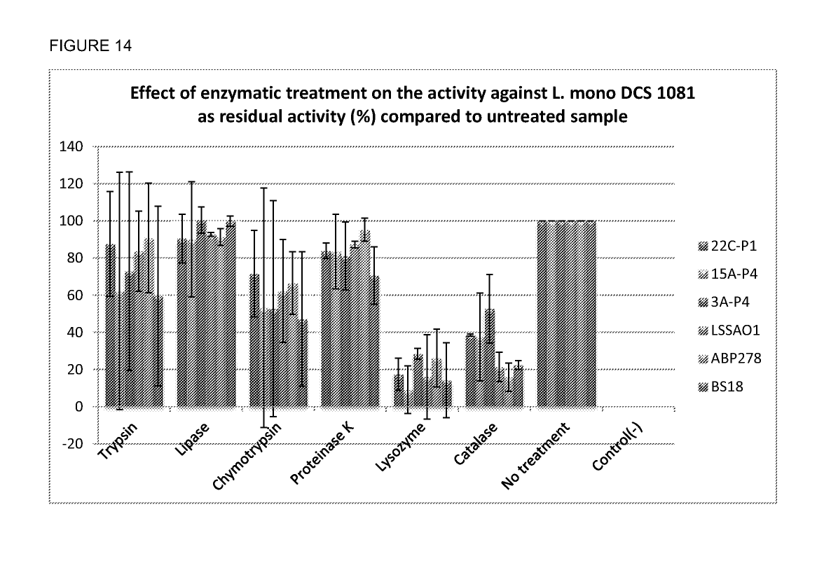

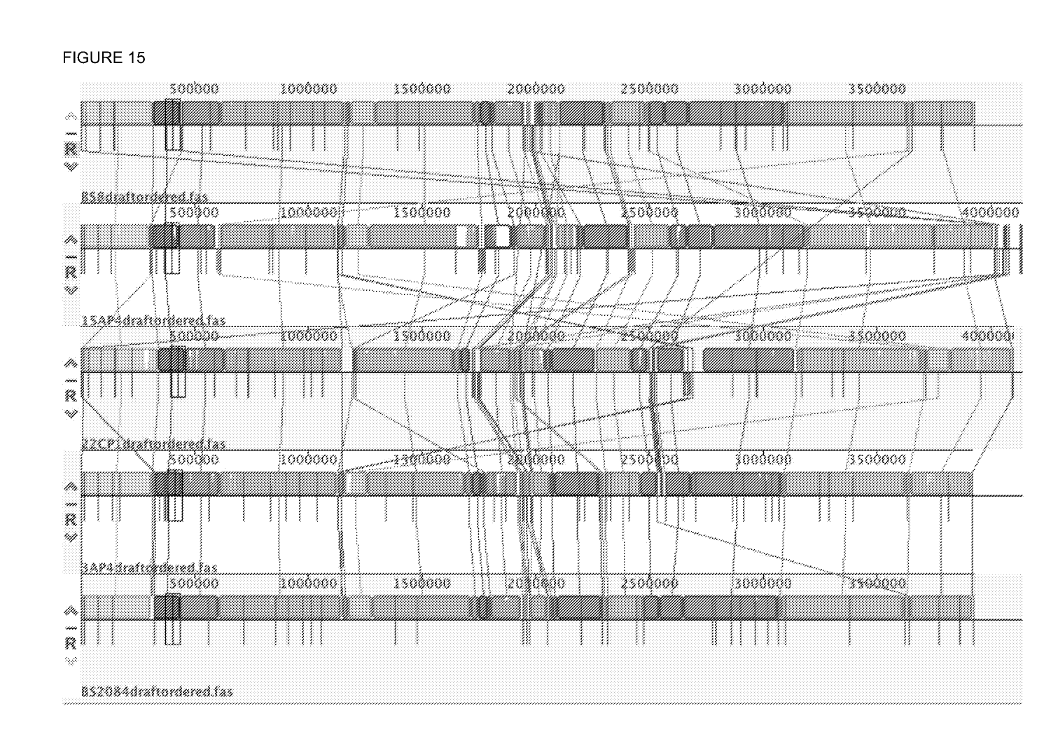

The results are shown in FIGS. 1 to 12.

All fermentates exhibited antimicrobial activity against both E. coli DCS1396 and L. monocytogenes DCS1081. The non-heat treated fermentate from BS18 exhibited the highest activity of all against E. coli while the fermentates of 22C-P1 and 3A-P4 were most active against L. monocytogenes.

In general, the anti-Gram-negative as well as the anti-Gram positive activity of the fermentates was preserved best at slightly alkaline pH (pH 8-9) independently of the heat treatment the sample received. The activity of all the fermentates against E. coli and L. monocytogenes remained intact for the most part between pH 6 and pH 9. The anti E. coli activity of most of the fermentates was virtually completely lost at pH 4. Only the fermentate from strain DCS1584 retained about 25% of its activity at this pH.

### Example 4

### Susceptibility of Activity to Enzymes

Samples of trypsin, lipase, chymotrypsin, proteinase K, lysozyme and catalase in 0.02M phosphate buffer pH 6.5 were prepared at a concentration of 20 mg/ml.

900 μl of non-pH adjusted (pH 6.8-7), CFS from each culture were mixed with 100 μl of each of the enzyme preparations. The mixtures were incubated for 4 hours at 37° C. and then heat treated at 100° C. for 5 minutes to deactivate the enzymes. After heat treatment the tubes were put directly at −20° C. for 5 minutes and then stored at 4° C. All the samples were tested for residual activity against Listeria monocytogenes DCS1081 and Escherichia coli DCS1396 (Table 6) using the well diffusion assay as described earlier.

TABLE 6
Treatment of CFSs and controls with enzymes

| | CFS | | | | | | |
|---|---|---|---|---|---|---|---|
| Sample | 1579 | 1580 | 1581 | 1582 | 1583 | 1584 | Target microorganism |
| Trypsin | ✓ | ✓ | ✓ | ✓ | ✓ | ✓ | Listeria monocytogenes |
| | | | | | | | DCS 1081 |
| Lipase | ✓ | ✓ | ✓ | ✓ | ✓ | ✓ | Listeria monocytogenes |
| | | | | | | | DCS 1081 |
| Chymotrypsin | ✓ | ✓ | ✓ | ✓ | ✓ | ✓ | Listeria monocytogenes |
| | | | | | | | DCS 1081 |
| Proteinase K | ✓ | ✓ | ✓ | ✓ | ✓ | ✓ | Listeria monocytogenes |
| | | | | | | | DCS 1081 |
| Lysozyme | ✓ | ✓ | ✓ | ✓ | ✓ | ✓ | Listeria monocytogenes |
| | | | | | | | DCS 1081 |
| Catalase | ✓ | ✓ | ✓ | ✓ | ✓ | ✓ | Listeria monocytogenes |
| | | | | | | | DCS 1081 |
| CASO - negative control | ✓ | ✓ | ✓ | ✓ | ✓ | ✓ | Listeria monocytogenes |
| | | | | | | | DCS 1081 |
| CFS - positive control | ✓ | ✓ | ✓ | ✓ | ✓ | ✓ | Listeria monocytogenes |
| | | | | | | | DCS 1081 |
| Trypsin | ✓ | ✓ | ✓ | ✓ | ✓ | ✓ | E. coli DCS 1396 |
| Lipase | ✓ | ✓ | ✓ | ✓ | ✓ | ✓ | E. coli DCS 1396 |
| Chymotrypsin | ✓ | ✓ | ✓ | ✓ | ✓ | ✓ | E. coli DCS 1396 |
| Proteinase K | ✓ | ✓ | ✓ | ✓ | ✓ | ✓ | E. coli DCS 1396 |
| Lysozyme | ✓ | ✓ | ✓ | ✓ | ✓ | ✓ | E. coli DCS 1396 |
| Catalase | ✓ | ✓ | ✓ | ✓ | ✓ | ✓ | E. coli DCS 1396 |
| CASO - negative control | ✓ | ✓ | ✓ | ✓ | ✓ | ✓ | E. coli DCS 1396 |
| CFS - positive control | ✓ | ✓ | ✓ | ✓ | ✓ | ✓ | E. coli DCS 1396 |

900 μl of CASO broth were mixed with 100 μl of each of the enzymes and followed the same incubation, heating and cooling procedure and used as negative controls. 450 μl of all CFSs were mixed with 50 μl of 0.02M phosphate buffer pH 6.5 and followed the same incubation, heating and cooling procedure to serve as positive controls. Benchmarks included 3% H₂O₂ in CASO and 100 ppm Polymyxin B (Sigma) in CASO broth. The samples were tested for residual activity against Listeria monocytogenes DCS1081 and Escherichia coli DCS1396, as shown in Table 7, using the well diffusion assay as described earlier.

TABLE 7
Treatment of benchmarks with enzymes

| | Antimicrobial | | |
|---|---|---|---|
| | preparation | | |
| | Polymyxin B | | |
| Sample | (SIGMA) | 3% H₂0₂ | Target microorganism |
| Trypsin | ✓ | | Listeria monocytogenes DCS |
| | | | 1081 |
| lipase | ✓ | | Listeria monocytogenes DCS |
| | | | 1081 |
| chymotrypsin | ✓ | | Listeria monocytogenes DCS |
| | | | 1081 |
| proteinase K | ✓ | | Listeria monocytogenes DCS |
| | | | 1081 |
| lysozyme | ✓ | | Listeria monocytogenes DCS |
| | | | 1081 |
| catalase | ✓ | ✓ | Listeria monocytogenes DCS |
| | | | 1081 |
| No treatment | ✓ | ✓ | Listeria monocytogenes DCS |
| | | | 1081 |
| No treatment | ✓ | ✓ | E. coli DCS 1396 |
| Trypsin | ✓ | | E. coli DCS 1396 |
| lipase | ✓ | | E. coli DCS 1396 |
| chymotrypsin | ✓ | | E. coli DCS 1396 |
| proteinase K | ✓ | | E. coli DCS 1396 |
| lysozyme | ✓ | | E. coli DCS 1396 |
| catalase | ✓ | ✓ | E. coli DCS 1396 |

### Results

The results are shown in graphs 13 and 14.

In general the effect of proteolytic enzymes on the anti E. coli and the anti L. monocytogenes activity of the fermentates was moderate. The results suggest that it is unlikely that lipase has an effect on any of the activities of any of the fermentates except perhaps the anti E. coli activity of the fermentate from strains ABP278 and BS18 and the anti-Listeria activity of fermentates from strains LSSAO1 and ABP278. Addition of catalase or lysozyme in any of the fermentates resulted in precipitation after the cooling-down step which in turn had a significant negative effect on almost all of the activities. The anti-E. coli and anti-L. monocytogenes activity was observed to be concentrated in the precipitate and was obviously not attributed to degradation of H₂O₂. Vigorous shaking which resulted in re-suspension of the precipitate in the liquid phase retrieved part of the activity.

Addition of catalase and/or lysozyme in an activity containing broth may prove an interesting method for the partial purification of the antimicrobial compounds.

### Example 5

### Preservation of Activity Studies

CFSs from the cultures of all 6 strains tested were prepared as described earlier. Each culture supernatant was adjusted to pH 9, filter sterilized and heat treated at 100° C. for 10 minutes as described earlier. Each heat treated CFS was then divided into 30 aliquots and stored under the conditions described in Table 20. In order to keep the aliquots in dark, the vials were wrapped with aluminium foil. For the induction of vacuum a freeze dried was used. The aliquots where poured in freeze-drying glass vials fitted with rubber lids and inserted in the freeze-dryer. Vacuum was applied until no more bubbles were generated from the liquid and the lids were closed under vacuum. Metallic lids were fitted onto the rubber lids to preserve the vacuum.

The preparations of all CFSs after step 3 (Table 19) were assayed for activity against E. coli DCS1396 and Listeria monocytogenes DCS1081 using the well diffusion assay as described earlier and considered as activity benchmark. Aliquots from all CFSs and all treatments were assayed for residual activity at 24 hours and at 13 days after production using the well diffusion assay as described earlier.

TABLE 8
Set of treatments of CFSs for the preservation of activity studies

| | Step 1 | Step 2 | Step 3 | Step 4 |
|---|---|---|---|---|
| Treatment 1 | pH 9 | Filter sterilization | 10 min @ 100° C. | 5 aliquots @ 4° C. |
| Treatment 2 | pH 9 | Filter sterilization | 10 min @ 100° C. | 5 aliquots @ −20° C. |
| Treatment 3 | pH 9 | Filter sterilization | 10 min @ 100° C. | 5 aliquots, dark @ 4° C. |
| Treatment 4 | pH 9 | Filter sterilization | 10 min @ 100° C. | 5 aliquots, dark @ −20° C. |
| Treatment 5 | pH 9 | Filter sterilization | 10 min @ 100° C. | 5 aliquots, vacuum*, @ 4° C. |
| Treatment 6 | pH 9 | Filter sterilization | 10 min @ 100° C. | 5 aliquots, vacuum*, @ −20° C. |

### Results

TABLE 9
Effect of storage conditions on activity of
fermentates against E. coli DCS 1336

| DAY 0 | |
|---|---|
| pH adjusted no heat treatment | pH adjusted + heat treatment |

Total zone diameter (including well) in mm

| | | |
|---|---|---|
| DCS 1579 | 21.04 | 19.87 |
| DCS 1580 | 19.69 | 18.67 |
| DCS 1581 | 21.65 | 19.89 |
| DCS 1582 | 21.67 | 21.11 |
| DCS 1583 | 18.58 | 18.66 |
| DCS 1584 | 16.07 | 15.67 |
| DCS 1579 | 20.49 | 19.87 |
| DCS 1580 | 19.15 | 17.47 |
| DCS 1581 | 20.59 | 20.71 |
| DCS 1582 | 21.40 | 20.65 |
| DCS 1583 | 20.15 | 17.28 |
| DCS 1584 | 15.85 | 14.31 |

Average total zone diameter (including well) in

| | | |
|---|---|---|
| DCS 1579 | 20.77 | 19.87 |
| DCS 1580 | 19.42 | 18.07 |
| DCS 1581 | 21.12 | 20.30 |
| DCS 1582 | 21.54 | 20.88 |
| DCS 1583 | 19.37 | 17.97 |
| DCS 1584 | 15.96 | 14.99 |

TABLE 10
Effect of storage conditions on activity of fermentates
against E. coli DCS 1336

| DAY 1 | | | | | |
|---|---|---|---|---|---|
| | 4° C. | 4° C. | | (−)20° C. | (−)20° C. |
| 4° C. | DARK | vacuum | (−)20° C. | dark | vacuum |

Total zone diameter (including well) in mm - 1/2

| | | | | | | |
|---|---|---|---|---|---|---|
| DCS 1579 | 16.20 | 15.67 | 19.58 | 17.80 | 18.84 | 19.91 |
| DCS 1580 | 14.17 | 14.47 | 16.77 | 15.79 | 16.77 | 17.37 |
| DCS 1581 | 15.92 | 16.18 | 18.48 | 17.26 | 18.14 | 19.04 |
| DCS 1582 | 16.89 | 17.54 | 19.41 | 18.95 | 19.50 | 19.64 |
| DCS 1583 | 13.34 | 14.17 | 16.32 | 15.25 | 16.73 | 17.16 |
| DCS 1584 | 0.00 | 0.00 | 15.39 | 14.08 | 14.95 | 14.87 |

Total zone diameter (including well) in mm - 2/2

| | | | | | | |
|---|---|---|---|---|---|---|
| DCS 1579 | 15.33 | 16.39 | 19.07 | 16.78 | 18.68 | 18.97 |
| DCS 1580 | 13.53 | 13.89 | 16.29 | 15.54 | 16.69 | 17.06 |
| DCS 1581 | 15.42 | 15.99 | 18.22 | 16.73 | 17.96 | 18.72 |
| DCS 1582 | 16.89 | 17.28 | 18.89 | 18.29 | 19.50 | 19.52 |
| DCS 1583 | 14.16 | 14.16 | 16.14 | 14.69 | 16.73 | 16.19 |
| DCS 1584 | 0.00 | 0.00 | 14.38 | 13.59 | 14.07 | 14.63 |

Average total zone diameter (including well) in

| | | | | | | |
|---|---|---|---|---|---|---|
| DCS 1579 | 15.77 | 16.03 | 19.33 | 17.29 | 18.76 | 19.44 |
| DCS 1580 | 13.85 | 14.18 | 16.53 | 15.67 | 16.73 | 17.22 |
| DCS 1581 | 15.67 | 16.09 | 18.35 | 17.00 | 18.05 | 18.88 |
| DCS 1582 | 16.89 | 17.41 | 19.15 | 18.62 | 19.50 | 19.58 |
| DCS 1583 | 13.75 | 14.17 | 16.23 | 14.97 | 16.73 | 16.68 |
| DCS 1584 | 0.00 | 0.00 | 14.89 | 13.84 | 14.51 | 14.75 |

TABLE 11
Effect of storage conditions on activity of fermentates
against E. coli DCS 1336

| DAY 13 | | | | | |
|---|---|---|---|---|---|
| | 4° C. | 4° C. | | (−)20° C. | (−)20° C. |
| 4° C. | DARK | vacuum | (−)20° C. | dark | vacuum |

Total zone diameter (including well) in mm - 1/2

| | | | | | | |
|---|---|---|---|---|---|---|
| DCS 1579 | 0.00 | 0.00 | 12.30 | 14.30 | 0.00 | 15.50 |
| DCS 1580 | 0.00 | 0.00 | 17.50 | 16.20 | 14.10 | 17.60 |
| DCS 1581 | 0.00 | 0.00 | 19.70 | 19.00 | 18.00 | 21.50 |
| DCS 1582 | 0.00 | 0.00 | 16.60 | 17.00 | 16.90 | 19.80 |
| DCS 1583 | 0.00 | 0.00 | 16.90 | 16.30 | 15.40 | 17.80 |
| DCS 1584 | 0.00 | 0.00 | 19.40 | 17.90 | 18.20 | 20.60 |

Total zone diameter (including well) in mm - 2/2

| | | | | | | |
|---|---|---|---|---|---|---|
| DCS 1579 | 0.00 | 0.00 | 12.20 | 13.90 | 0.00 | 14.80 |
| DCS 1580 | 0.00 | 0.00 | 17.60 | 16.20 | 13.80 | 17.70 |
| DCS 1581 | 0.00 | 0.00 | 18.80 | 19.00 | 17.00 | 21.20 |
| DCS 1582 | 0.00 | 0.00 | 16.30 | 17.30 | 16.60 | 19.80 |
| DCS 1583 | 0.00 | 0.00 | 15.40 | 16.50 | 14.60 | 17.00 |
| DCS 1584 | 0.00 | 0.00 | 18.80 | 17.80 | 17.00 | 20.00 |

Average total zone diameter (including well) in

| | | | | | | |
|---|---|---|---|---|---|---|
| DCS 1579 | 0.00 | 0.00 | 12.25 | 14.10 | 0.00 | 15.15 |
| DCS 1580 | 0.00 | 0.00 | 17.55 | 16.20 | 13.95 | 17.65 |
| DCS 1581 | 0.00 | 0.00 | 19.25 | 19.00 | 17.50 | 21.35 |
| DCS 1582 | 0.00 | 0.00 | 16.45 | 17.15 | 16.75 | 19.80 |
| DCS 1583 | 0.00 | 0.00 | 16.15 | 16.40 | 15.00 | 17.40 |
| DCS 1584 | 0.00 | 0.00 | 19.10 | 17.85 | 17.60 | 20.30 |

Hazy halo - impossible to accurately measure diameter

TABLE 12
Effect of storage conditions on activity of fermentates
against E. coli DCS 1336

| DAY 34 | | | | | |
|---|---|---|---|---|---|
| | 4° C. | 4° C. | | (−)20° C. | (−)20° C. |
| 4° C. | DARK | vacuum | (−)20° C. | dark | vacuum |

Total zone diameter (including well) in mm - 1/2

| | | | | | | |
|---|---|---|---|---|---|---|
| DCS 1579 | 0.00 | 0.00 | 18.30 | 16.10 | 15.80 | 17.80 |
| DCS 1580 | 0.00 | 0.00 | 16.30 | 15.50 | 0.00 | 15.70 |
| DCS 1581 | 0.00 | 0.00 | 16.30 | 17.20 | 0.00 | 18.00 |
| DCS 1582 | 0.00 | 0.00 | 18.10 | 17.20 | 16.40 | 19.70 |
| DCS 1583 | 0.00 | 0.00 | 0.00 | 15.00 | 0.00 | 16.50 |
| DCS 1584 | 0.00 | 0.00 | 0.00 | 0.00 | 0.00 | 0.00 |

Total zone diameter (including well) in mm - 2/2

| | | | | | | |
|---|---|---|---|---|---|---|
| DCS 1579 | 0.00 | 0.00 | 17.90 | 17.70 | 15.80 | 17.90 |
| DCS 1580 | 0.00 | 0.00 | 16.30 | 15.30 | 0.00 | 15.70 |
| DCS 1581 | 0.00 | 0.00 | 17.00 | 16.40 | 0.00 | 17.70 |
| DCS 1582 | 0.00 | 0.00 | 19.00 | 17.20 | 14.70 | 18.70 |
| DCS 1583 | 0.00 | 0.00 | 13.50 | 15.80 | 0.00 | 15.60 |
| DCS 1584 | 0.00 | 0.00 | 0.00 | 0.00 | 0.00 | 0.00 |

Average total zone diameter (including well) in

| | | | | | | |
|---|---|---|---|---|---|---|
| DCS 1579 | 0.00 | 0.00 | 18.10 | 16.90 | 15.80 | 17.85 |
| DCS 1580 | 0.00 | 0.00 | 16.30 | 15.40 | 0.00 | 15.70 |
| DCS 1581 | 0.00 | 0.00 | 16.65 | 16.80 | 0.00 | 17.85 |
| DCS 1582 | 0.00 | 0.00 | 18.55 | 17.20 | 15.55 | 19.20 |
| DCS 1583 | 0.00 | 0.00 | 6.75 | 15.40 | 0.00 | 16.05 |
| DCS 1584 | 0.00 | 0.00 | 0.00 | 0.00 | 0.00 | 0.00 |

Hazy halo - impossible to accurately measure diameter

It was apparent that the storage of the fermentate under vacuum dramatically improved the preservation of the activity against E. coli during storage. This was especially obvious in samples stored at 4° C. where storage under vacuum managed to retain almost 100% of the initial activity of the fermentates against E. coli compared to samples stored at 4° C. without vacuum where the activity was completely lost after 34 days of storage.

The activity of all fermentates against Listeria monocytogenes seemed to be unaffected regardless of the preservation methods employed.

### Example 6

### Mining and Comparative Genomics of B. Subtilis Strains 22C-P1, 15A-P4, 3A-P4, BS2084 and BS8 for Secondary Metabolites

Draft genomes from 5 commercial Bacillus strains (15A-P4, 22C-P1, 3A-P4, BS2084, BS8) were compared to public Bacillus amyloliquefaciens subsp. plantarum strain FZB42. Strain FZB42 harbors a large array of nine giant gene clusters involved in the synthesis of lipopeptides and polyketides with antifungal, antibacterial, and nematocidal activity (Chen et al. 2007). Genomes were mined for secondary metabolites that would elucidate mode of action for pathogen inhibition.

### Results

TABLE 13
shows the presence of genes encoding secondary metabolites in B. subtilis strains
15A-P4, 22C-P1, 3A-P4, BS2084, LSSA01, BS18.

| | Genes in Operon | 15A-P4 | 22C-P1 | 3A-P4 | BS 2084 | LSSA01 | BS18 | ABP278 |
|---|---|---|---|---|---|---|---|---|
| Non-Ribosomal | | | | | | | | |
| Peptides | | | | | | | | |
| Surfactin | srfABCD | X | X | X | X | X | X | X |
| BacillomycinD | bmyCBAD | X | X | X | X | X | X | X |
| Fengycin | fenABCDE | X | X | X | X | X | X | X |
| Bacillibactin | dhbABCDEF | X | X | X | X | X | X | X |
| Bacilysin/anticapsin | bacABCDE | X | X | X | X | X | X | X |
| Nrs1 | nrsABCDEF | — | — | — | X | X | X | — |
| Nrs2 | Uncharacterized | X | — | — | — | — | — | — |
| Polyketides | | | | | | | | |
| Macrolactin | mlnABCDEFGHI | X | X | X | X | X | X | X |
| Difficidin | dfnAYXBCDEFGHIJKLM | X | X | X | X | X | X | X |
| Bacillaene | baeBCDEGHIJLMNRS | X | X | X | X | X | X | X |
| Ribosome | | | | | | | | |
| dependent | | | | | | | | |
| Plantazolicin | pznABCDELJIFGHK | — | — | — | X | X | X | — |
| (microcin) | | | | | | | | |
| LCI (small | LCI | X | X | X | X | X | X | X |
| peptide) | | | | | | | | |

Nrs 1 and Nrs 2 are designations for two as yet unnamed non-ribosomal peptides.

### Example 7

The well diffusion assay was used to assess the inhibitory range of the cell free supernatants (CFSs) prepared in Example 1 against a number of target microorganisms (Table 1).

The plate diffusion assay protocol used is described in Example 2.

TABLE 14
shows the broad spectrum activity of cell-free supernatants of
BS18 and ABP 278 against the contaminant microorganisms tested.

| | | Activity against tested | |
|---|---|---|---|
| | | microorganisms | |
| | | Bacillus subtilis | Bacillus subtilis |
| Cat. No. | Target microorganisms | ABP278 | BS18 |
| DCS 782 | Brochothrix thermosphacta | +++ | +++ |
| DCS 561 | Bacillus licheniformis | ++ | ++ |
| DCS 561sp | Bacillus licheniformis spores | ++ | ++ |
| DCS 1321sp | Bacillus coagulans spores | ++ | (++) |
| DCS 724sp | Bacillus coagulans spores | ++ | (++) |
| DCS 725sp | Bacillus coagulans spores | ++ | ++ |
| DCS 1322sp | Bacillus licheniformis spores | ++ | ++ |
| DCS 1323sp | Bacillus licheniformis spores | ++ | ++ |
| DCS 1324sp | Bacillus licheniformis spores | ++ | ++ |
| DCS 773sp | Bacillus subtilis spores | ++ | + |
| DCS 774sp | Bacillus subtilis spores | ++ | (++) |
| DCS 630 | Staphylococcus aureus | + | 0 |
| DCS 232 | Staphylococcus aureus | ++ | + |
| DCS 1404 | Staphylococcus epidermidis | haz | + |
| DCS 489 | Listeria monocytogenes | ++ | ++ |
| DCS 490 | Listeria monocytogenes | ++ | ++ |
| DCS 17 | Listeria innocua | ++ | ++ |
| DCS 573 | Lactobacillus fermentum | +++ | +++ |
| DCS 608 | Lactobacillus sakei | ++ | 0 |
| DCS 611 | Lactobacillus farciminis | ++ | ++ |
| DCS 189 | Lactobacillus plantarum | ++ | + |
| DCS 512 | Leuconostoc mesenteroides | ++ | ++ |
| DCS 23 | Listeria monocytogenes | ++ | ++ |
| DCS 1081 | Listeria monocytogenes | +++ | ++ |
| DCS 1082 | Listeria monocytogenes | ++ | ++ |
| DCS 376 | Listeria monocytogenes | ++ | ++ |
| DCS 377 | Listeria monocytogenes | ++ | ++ |
| DCS 1427 | Listeria monocytogenes | ++ | ++ |
| DCS 1428 | Listeria monocytogenes | ++ | ++ |
| DCS 203 | Enterococcus faecalis | ++ | ++ |
| DCS 639 | Enterococcus faecalis | ++ | ++, haz |
| DCS 78 | Enterococcus faecalis/faecium | ++ | +++ |
| DCS 212 | Enterococcus gallinarum | + | + |
| DCS 541sp | Clostridium sporogenes spores | ++ | 0 |
| DCS 800 | Clostridium perfringens | ++ | 0 |
| DCS 495 | Escherichia coli | ++ | ++ |
| DCS 496 | Escherichia coli | ++ | ++ |
| DCS 497 | Escherichia coli | ++ | ++ |
| DCS 492 | Escherichia coli | ++ | ++ |
| DCS 1396 | Escherichia coli | +++ | +++ |
| DCS 494 | Escherichia coli | ++ | ++ |
| DCS 546 | Escherichia coli (Antibiotic control | ++ | +++ |
| | str.) | | |
| DCS 558 | Escherichia coli (Q-ctrl. b-lactamase) | ++ | ++ |
| DCS 15 | Escerichia coli (O157:H7) | ++ | +++ |
| DCS 1152 | Salmonella enteritidis | ++ | ++ |
| DCS 223 | Salmonella typhimurium | ++ | ++ |
| DCS 1143 | Salmonella enterica ser. | +++ | +++ |
| | Typhimurium | | |
| DCS 1145 | Salmonella enterica ser. Kedougou | ++ | +++ |
| DCS 1147 | Salmonella enterica ser. Settenberg | ++ | ++ |
| DCS 1148 | Salmonella enterica ser. Infantis | ++ | +++ |
| DCS 1152 | Salmonella enterica ser. Enteritidis | +++ | +++ |
| DCS 567 | Klebsiella oxytoca | ++ | ++ |
| DCS 566 | Citrobacter freundii | ++ | ++ |
| DCS 428 | Pseudomonas fluorescens | ++ | ++ |
| DCS 613 | Hafnia alvei | ++ | ++ |
| DCS 458 | Pseudomonas putida | (++) | ++ |
| DCS 215 | Shigella flexneri | +++ | +++ |
| DCS 216 | Yersinia enterocolitica (Heat stbl. | +++ | +++ |
| | Toxin) | | |
| DCS 429 | Shigella sonnei | ++ | +++ |
| DCS 599 | Saccharomyces cerevisiae | ++ | ++ |
| DCS 538 | Zygosaccharomyces bailii | ++ | + |
| DCS 1087 | Rhodotorula mucilaginosa | + | 0 |
| DCS 603 | Pichia anomala | ++ | ++ |
| DCS 604 | Candida tropicalis | + | 0 |
| DCS 1326 | Penicillium commune | ++ | 0 |
| DCS 709 | Aspergillus parasiticus | + | 0 |

### Example 8

### The Effect of Storage Conditions on Activity and Application of Fermentates in a UHT Milk Food Model Experimental

Fermentate production and data for effect of storage conditions on activity

### “Effective Concentration Assay” Protocol

In a 96-well microtiter plate with flat-bottom wells, CASO broth was added in the wells according to Table 15. One hundred and fifty μl of double strength CASO broth (i.e. CASO broth made up with double the amount of powder per volume as recommended by the manufacturer) was added to wells B1, C1, D1, E1, F1, G1, B12, C12, D12, E12, F12 and G12. Wells B2-B11, C2-C11, D2-D11, E2-E11, F2-F11 and G2-G11 were filled with 100 μl of normal strength CASO broth.

TABLE 15
Filling of microtiter plate with growth media for activity assay.

| | 1 | 2 | 3 | 4 | 5 | 6 | 7 | 8 | 9 | 10 | 11 | 12 |
|---|---|---|---|---|---|---|---|---|---|---|---|---|
| A | | | | | | | | | | | | |
| B | 150 μl | 100 μl | 100 μl | 100 μl | 100 μl | 100 μl | 100 μl | 100 μl | 100 μl | 100 μl | 100 μl | 150 μl |
| | 2X | 1X | 1X | 1X | 1X | 1X | 1X | 1X | 1X | 1X | 1X | 2X |
| | CASO | CASO | CASO | CASO | CASO | CASO | CASO | CASO | CASO | CASO | CASO | CASO |
| | broth | broth | broth | broth | broth | broth | broth | broth | broth | broth | broth | broth |
| C | 150 μl | 100 μl | 100 μl | 100 μl | 100 μl | 100 μl | 100 μl | 100 μl | 100 μl | 100 μl | 100 μl | 150 μl |
| | 2X | 1X | 1X | 1X | 1X | 1X | 1X | 1X | 1X | 1X | 1X | 2X |
| | CASO | CASO | CASO | CASO | CASO | CASO | CASO | CASO | CASO | CASO | CASO | CASO |
| | broth | broth | broth | broth | broth | broth | broth | broth | broth | broth | broth | broth |
| D | 150 μl | 100 μl | 100 μl | 100 μl | 100 μl | 100 μl | 100 μl | 100 μl | 100 μl | 100 μl | 100 μl | 150 μl |
| | 2X | 1X | 1X | 1X | 1X | 1X | 1X | 1X | 1X | 1X | 1X | 2X |
| | CASO | CASO | CASO | CASO | CASO | CASO | CASO | CASO | CASO | CASO | CASO | CASO |
| | broth | broth | broth | broth | broth | broth | broth | broth | broth | broth | broth | broth |
| E | 150 μl | 100 μl | 100 μl | 100 μl | 100 μl | 100 μl | 100 μl | 100 μl | 100 μl | 100 μl | 100 μl | 150 μl |
| | 2X | 1X | 1X | 1X | 1X | 1X | 1X | 1X | 1X | 1X | 1X | 2X |
| | CASO | CASO | CASO | CASO | CASO | CASO | CASO | CASO | CASO | CASO | CASO | CASO |
| | broth | broth | broth | broth | broth | broth | broth | broth | broth | broth | broth | broth |
| F | 150 μl | 100 μl | 100 μl | 100 μl | 100 μl | 100 μl | 100 μl | 100 μl | 100 μl | 100 μl | 100 μl | 150 μl |
| | 2X | 1X | 1X | 1X | 1X | 1X | 1X | 1X | 1X | 1X | 1X | 2X |
| | CASO | CASO | CASO | CASO | CASO | CASO | CASO | CASO | CASO | CASO | CASO | CASO |
| | broth | broth | broth | broth | broth | broth | broth | broth | broth | broth | broth | broth |
| G | 150 μl | 100 μl | 100 μl | 100 μl | 100 μl | 100 μl | 100 μl | 100 μl | 100 μl | 100 μl | 100 μl | 150 μl |
| | 2X | 1X | 1X | 1X | 1X | 1X | 1X | 1X | 1X | 1X | 1X | 2X |
| | CASO | CASO | CASO | CASO | CASO | CASO | CASO | CASO | CASO | CASO | CASO | CASO |
| | broth | broth | broth | broth | broth | broth | broth | broth | broth | broth | broth | broth |
| H | | | | | | | | | | | | |

150 μl of sterile antimicrobial containing sample 1 was added in each of wells B1, C1, D1, 150 μl of sterile antimicrobial containing sample 2 in each of wells E1, F1, G1, 150 μl of sterile antimicrobial containing sample 3 in each of wells B12, C12, D12 and 150 μl of sterile antimicrobial containing sample 4 in each of wells E12, F12 and G12. Subsequently, 1.5× dilutions of the samples in these wells were done by sequentially transferring 200 μl of sample horizontally from column 1 to 5 and in reverse order from column 12 to 8 according to Table 16.

No samples were added to wells B6, C6, D6, E6, F6, G6, B7, C7, D7, E7, F7 and G7. 95 μl of normal strength CASO broth and 5 μl of target strain preparation (Table 18), adjusted to 5×10⁵ cfu/ml, were added to wells B1-B6, B8-B12, C1-C6, C8-C12, D1-D6, D8-D12, E1-E6, E8-E12, F1-F6, F8-F12, G1-G6 and G8-G12. Only 100 μl of CASO broth were added to wells C7, D7, E7, F7 and G7.

TABLE 16
Example of layout of a microtiter plate and dilutions of the antimicrobial
containing samples in it made for assaying the activity of the samples.

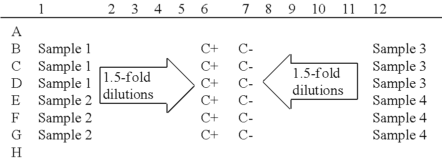

Effectively a gradient of concentration of the samples assayed was created horizontally in each of lines B1-B6, C1-C6, D1-D6, E1-E6, F1-F6 and in reverse order in lines B12-B8, C12-C8, D12-D8, E12-E8, F12-F8 and G12-G8 according to Table 17. Wells B6, C6, D6, E6, F6, G6 were used as positive control and wells B7, C7, D7, E7, F7 and G7 as negative control.

TABLE 17
Layout of concentrations of the samples assayed in the microtiter plate.

| | 1 | 2 | 3 | 4 | 5 | 6 | 7 | 8 | 9 | 10 | 11 | 12 |
|---|---|---|---|---|---|---|---|---|---|---|---|---|
| A | | | | | | | | | | | | |
| B | 25% | 16.7% | 11.1% | 7.4% | 4.9% | | | 4.9% | 7.4% | 11.1% | 16.7% | 25% |
| C | 25% | 16.7% | 11.1% | 7.4% | 4.9% | | | 4.9% | 7.4% | 11.1% | 16.7% | 25% |
| D | 25% | 16.7% | 11.1% | 7.4% | 4.9% | | | 4.9% | 7.4% | 11.1% | 16.7% | 25% |
| E | 25% | 16.7% | 11.1% | 7.4% | 4.9% | | | 4.9% | 7.4% | 11.1% | 16.7% | 25% |
| F | 25% | 16.7% | 11.1% | 7.4% | 4.9% | | | 4.9% | 7.4% | 11.1% | 16.7% | 25% |
| G | 25% | 16.7% | 11.1% | 7.4% | 4.9% | | | 4.9% | 7.4% | 11.1% | 16.7% | 25% |
| H | | | | | | | | | | | | |

TABLE 18
Target microorganisms used in this study

| Collection No | Microorganism |
|---|---|
| DCS 15 | Escherichia coli |
| DCS 492 | Escherichia coli |
| DCS 495 | Escherichia coli |
| DCS 1143 | Salmonella Typhimurium |
| DCS 1147 | Salmonella Senftenberg |
| DCS 1152 | Salmonella Enteritidis |

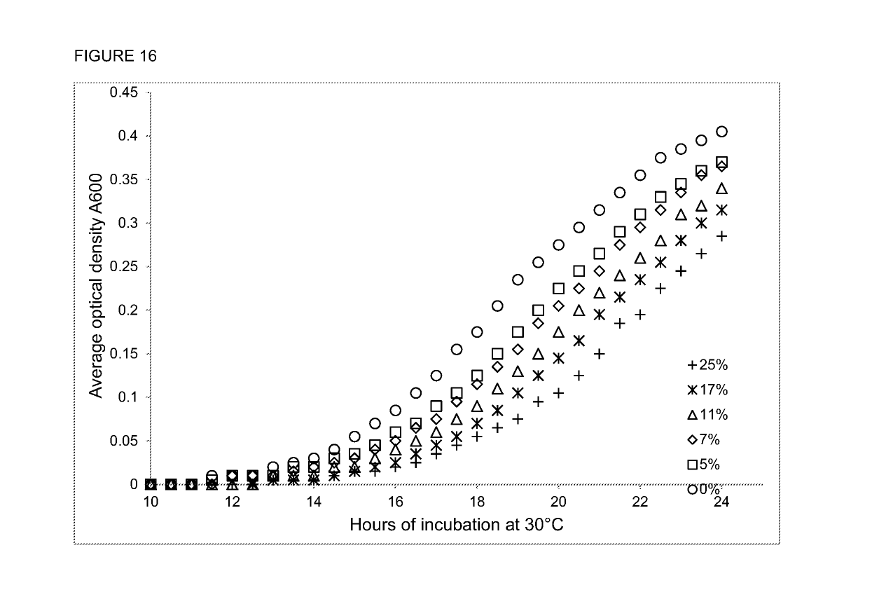

The microtiter plate was then incubated at 30° C. for 24-48 hours and the development of optical density at 620 nm of each well was monitored by periodic measurement (dt<1 h). Wells A1, B1 and C1 were triplicates of the same sample and the same concentration, wells A2, B2 and C2 were triplicate of the same sample but at ⅔ of the concentration of A1, B1 and C1 and so on. The average optical density values of the triplicates were calculated and the blank optical density (average of triplicates in column 7 for each time point) was deducted. The resulting OD values were plotted against time as seen in FIG. 16. As can be seen from the figure, the higher the concentration of the antimicrobial containing sample the slower the development of the OD.

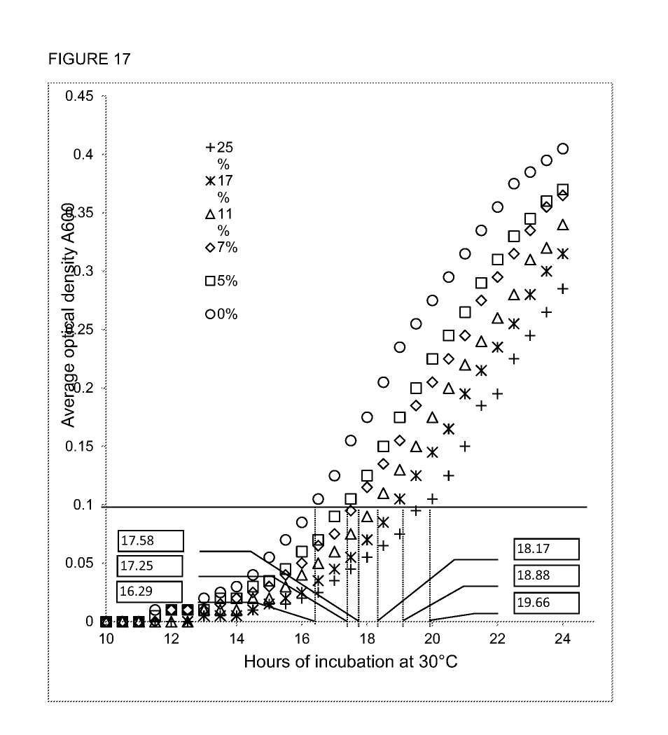

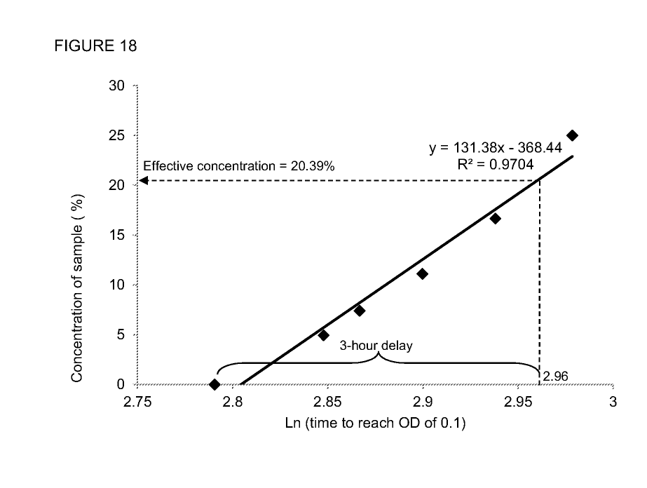

A horizontal threshold was drawn at OD=0.1 and the corresponding x value for y=0.1 for each one of the curves was extrapolated using linear correlation between two point with Microsoft Excel functions (FIG. 17). The natural logarithms (ln) of the derived x values were plotted against the concentration of sample that each of the curves represented. In the example shown in FIG. 17, the highest concentration of the fermentate is 25% and the concentrations of the dilutions are 16.7%, 11.1%, 7.4%, 4.9% and 0% respectively (for the negative control). For y=0.1 the derived x values were 19.66, 18.88, 18.17, 17.58, 17.25 and 16.29 hours respectively. The diagram plotting the natural logarithm values of time to reach OD of 0.1 to the concentration values is shown in FIG. 18.

The effective concentration of a sample was arbitrarily defined as the concentration needed to cause a 3 hour delay for the indicator microorganism culture to reach an optical density of 0.1 (620 nm), it was calculated from the trendline equation (FIG. 18) and it was expressed in % v/v.

### Determination of Activity of Liquid Samples:

The antimicrobial units per ml of a sample were defined as:

$$Units \text{/} ml = \frac{500}{effective concentration ( \% v \text{/} v )}$$

Production of fermentates in three independent experiments and assaying:

### Culturing Conditions:

Strains Bacillus subtilis 15A-P4 (DCS1580), 3A-P4 (DCS1581), LSSAO1 (DCS1582), and BS18 (DCS1584) were revived from deep frozen stock cultures on CASO agar. An isolated colony of each of the cultures was streaked on CASO agar and incubated aerobically at 32° C. until formation of well-defined colonies (24-30 hours). One colony of each of the strains was transferred to 10 ml of CASO broth in a 50 ml tube and incubated at inclination shaking at 130 rpm at 32° C. for 24 hours. One ml of the grown culture was transferred to 100 ml of CASO broth in a 500 ml conical flask and incubated with shaking at 130 rpm at 32° C. for 24 hours.

### Preparation of Different Fermentates:

The fully grown cultures were centrifuged at 10000×g for 30 minutes. The pH of the supernatant was adjusted to pH 9 using 5M KOH and heat-treat at 95° C. for 10 minutes. After cooling down 750 ppm of ascorbic acid were added and check the pH was checked again to make sure it was between pH 8 and pH 9. The solution was then filter-sterilized (0.2 μm). Three aliquots of 5 ml each were taken and one of them was assayed immediately for activity. The other two aliquots were frozen at −20° C. until assaying. The rest of the fermentate preparation was divided in 3×25 ml aliquots in sterile plastic cups and frozen at −80° C. The frozen samples were submitted to freeze drying for 2-3 days. After freeze-drying the dried powder was aseptically collected and packaged under vacuum in sterile aluminium foil bags and kept at 4° C. until assaying.

### Assaying of Different Fermentates for Antimicrobial Activity:

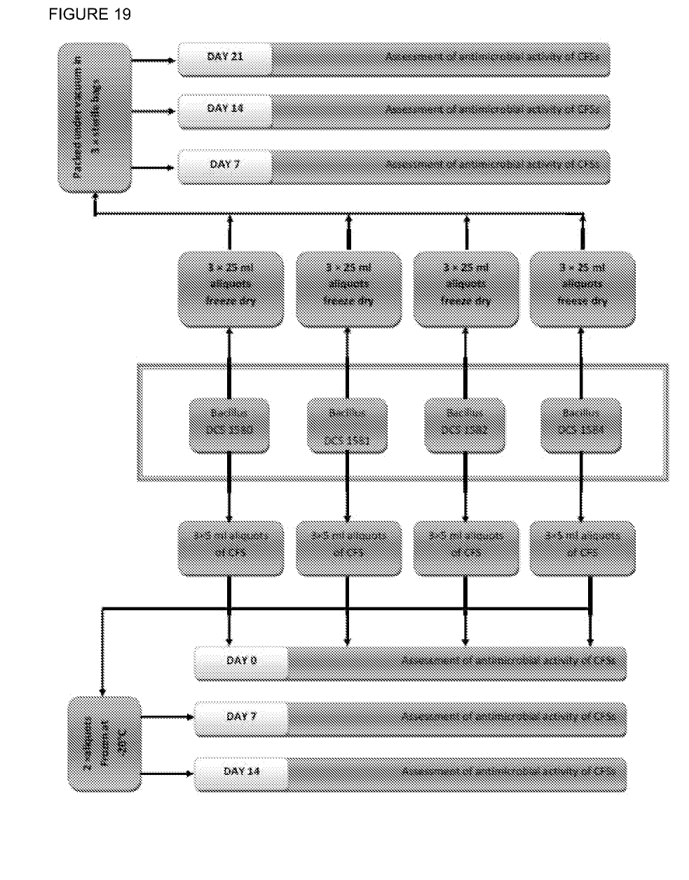

The two 5 ml aliquots were assayed at days 7 and 14 after production (FIG. 19). The aliquots were taken out of the freezer and left on the bench to thaw before being used in the antimicrobial activity assay as described earlier.

The 3 freeze-dried samples were assayed at days 7, 14 and 21 after production. The freeze-dried samples in the bag were re-suspended in 25 ml of de-ionized water before being used in the antimicrobial activity assay as described earlier.

### Application of Fermentates in Food Model:

### Culturing Conditions of Fermentate Producing Microorganisms:

Strains Bacillus subtilis 15A-P4 (DCS1580), 3A-P4 (DCS1581), LSSAO1 (DCS1582), and BS18 (DCS1584) were revived from deep frozen stock cultures on CASO agar. An isolated colony of each of the cultures was streaked on CASO agar and incubated aerobically at 32° C. until formation of well-defined colonies (24-30 hours). One colony of each strain was transferred to 10 ml of CASO broth in a 50 ml tube and incubated at inclination shaking at 130 rpm at 32° C. for 24 hours. 1 ml of the grown culture was transferred to each of 6×100 ml of CASO broth in 500 ml flasks and incubated with shaking at 130 rpm at 32° C. for 24 hours.

### Preparation of Different Fermentate Samples:

The fully grown cultures were centrifuged at 10,000×g for 30 minutes. The supernatants were pooled together, 750 ppm of ascorbic acid was added and the pH was adjusted to pH 9 using 5M KOH. The solution was then filter-sterilized (0.2 μm). Two ml of the filter sterilized supernatant was kept for assaying (see paragraph “assaying of fermentate preparations for food model application”) and the rest (about 600 ml) was divided into 4 aliquots of about 150 ml each in wide petri-dishes and frozen at −80° C. Subsequently they were submitted to freeze-drying for 72 hours or until moisture-free powder was produced. The powder was collected, packaged in aluminium foil sachets under vacuum and kept at 4° C. until use.

### Assaying of Fermentate Preparations for Food Model Application:

The activity of the fermentate powders was evaluated just before application in the food model. One gram of the freeze-dried powder in the sachets was re-suspended in water to reach the same solids concentration as the liquid sample it was produced from and assayed for activity using the microtiter-plate based liquid assay as described earlier against E. coli DCS 495.

### Preparation of Indicator Strains for Food Model Application Studies:

Six indicator strains as shown in Table 19 were grown overnight using the growth conditions listed in Table 19 by inoculating 10 mL of broth with colonies from a blood agar plate. The fully grown culture was enumerated using TEMPO EB (Enterobacteriaceae protocol, (bioMérieux (Owen M. et al., “Evaluation of the TEMPO® most probable number technique for the enumeration of Enterobacteriaceae in food and dairy products”, Journal of Applied Microbiology, 109, 1810-1816))) and stored at 4° C. until use (overnight). Pools of Escherichia coli and Salmonella spp. were made by mixing the individual cultures in order to reach equal cfu/ml counts in one suspension.

TABLE 19
Indicator strains used in the food model application studies

| | | | | Growth |
|---|---|---|---|---|
| | DCS no | Name | Reference no. | conditions |
| Escherichia | DCS 15 | Escherichia | H157:O7 - Oxoid- | CASO, |
| spp. | | coli O157 | Ring trial | 37° C. |
| | DCS | Escherichia | CRA 161(EU 340) | CASO, |
| | 492 | coli | Frozen liver | 37° C. |
| | DCS | Escherichia | CRA 92 (EU 340) | CASO, |
| | 495 | coli | Frozen pork | 37° C. |
| Salmonella | DCS | Salmonella | LRD Microbiol. | Lactic*, |
| spp. | 1152 | enteritidis | B Sa ent 98.15. | 37° C. |
| | DCS | Salmonella | LRD Microbiol. | Lactic, |
| | 1147 | senftenberg | B Sa sef 98.01. | 37° C. |
| | DCS | Salmonella | LRD Microbiol. | Lactic, |
| | 1143 | typhimurium | B Sa tym 98.01. | 37° C. |

*Lactic broth: Elliker broth supplemented with 0.1% Tween 80.

### Preparation and Inoculation of Samples:

UHT milk was purchased from retail and was used as the food model study. Batches of 700 ml of UHT milk were supplemented with either freeze dried fermentate or freeze dried CASO broth to reach the desirable concentration for each experiment (see Tables 20-23). Also one batch of 700 ml of UHT milk was not treated with any additives and was used as a positive control. The pH of the batches was measured each batch of UHT milk (treated or untreated) was divided into 50 ml containers. Six containers of each batch used in each experiment were inoculated with a pool of either E. coli or Salmonella spp. (2 targets×3 triplicates) prepared as described earlier. Three containers were not inoculated with any target microorganisms and were used as controls. All samples were incubated at 12° C. All fermentates were tested in separate trials at four different dates (Tables 20-23).

TABLE 20
Trial setup on day 1.

| | | | | | Repli- |
|---|---|---|---|---|---|
| Trial | Antimicrobial | Concentration | Inoculum | Level | cates |
| 1 | — | — | Escherichia | 10² | A, B, C |
| | | | pool | CFU/g | |
| 2 | — | — | Salmonella | 10² | A, B, C |
| | | | pool | CFU/g | |
| 3 | — | — | — | — | A, B, C |
| 4 | S1582 | 1% w/v | Escherichia | 10² | A, B, C |
| | | | pool | CFU/g | |
| 5 | S1582 | 1% w/v | Salmonella | 10² | A, B, C |
| | | | pool | CFU/g | |
| 6 | S1582 | 1% w/v | — | — | A, B, C |

TABLE 21
Trial setup on day 2.

| | | Con- | | | |
|---|---|---|---|---|---|
| Trial | Antimicrobial | centration | Inoculum | Level | Replicates |
| 7 | — | — | Escherichia | 10² CFU/g | A, B, C |
| | | | pool | | |
| 8 | — | — | Salmonella | 10² CFU/g | A, B, C |
| | | | pool | | |
| 9 | — | — | — | — | A, B, C |
| 10 | S1584 | 1% w/v | Escherichia | 10² CFU/g | A, B, C |
| | | | pool | | |
| 11 | S1584 | 1% w/v | Salmonella | 10² CFU/g | A, B, C |
| | | | pool | | |
| 12 | S1584 | 1% w/v | — | — | A, B, C |
| 13 | CASO | 1% w/v | Escherichia | 10² CFU/g | A, B, C |
| | | | pool | | |
| 14 | CASO | 1% w/v | Salmonella | 10² CFU/g | A, B, C |
| | | | pool | | |
| 15 | CASO | 1% w/v | — | — | A, B, C |

TABLE 22
Trial setup on day 3.

| | | Con- | | | |
|---|---|---|---|---|---|
| Trial | Antimicrobial | centration | Inoculum | Level | Replicates |
| 16 | — | — | Escherichia | 10² CFU/g | A, B, C |
| | | | pool | | |
| 17 | — | — | Salmonella | 10² CFU/g | A, B, C |
| | | | pool | | |
| 18 | — | — | — | — | A, B, C |
| 19 | S1580 | 1% w/v | Escherichia | 10² CFU/g | A, B, C |
| | | | pool | | |
| 20 | S1580 | 1% w/v | Salmonella | 10² CFU/g | A, B, C |
| | | | pool | | |
| 21 | S1580 | 1% w/v | — | — | A, B, C |

TABLE 23
Trial setup on day 4.

| | | Con- | | | |
|---|---|---|---|---|---|
| Trial | Antimicrobial | centration | Inoculum | Level | Replicates |
| 22 | — | — | Escherichia | 10² CFU/g | A, B, C |
| | | | pool | | |
| 23 | — | — | Salmonella | 10² CFU/g | A, B, C |
| | | | pool | | |
| 24 | — | — | — | — | A, B, C |
| 25 | S1581 | 1% w/v | Escherichia | 10² CFU/g | A, B, C |
| | | | pool | | |
| 26 | S1581 | 1% w/v | Salmonella | 10² CFU/g | A, B, C |
| | | | pool | | |
| 27 | S1581 | 1% w/v | — | — | A, B, C |

### Microbiological Analysis of Samples:

Survival of the contaminant organisms as affected by treatment of the milk samples was monitored by enumeration on a TEMPO® (bioMérieux). 10 ml of treated or untreated milk were taken out of each of the samples and after appropriate dilution in buffered peptone they were submitted for analysis. Salmonella spp. and E. coli were enumerated using the TEMPO® EB protocol (bioMérieux (Owen M. et al., “Evaluation of the TEMPO® most probable number technique for the enumeration of Enterobacteriaceae in food and dairy products”, Journal of Applied Microbiology, 109, 1810-1816)). Uninoculated samples are analysed applying the TEMPO TVC protocol (bioMérieux (Crowley et al., “TEMPO® TVC for the Enumeration of Aerobic Mesophilic Flora in Foods: Collaborative Study”, Journal of AOAC International, Vol. 92, No. 1, January 2008, pp. 165-174(10))) to account for growth of background flora.

### Results

### Fermentate Production and Data for Effect of Storage Conditions on Activity:

### Activity of Liquid Fermentates Preparations:

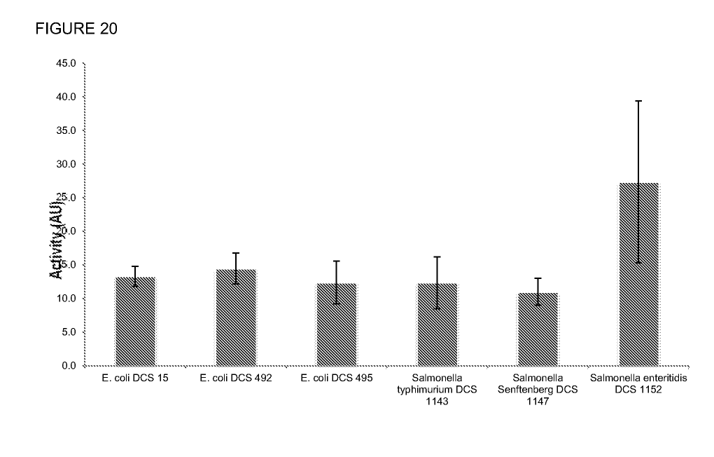

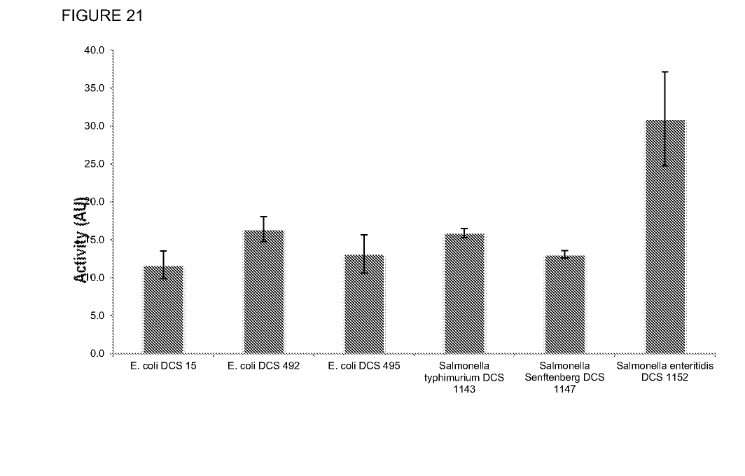

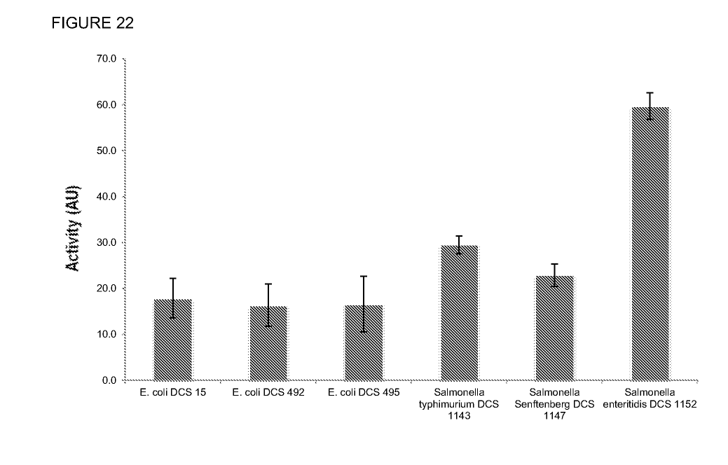

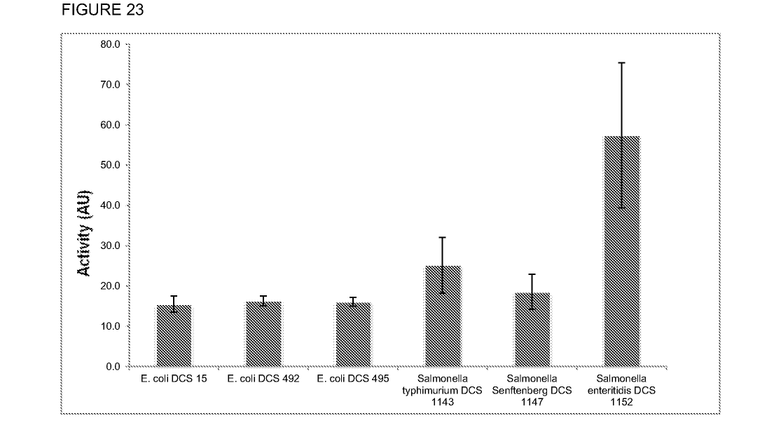

Each of the fermentates was produced at 3 different dates following the same procedure and their activity against a number of microorganisms was evaluated. The average activity of each of the fermentates from the 3 different dates against each of the target microorganisms is shown in FIGS. 20-23.

### Effect of Different Storage Conditions on the Activity of all Fermentates:

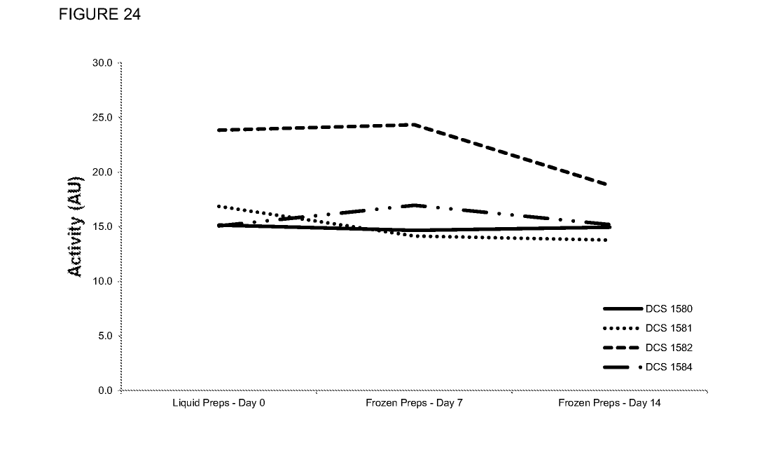

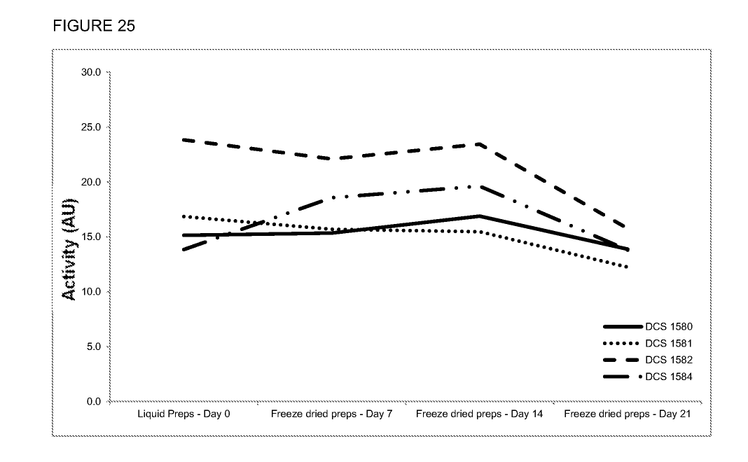

To evaluate the effect of storage conditions on the activity of all fermentates, the average activity against all target microorganisms and from all 3 different production dates were taken for day 0, day 7, day 14. Day 21 was also included for the freeze dried samples. The development of the activity in time and at different storage conditions is shown in FIGS. 24 and 25.

### Application of Fermentates in Food Model:

### Application of Fermentates in UHT Milk:

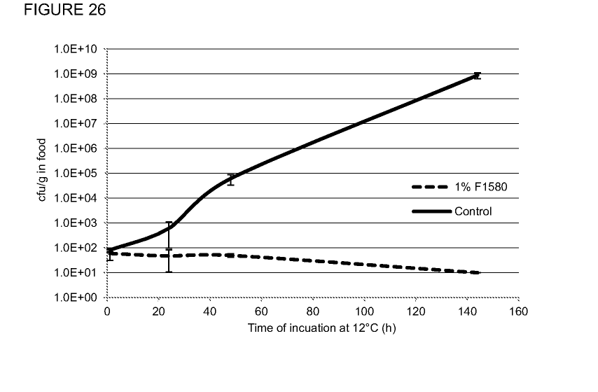

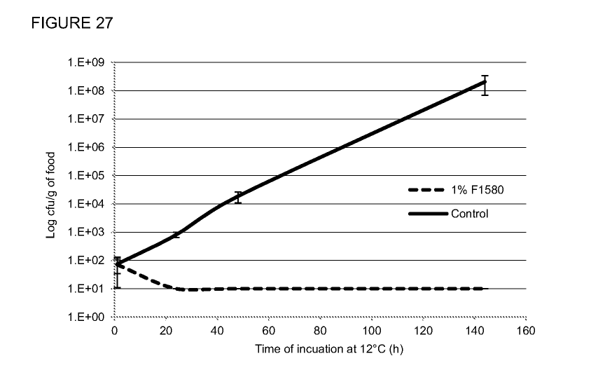

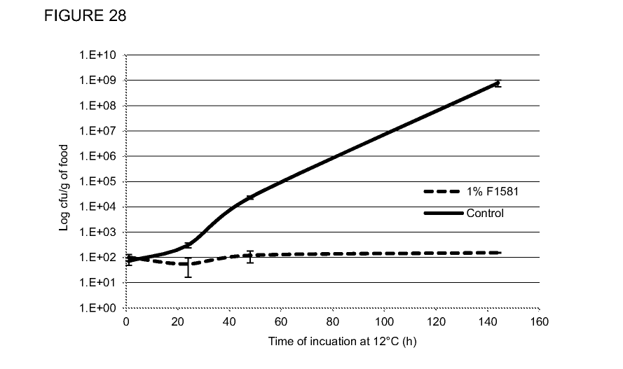

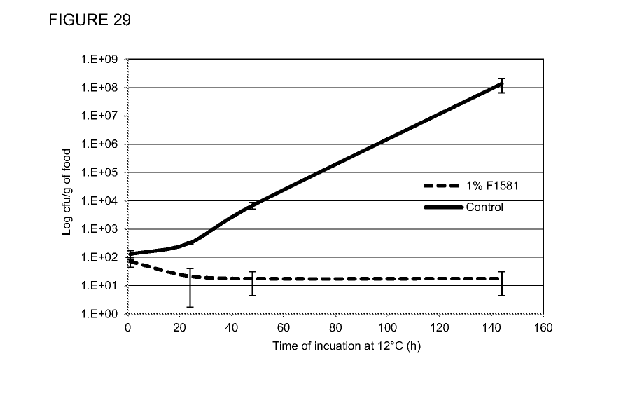

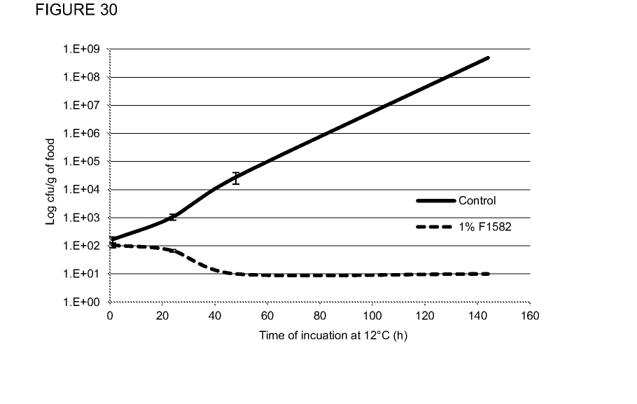

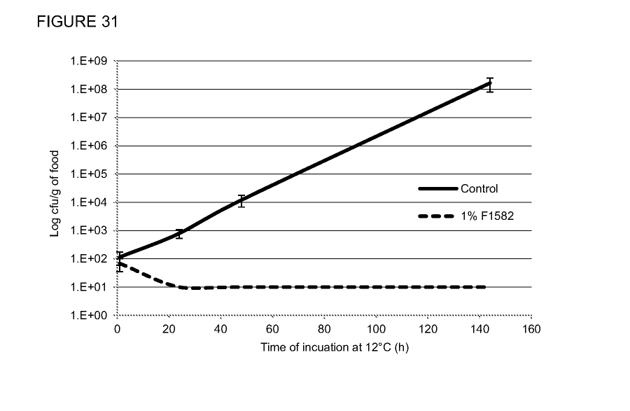

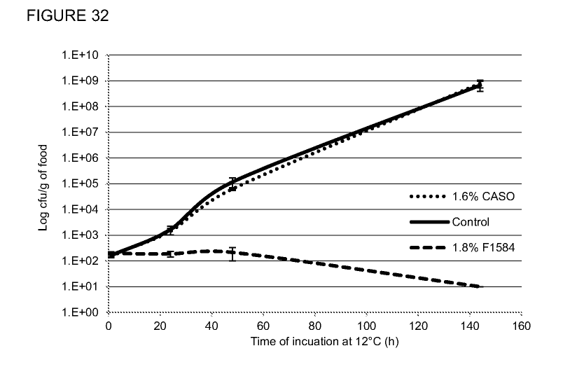

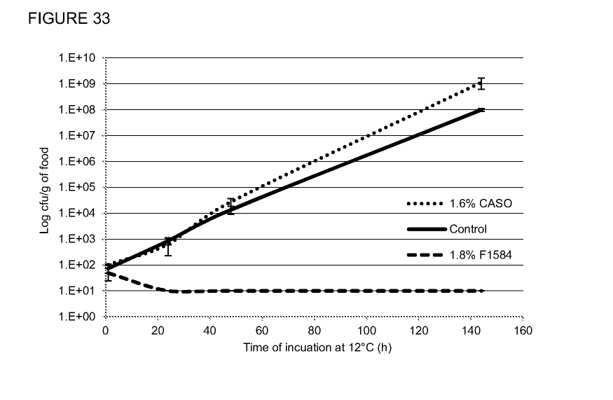

The antimicrobial activities of the 4 different fermentates in a UHT milk model spiked with pools of E. coli and Salmonella spp. are shown in FIGS. 26 to 33.

### Discussion

The activity of all fermentates was shown to be stable during storage at −20° C. as liquid preparations or at 4° C. as freeze dried preparations for at least 14 and 21 days respectively.

All fermentates displayed an ability to either retain the growth or eliminate (to under the detectable limit) E. coli and Salmonella. Compared to an untreated sample and after a 6-day period of incubation at an abusing temperature of 12° C., a 7-8 log cfu reduction was observed in all cases against all the target microorganisms tested.

Among all the fermentates, DCS1582 performed better than the rest giving a kill of Salmonella and E. coli at 24 and 48 hours of incubation respectively. This result was expected since the initial activity of the particular fermentate was higher. To compensate for this, difference in activity a 1.8% concentration of fermentate DCS1584 was used in food, compared to 1% used earlier. As a result, the fermentate achieved a kill of Salmonella at 24 hours of incubation and a kill of E. coli after 6 days. Fermentate from Bacillus DCS1580 performed comparably and this agreed with the activity of the fermentate which was the second highest among the four. Last, fermentate 1581 achieved a control of E. coli at its initial inoculation rate and a slow reduction of Salmonella spp. in the food model which is consistent with its activity as measured immediately before its use.

### Example 9

### Use of Bacillus Subtilis Cell Free Supernatants Bs18 and 15AP4 to Control Salmonella

Salmonella enterica subsp. enterica is the leading cause of food borne illness in the United States, and is the source of almost all Salmonella infections of warm blooded animals. Because humans live in close proximity with their pets, the potential exists to acquire Salmonella infection from handling contaminated foods items, which poses a health risk. In recent years Salmonella contamination has become a rising concern for the pet food industry as pet food processing facilities have fallen under increased scrutiny to maintain quality and safety of pet food products and as a result of a numerous recalls.

Details of Salmonella enterica subsp. enterica strains used in this Example are represented in Tables 25 and 26.

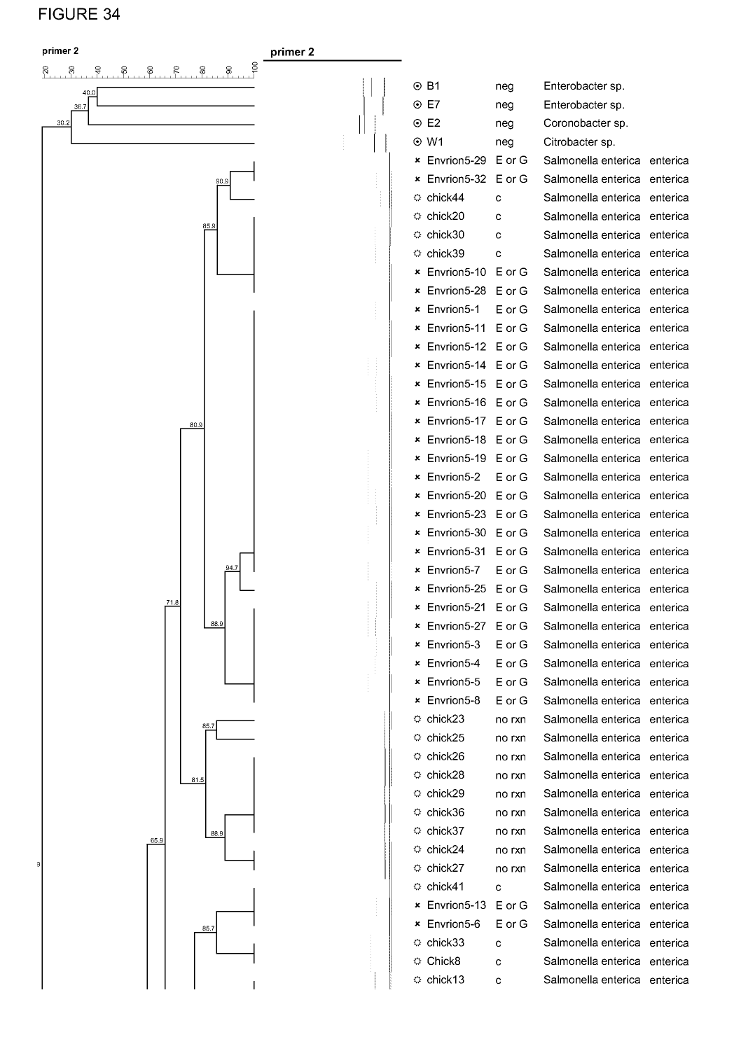

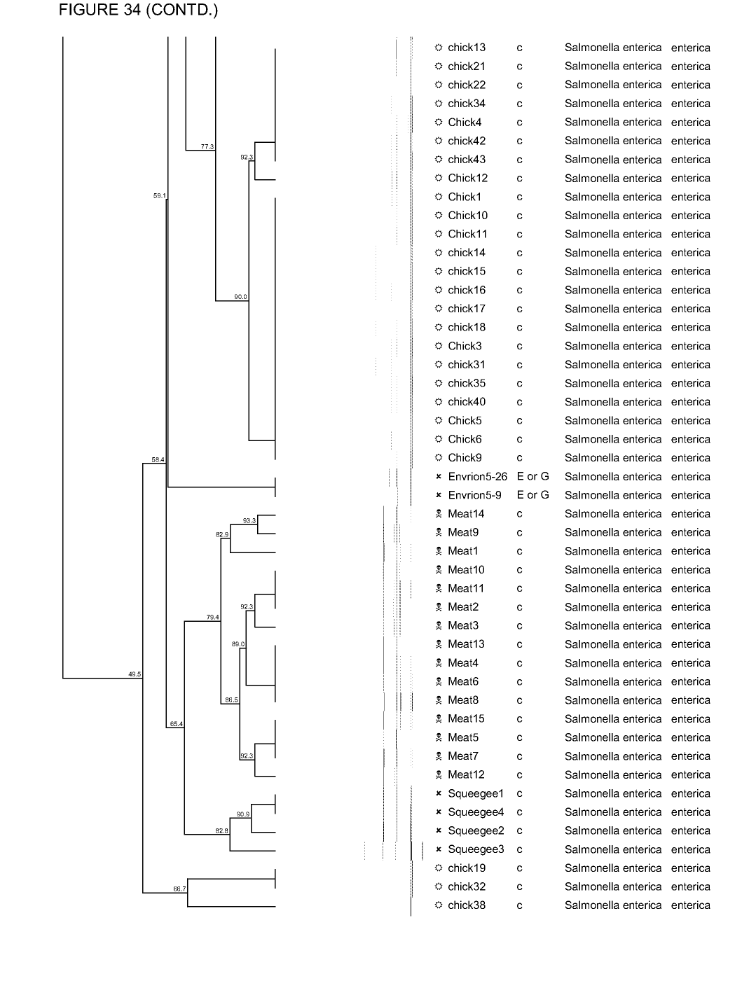

Raw material samples, post-extrusion kibble coatings, and environmental swab samples were obtained from a pet food processing facility in order to characterize the diversity of Salmonella isolates implicated in contamination through the use of 16S rRNA gene sequencing, agglutination, testing, and RAPD PCR profiling. The samples were pre-enriched in peptone, selectively enriched in Tetrathionate Broth Base Hajana (TT) Broth, and plated onto XLT-4 agar plates. Well isolated colonies were collected from each of the four samples; meat and bone meal, chicken by-product meal, a worker's boots, and a squeegee used to mop the floor. 16S rRNA sequencing indicated that all isolates had a >97% sequence identity to S. enterica subsp. enterica. Agglutination testing confirmed that the isolates were of serogroups C (54), E or G (32), or produced no reaction (9). RAPD profiles were analysed and clustered by similarity using unweighted pair group method arithmetic averages (UPGMA) and Dice Correlation Coefficient with BioNumerics software. At 80% similarity, isolates formed 9 major clusters, primarily grouping by sample origin and serogroup. Non-Salmonella isolates (Citrobacter spp., Cronobacter spp., and Enterobacter spp.) were used for a basis of comparison in the constructed dendrogram. Refer to FIG. 34, for a visual representation of the diversity presented in the dendrogram.

Of the 95 isolates, 14 isolates were chosen as representatives of the diversity (Table 24) to determine the inhibition spectrum of the Bacillus subtilis cell free supernatants of the following strains BS18 and 15AP4. Cell free supernatants (fermentates) were created and an inhibition broth assay used to measure the effect of these supernatants on target organisms.

TABLE 24
Salmonella enterica subsp. enterica isolates obtained from pet
food facility chosen to represent the diversity found from these samples

| Designation | Species | Serogroup | Source |
|---|---|---|---|
| E5-13 | Salmonella enterica | E or G | worker's boots |
| C8 | Salmonella enterica | C | chicken by-product meal |
| E5-29 | Salmonella enterica | E or G | worker's boots |
| C30 | Salmonella enterica | C | chicken by-product meal |
| E 5-16 | Salmonella enterica | E or G | worker's boots |
| E 5-4 | Salmonella enterica | E or G | worker's boots |
| C37 | Salmonella enterica | no rxn | chicken by-product meal |
| C19 | Salmonella enterica | C | chicken by-product meal |
| M5 | Salmonella enterica | C | meat and bone meal |
| M14 | Salmonella enterica | C | meat and bone meal |
| E5-9 | Salmonella enterica | E or G | worker's boots |
| C3 | Salmonella enterica | C | chicken by-product meal |
| C22 | Salmonella enterica | C | chicken by-product meal |
| S4 | Salmonella enterica | E or G | squeegee |

In addition to the strains above, a total of 29 further representative isolates of Salmonella enterica subsp. enterica were also selected (Table 25) for testing in the inhibition broth assay. Table 25, outlines the variety of serotypes tested. All isolates are of known serotypes that have had implications in outbreak/recalls of a variety of pet foods (kibble, treats, pig ear treats, raw pet food, frozen pet food, and found in pet food plant).

TABLE 25
Salmonella enterica subsp. enterica isolates of a range
of serotypes relevant to pet food recalls/outbreaks

| Number | Species | Serotype | Serogroup | Research Identified Outbreaks |
|---|---|---|---|---|
| 586 | Salmonella enterica | Typhimurium | B | pet treats |
| 707 | Salmonella enterica | Newport | C | pet treats |
| 1231 | Salmonella enterica | Hadar | C | raw pet food |
| 1278 | Salmonella enterica | Infantis | C | pig ear treats/dog kibble |
| 1329 | Salmonella enterica | Braenderup | C | raw pet food |
| 1332 | Salmonella enterica | Anatum | E | pet treats |
| 1337 | Salmonella enterica | Braenderup | C | raw pet food |
| 1638 | Salmonella enterica | Derby | B | pet food plant |
| 1658 | Salmonella enterica | Schwarzengrund | B | raw pet food |
| 1661 | Salmonella enterica | Tennessee | C | dog kibble |
| 2274 | Salmonella enterica | Anatum | E | pet treats |
| 2341 | Salmonella enterica | Mbandaka | C | frozen pet food |
| 2637 | Salmonella enterica | Schwarzengrund | B | raw pet food |
| 2735 | Salmonella enterica | Ohio | C | pet treats |
| 2755 | Salmonella enterica | Mbandaka | C | frozen pet food |
| 3917 | Salmonella enterica | Hadar | C | raw pet food |
| 5868 | Salmonella species | Typhimurium | B | pet treats |
| 7111 | Salmonella enterica | Infantis | C | pig ear treats/dog kibble |
| 12960 | Salmonella enterica | Senftenberg | E | dog food/treats |
| 13062 | Salmonella enterica | Tennessee | C | dog kibble |
| 13069 | Salmonella enterica | Mbandaka | C | frozen pet food |
| 13079 | Salmonella enterica | Newport | C | pet treats |
| 13168 | Salmonella enterica | Senftenberg | E | dog food/treats |
| 1255 | Salmonella enterica | Montevideo | C | dog food |
| 1492 | Salmonella enterica | Montevideo | C | dog food |
| 13071 | Salmonella enterica | Montevideo | C | dog food |
| 1336 | Salmonella enterica | Thompson | C | pet treats |
| 1339 | Salmonella enterica | Thompson | C | pet treats |
| 3898 | Salmonella enterica | Neumuenster | C | pet treats |

### Method for Producing Bacillus Subtilis Cell-Free Supernatant

In brief, an isolated colony of each of the cultures was streaked on tryptic soy agar (TSA) and incubated aerobically at 32° C. for 24 hours. One colony of each was transferred to 10 ml of TSB in a 50 ml round bottom tube and incubated shaking at 130 rpm at 32° C. for 24 hours. A 0.5 ml aliquot of the grown culture was transferred to 50 ml of TSB in a 250 ml Erlenmeyer flask and incubated shaking at 130 rpm at 32° C. for 24 hours. The fully grown cultures were centrifuged twice at 10,000×rpm for 10 minutes. The supernatant was filter sterilized and stored at −20° C. in individual aliquots. The cell free supernatants were individually thawed upon using in an inhibition broth assay.

### Inhibition Broth Assay

A broth assay was performed to determine the reduction in bacterial growth of the Salmonella isolates as a result of the CFS mentioned above. Single, well isolated colonies of the Salmonella isolates were picked into brain-heart infusion broth (BHI) (BD Product No. 238400) and grown at 37° C. for 24 hours and served as the target organisms. In order to set up the broth assay, wells of a 96-well microtiter plate were filled each with 0.18 ml of BHI, set up in duplicate, with (CFS treated) and without (control) CFS (method 1 & 2 produced) at 10% (v/v) and 50% (v/v). All wells were inoculated with 1% (v/v) of the target organism and the 96-well plates were incubated at 37° C. for 24 hours. An OD₅₉₅ was measured and a percent inhibition value was reported for the treated versus the control results.

### Results

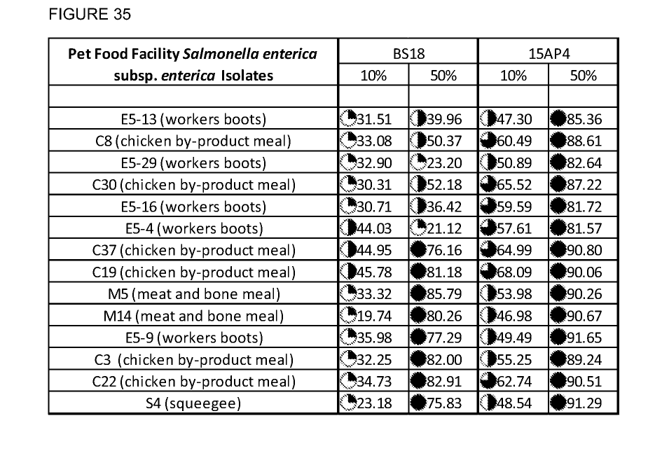

FIG. 35, represents the inhibition activity of the fermentates obtained from Bacillus subtilis strains BS18 and 15AP4. Both fermentates exhibit a wide spectrum of inhibition of the Salmonella diversity obtained from a pet food processing plant. As depicted in the increased inhibition from 10% (v/v) to 50% (v/v), it is expected that the potency of the CFS has a role in improving the reduction as well as the spectrum.

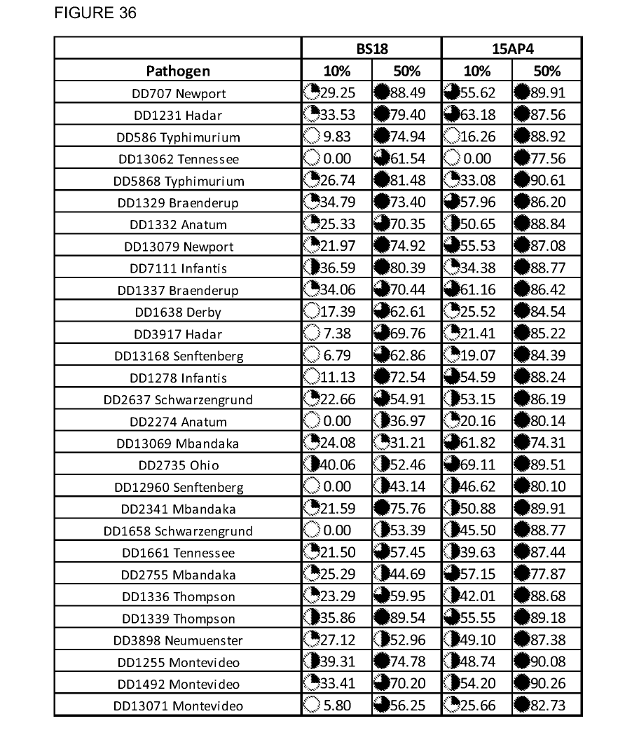

A similar result was also observed when fermentates from BS18 and 15AP4 were tested in the inhibition broth assay with isolates of known serotype previously implicated in outbreaks/recall of a variety of pet foods (FIG. 36).

These data show that fermentates from both BS18 and 15AP4 display efficient growth inhibition against a range of Salmonella enterica strains.

### Example 10

### Use of Bacillus Subtilis Cell Free Supernatants 22CP1, LSSA01, 3AP4 and BS2084 to Control Salmonella Method

Target organisms used for testing the 22CP1, LSSA01, 3AP4 and BS2084 cell free supernatants were the same as those in Example 9, represented in Tables 25 and 26.

In brief, an isolated colony of each of the cultures was streaked on tryptic soy agar (TSA) and incubated aerobically at 32° C. for 24 hours. One colony of each was transferred to 10 ml of TSB in a 50 ml SARSTEDT tube and incubated shaking at inclination at 130 rpm at 32° C. for 24 hours. A 0.5 ml aliquot of the grown culture was transferred to 50 ml of TSB in a 250 ml baffled Erlenmeyer flask (increased aeration) and incubated shaking at 130 rpm at 32° C. for 24 hours. The fully grown cultures were centrifuged twice at 12,000×g for 30 minutes. The supernatant was filter sterilized, 750 ppm of ascorbic acid was added, the supernatant was pH adjusted to 9 using KOH, then finally filter sterilized again. The cell free supernatants were used immediately upon preparation in an inhibition broth assay, detailed in Example 9.

### Results

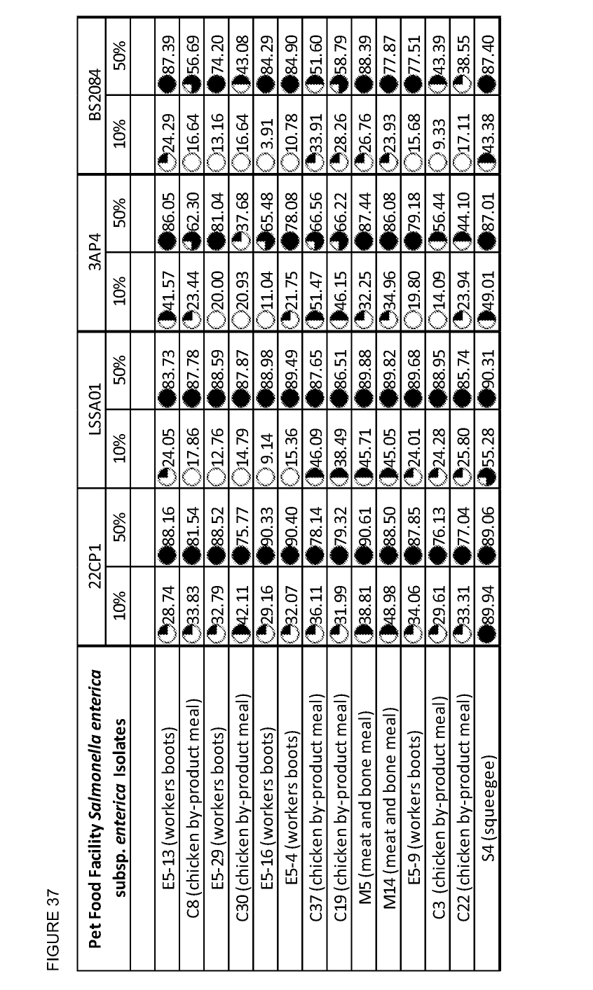

FIG. 37, represents the inhibition activity of the fermentates obtained from Bacillus subtilis strains 22CP1, LSSA01, 3AP4 and BS2084. All fermentates exhibit a wide spectrum of inhibition of the Salmonella diversity obtained from a pet food processing plant. As depicted in the increased inhibition from 10% (v/v) to 50% (v/v), it is expected that the potency of the CFS has a role in improving the reduction as well as the spectrum.

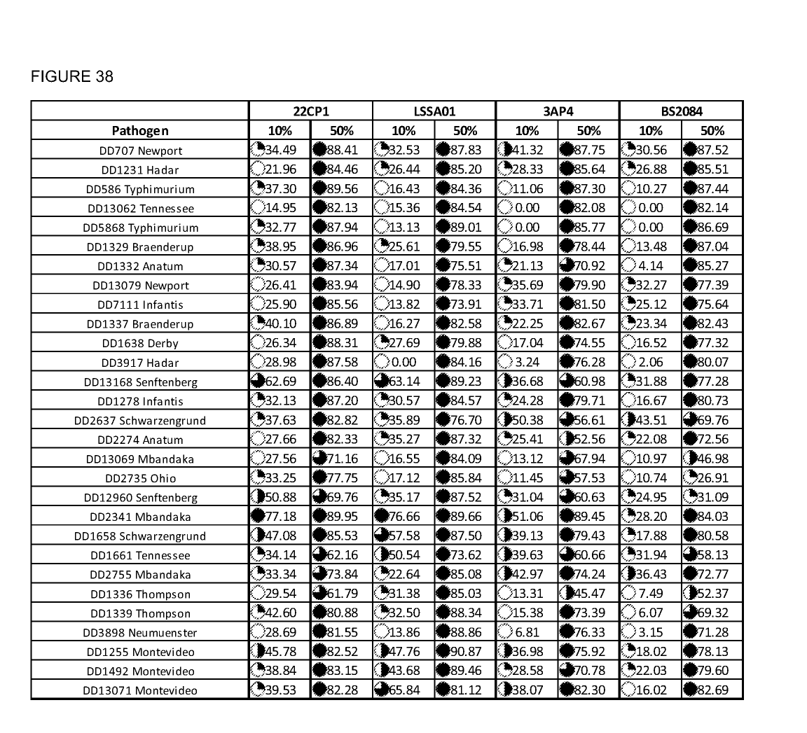

When the cell free supernatants obtained from Bacillus subtilis strains 22CP1, LSSA01, 3AP4 and BS2084 were tested against isolates of known serotype previously implicated in outbreaks/recall of a variety of pet foods, similar results were also observed (FIG. 38).

This indicates that, in a similar to manner to the cell free supernatants tested in Example 9, these fermentates also show growth inhibition against a wide-range of Salmonella isolates.

### Example 11

### Use of Bacillus Subtilis Cell Free Supernatant ABP278 to Control Salmonella Method

In brief, an isolated colony of each of the cultures was streaked on tryptic soy agar (TSA) and incubated aerobically at 32° C. for 24 hours. One colony of each was transferred to 10 ml of TSB in a 50 ml round bottom tube and incubated shaking at 130 rpm at 32° C. for 24 hours. A 0.5 ml aliquot of the grown culture was transferred to 50 ml of TSB in a 250 ml Erlenmeyer flask and incubated shaking at 130 rpm at 32° C. for 24 hours. The fully grown cultures were centrifuged twice at 10,000×rpm for 10 minutes. The supernatant was filter sterilized and stored at −20° C. in individual aliquots. The cell free supernatants were individually thawed upon using in an inhibition broth assay, as detailed in Example 9.

A selection of target organisms used in Examples 9 and 10 were used to test the inhibition activity of ABP278.

### Results

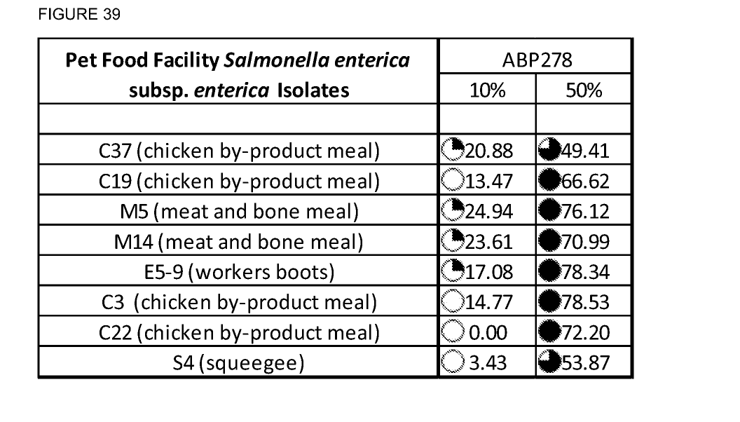

FIG. 39, represents the inhibition of the fermentate obtained from Bacillus subtilis strain ABP278. The fermentate exhibited efficient inhibition of the Salmonella diversity obtained from a pet food processing plant. As depicted in the increased inhibition from 10% (v/v) to 50% (v/v), it is expected that the potency of the CFS has a role in improving the reduction as well as the spectrum.

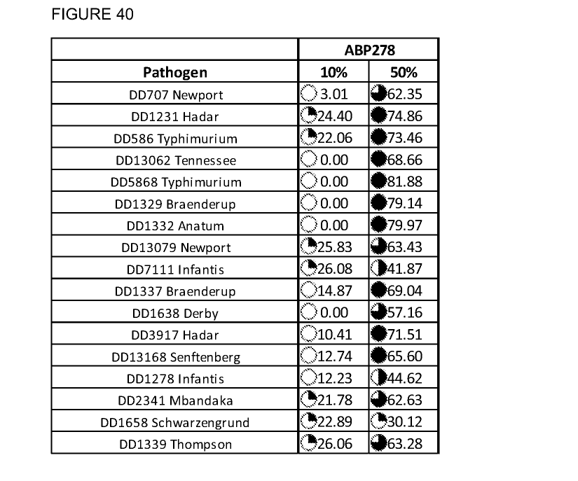

When the cell free supernatant obtained from Bacillus subtilis strain ABP278 was tested against isolates of known serotype previously implicated in outbreaks/recall of a variety of pet foods, similar results were also observed (FIG. 40).

This indicates that, in a similar to manner to the cell free supernatants tested in Examples 9 and 10, these fermentates also show growth inhibition against a diverse group of Salmonella isolates.

### Example 12

### Use of Dried Bacillus Subtilis Fermentates to Demonstrate Inhibition of a Variety of Salmonella Isolates on Dog Kibbles

Pet food compositions are subjected to microbial contamination by pathogenic strains such as Salmonella which constitute a potential health risk for both the pet and the owner. The freeze-dried Bacillus fermentates of LSSA01 (DCS1582); BS18 (DCS1584); ABP278 (DCS 1583) and 3A-P4 (DCS1581) were coated onto hard-extruded dog kibble and their anti-GRAM negative efficacy tested against a pool of Salmonella enteritica spp. This was compared to a negative control in which the dog kibble had not been coated with a fermentate.

### Method

### Culturing Conditions:

Strains Bacillus subtilis 15A-P4 (DCS1580), 3A-P4 (DCS1581), LSSAO1 (DCS1582), and BS18 (DCS1584) were revived from deep frozen stock cultures on CASO agar. An isolated colony of each of the cultures was streaked on CASO agar and incubated aerobically at 32° C. until formation of well-defined colonies (24-30 hours). One colony of each of the strains was transferred to 10 ml of CASO broth in a 50 ml tube and incubated with inclination shaking at 150 rpm at 32° C. for 24 hours. One ml of the grown culture of 15A-P4 (DCS1580); LSSAO1 (DCS1582), and BS18 (DCS1584) was transferred to 100 ml of CASO broth in a 500 ml baffled Erlenmeyer flask (increased aeration) and incubated with shaking at 150 rpm at 32° C. for 24 hours. One ml of the grown culture of 3A-P4 (DCS 1581) was transferred to 100 ml of CASO broth in a 500 ml conical flask and incubated with shaking at 150 rpm at 32° C. for 24 hours.

### Preparation of Different Fermentates:

The fully grown cultures were centrifuged at 10000×g for 30 minutes. The supernatant was filter sterilized. 750 ppm of ascorbic acid was added to the supernatant and the pH of the supernatant was adjusted to pH 9 using 5M KOH. The solution was then filter-sterilized (0.2 μm). The fermentate preparation was divided into 3×25 ml aliquots in sterile plastic cups and frozen at −80° C. The frozen samples were subjected to freeze-drying for 2-3 days. After freeze-drying the dried powder was aseptically collected and packaged under vacuum in sterile aluminium foil bags and kept at 4° C. until assaying.

### Preparation of Indicator Strains for Pet Food Model Application Studies:

A Salmonella cocktail was prepared using different strains of Salmonella enterica subsp. enterica. These strains were chosen to represent a diversity of Salmonella, which have been previously implicated in Salmonella outbreaks/recalls in extruded pet food. This diversity included the serotypes Senftenberg, Montevideo, Typhimurium, Schwarzengrund, Enterica and Newport, all of which fall into serogroups E, C, and B.

The 6 indicator strains as shown in Table 26 were grown overnight at 37° C. by inoculating 10 mL of CASO broth with colonies from a blood agar plate. The fully grown culture was enumerated using TEMPO® EB (bioMérieux (Owen M. et al., “Evaluation of the TEMPO® most probable number technique for the enumeration of Enterobacteriaceae in food and dairy products”, Journal of Applied Microbiology, 109, 1810-1816)) and stored at 4° C. until use (overnight). Pools of Salmonella spp. were made by mixing the individual cultures in order to reach equal CFU/ml counts in one suspension.

TABLE 26
Indicator strains used in the food model application
studies (see also Tables 25 and 26).

| Number | Species | Serotype | Serogroup | Source |
|---|---|---|---|---|
| 586 (DCS 2162) | Salmonella enterica | Typhimurium | B | pet treats |
| 707 (DCS 2163) | Salmonella enterica | Newport | C | pet treats |
| 1658 (DCS | Salmonella enterica | Schwarzengrund | B | raw pet food |
| 2170) | | | | |
| E5-13 (DCS | Salmonella enterica | | E or G | worker's boots |
| 2191) | | | | |
| 12960 (DCS | Salmonella enterica | Senftenberg | E | dog food/treats |
| 2180) | | | | |
| 1492 (DCS | Salmonella enterica | Montevideo | C | dog food |
| 2186) | | | | |

### Preparation and Inoculation of Samples:

The extruded dog kibbles were made in an extrusion trial following a standard recipe. Samples of 10 g of the dried dog kibbles were supplemented with either 1% (w/w) of each of freeze dried Bacillus subtilis fermentate 15A-P4 (DCS1580), 3A-P4 (DCS1581), LSSAO1 (DCS1582), and BS18 (DCS1584). No fermentate was added to the control batch (see Table 27). Control kibble and the treated kibbles were individually distributed into three replicates per condition per sampling time point. All replicates were individually inoculated with 0.5 ml (˜10E+6 CFU/g of kibble) of the Salmonella cocktail, prepared as described earlier. Even distribution was achieved by slowly dripping the solution onto the kibbles and well mixing. All samples were kept in the sealed plastic bags at 20° C.

TABLE 27
Overview of trials.

| | | | | | Sampling | |
|---|---|---|---|---|---|---|
| | Kibbles | | | Concentration | time | |
| Trial | (g) | Antimicrobial | Inoculum | (CFU/g) | (day) | Replicates |
| 1 | 10 | S1580 | Salmonella | 1 × 10⁶ | 0, 1, 6 | A, B, C |
| | | | pool | | | |
| 2 | 10 | S1581 | Salmonella | 1 × 10⁶ | 0, 1, 6 | A, B, C |
| | | | pool | | | |
| 3 | 10 | S1582 | Salmonella | 1 × 10⁶ | 0, 1, 6 | A, B, C |
| | | | pool | | | |
| 4 | 10 | S1584 | Salmonella | 1 × 10⁶ | 0, 1, 6 | A, B, C |
| | | | pool | | | |
| 5 | 10 | — | Salmonella | 1 × 10⁶ | 0, 1, 6 | A, B, C |
| | | | pool | | | |

### Microbiological Analysis of Samples:

The cell count development of the inoculated Salmonella pool was monitored starting at day 0, after 24 hours and after one week. The enumeration was performed in accordance with the guidelines of TEMPO® EB (bioMérieux (Owen M. et al., “Evaluation of the TEMPO® most probable number technique for the enumeration of Enterobacteriaceae in food and dairy products”, Journal of Applied Microbiology, 109, 1810-1816)) for enumeration of Enterobactericae. At each time point a 10 fold dilution of each sample was made using buffered peptone water. The kibbles were held for 30 minutes to absorb the water and to be softened for stomaching. All 4 fermentates were tested in one trial at the same starting date (Table 27).

### Results

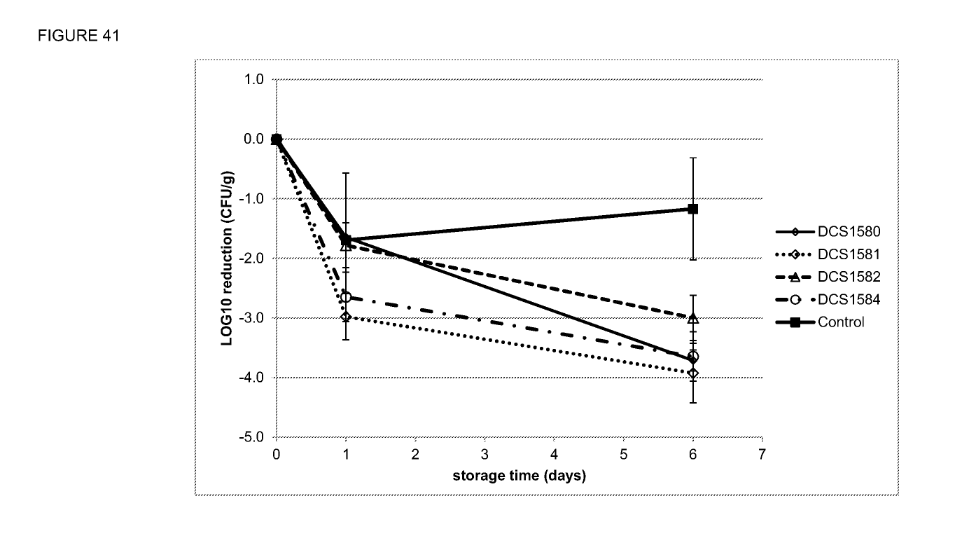

In contrast to the untreated sample, all fermentates displayed an ability to eliminate Salmonella enterica subsp. enterica to below 100 CFU/g (FIG. 41). In all cases, after a 6-day period of incubation at 20° C. against the target microorganisms tested, a 2-3 Log CFU reduction was observed.

The kibble treated with 1% (w/w) freeze dried Bacillus subtilis fermentate showed a significant reduction in Salmonella enterica subsp. enterica at each time point as well as an overall rate of reduction throughout the duration of the assay.

All publications mentioned in the above specification are herein incorporated by reference. Various modifications and variations of the described methods and system of the present invention will be apparent to those skilled in the art without departing from the scope and spirit of the present invention. Although the present invention has been described in connection with specific preferred embodiments, it should be understood that the invention as claimed should not be unduly limited to such specific embodiments. Indeed, various modifications of the described modes for carrying out the invention which are obvious to those skilled in biochemistry and biotechnology or related fields are intended to be within the scope of the following claims.

### REFERENCES

Abriouel, H., Franz, C. M. A. P., Ben Omar, N. & Galvez, A. (2011). Diversity and applications of Bacillus bacteriocins. Fems Microbiology Reviews 35, 201-232.
Arima, K., Kakinuma, A. & Tamura, G. (1968). Surfactin, a crystalline peptidelipid surfactant produced by Bacillus subtilis: isolation, characterization and its inhibition of fibrin clot formation. Biochemical and biophysical research communications 31, 488-494.
Butcher, R. A., Schroeder, F. C., Fischbach, M. A., Straightt, P. D., Kolter, R., Walsh, C. T. & Clardy, J. (2007). The identification of bacillaene, the product of the PksX megacomplex in Bacillus subtilis. Proceedings of the National Academy of Sciences of the United States of America 104, 1506-1509.
Chen, X. H., Vater, J., Piel, J. & other authors (2006). Structural and functional characterization of three polyketide synthase gene clusters in Bacillus amyloliquefaciens FZB 42. Journal of Bacteriology 188, 4024-4036.
Chen, X. H., Koumoutsi, A., Scholz, R. & other authors (2007). Comparative analysis of the complete genome sequence of the plant growth-promoting bacterium Bacillus amyloliquefaciens FZB42. Nature Biotechnology 25, 1007-1014.
Chen, X. H., Koumoutsi, A., Scholz, R., Schneider, K., Vater, J., Suessmuth, R., Piel, J. & Borriss, R. (2009). Genome analysis of Bacillus amyloliquefaciens FZB42 reveals its potential for biocontrol of plant pathogens. Journal of Biotechnology 140, 27-37.
Cooper, D. G., Macdonald, C. R., Duff, S. J. & Kosaric, N. (1981). Enhanced Production of Surf actin from Bacillus subtilis by Continuous Product Removal and Metal Cation Additions. Applied and environmental microbiology 42, 408-412.
Gilliver, K. (1949). The antibacterial properties of some species of aerobic spore-forming bacilli. British journal of experimental pathology 30, 214-220.
Gustafson, K., Roman, M. & Fenical, W. (1989). The macrolactins, a novel class of antiviral and cytotoxic macrolides from a deep-sea marine bacterium. Journal of the American Chemical Society 111, 7519-7524.
Kenig, M. & Abraham, E. P. (1976). Antimicrobial Activities and Antagonists of Bacilysin and Anticapsin. Journal of General Microbiology 94, 37-45.
Kim, H. S., Yoon, B. D., Lee, C. H., Suh, H. H., Oh, H. M., Katsuragi, T. & Tani, Y. (1997). Production and properties of a lipopeptide biosurfactant from Bacillus subtilis C9. Journal of Fermentation and Bioengineering 84, 41-46.
Koumoutsi, A., Chen, X.-H., Henne, A., Liesegang, H., Hitzeroth, G., Franke, P., Vater, J. & Borriss, R. (2004). Structural and Functional Characterization of Gene Clusters Directing Nonribosomal Synthesis of Bioactive Cyclic Lipopeptides in Bacillus amyloliquefaciens Strain FZB42. Journal of Bacteriology 186, 1084-1096.
Loeffler, W., Tschen, J. S. M., Vanittanakom, N., Kugler, M., Knorpp, E., Hsieh, T. F. & Wu, T. G. (1986). Antifungal effects of bacilysin and fengymycin from Bacillus subtilis F-29-3. A comparison with activities of other Bacillus antibiotics. Journal of Phytopathology 115, 204-213.
Lu, X.-L., Xu, Q.-Z., Liu, X.-Y., Cao, X., Ni, K.-Y. & Jiao, B.-H. (2008). Marine Drugs—Macrolactins. Chemistry & Biodiversity 5, 1669-1674.
Mojid Mondol, M. A., Kim, J. H., Lee, H.-S., Lee, Y.-J. & Shin, H. J. (2011). Macrolactin W, a new antibacterial macrolide from a marine Bacillus sp. Bioorganic &amp; Medicinal Chemistry Letters 21, 3832-3835.
Owen M., Willis C. and Lamph D. (2010) Evaluation of the TEMPO® most probable number technique for the enumeration of Enterobacteriaceae in food and dairy products. Journal of Applied Microbiology 109, 1810-1816.
Patel, P. S., Huang, S., Fisher, S., Pirnik, D., Aklonis, C., Dean, L., Meyers, E., Fernandes, P. & Mayerl, F. (1995). Bacillaene, a novel inhibitor of prokaryotic protein-synthesis produced by bacillus-subtilis—production, taxonomy, isolation, physicochemical characterization and biological-activity. Journal of Antibiotics 48, 997-1003.
Peypoux, F., Bonmatin, J. M. & Wallach, J. (1999). Recent trends in the biochemistry of surfactin. Applied Microbiology and Biotechnology 51, 553-563.
Rogers, H. J., Newton, G. G. & Abraham, E. P. (1965). Production and purification of bacilysin. The Biochemical journal 97, 573-578.
Romero, D., de Vicente, A., Rakotoaly, R. H. & other authors (2007). The iturin and fengycin families of lipopeptides are key factors in antagonism of Bacillus subtilis toward Podosphaera fusca. Molecular Plant-Microbe Interactions 20, 430-440.
Wilson, K. E., Flor, J. E., Schwartz, R. E., Joshua, H., Smith, J. L., Pelak, B. A., Liesch, J. M. & Hensens, 0. D. (1987). Difficidin and oxydifficidin—Novel broad-spectrum antibacterial antibiotics produced by Bacillus subtilis. 2. Isolation and physicochemical characterization. Journal of Antibiotics 40, 1682-1691.
Zimmerman, S. B., Schwartz, C. D., Monaghan, R. L. & other authors (1987). Difficidin and oxydifficidin—novel broad-spectrum antibacterial antibiotics produced by bacillus-subtilis 0.1. production, taxonomy and antibacterial activity. journal of antibiotics 40, 1677-1681.

1.-99. (canceled)

100. A method of preventing and/or reducing a microbial contaminant of a foodstuff or surface coating material comprising the step of contacting a constituent of the foodstuff or surface coating material, the foodstuff itself or surface coating material itself and/or the packaging of the foodstuff or surface coating material with an anti-contaminant composition comprising a cell-free fermentation product of one or more Bacillus subtilis strains selected from the group consisting of: LSSA01, 22C-P1, BS18, 15A-P4, 3A-P4, ABP278, and BS 2084; wherein said fermentation product comprises one or more compounds selected from the group consisting of: a polyketide, a lipopeptide, a bacillibactin, a bacilysin, an anticapsin, a plantazolicin, a LCI, a homologue of a plantazolicin and a homologue of a LCI.

101. A method according to claim 100, wherein the foodstuff is a human foodstuff, a pet food or an animal feed.

102. A method according to claim 100, wherein the surface coating material is a paint.

103. A method according to claim 100, wherein the foodstuff is a meat product or a pet food.

104. A method or use according to claim 100, wherein the polyketide is selected from the group consisting of: a difficidin, a macrolactin, a bacillaene and combinations thereof.

105. A method or use according to claim 100, wherein the composition further comprises one or more additional components, preferably wherein the additional component is a carrier, adjuvant, solubilizing agent, suspending agent, diluent, oxygen scavenger, antioxidant and/or a food material.

106. A method or use according to claim 100, wherein the compounds are partially purified.

107. A method or use according to claim 100, wherein the cell-free fermentation product is effective against a contaminant microorganism or microorganisms if following the “Plate Diffusion Assay” protocol an inhibition zone of at least 2 mm is observed.

108. A method or use according to claim 100, wherein the cell-free fermentation product is effective against a contaminant microorganism or microorganisms if it has at least about 20% inhibition in the “Inhibition Broth Assay”.

109. A method or use according to claim 100, wherein the cell-free fermentation product is effective against a contaminant microorganism or microorganisms if it has an effective concentration of at least about 100% (v/v) measured by the “Effective Concentration Assay”.

110. A method according to claim 100, wherein the cell-free fermentation product is effective against a microorganism if it has more than one, preferably all three, of the following activities: if following the “Plate Diffusion Assay” protocol an inhibition zone of at least 2 mm is observed; at least about 20% inhibition in the “Inhibition Broth Assay”; an effective concentration of at least about 100% (v/v) measured by the “Effective Concentration Assay”.

111. A method according to claim 100, wherein the fermentation product is a fermentate.

112. A method according to claim 100, wherein the step of contacting comprises admixing a constituent of the foodstuff or surface coating material with the anti-contaminant composition.

113. A method according to claim 100, wherein the step of contacting comprises applying the anti-contaminant composition to the surface of the foodstuff or surface coating material; a constituent of the foodstuff or a constituent of the surface coating material and/or the packaging of the foodstuff or surface coating material.

114. A method according to claim 100, wherein the method prevents and/or reduces microbial contamination by one or more of a Gram-positive bacterium, a Gram-negative bacteria or a fungus.

115. A method according to claim 100, wherein the method prevents and/or reduces microbial contaminant by one or more Gram-negative bacteria from a genus selected from the group consisting of: Salmonella, Escherichia; Hafnia; Klebsiella; Pseudomonas; Shigella and Yersinia.

116. A method according to claim 100, wherein the method prevents and/or reduces microbial contaminant by one or more of: Salmonella enterica; Escherichia coli; Hafnia alvei; Klebsiella oxytoca; Pseudomonas fluorescens; Pseudomonas putida; Salmonella typhimurium; Shigella flexneri; Shigella sonnei and Yersinia enterocolitica.

117. A method according to claim 116, wherein the Salmonella enterica spp is one or more of the following: Salmonella enterica ser. Anatum, Salmonella enterica ser. Braenderup, Salmonella enterica ser. Derby, Salmonella enterica ser. Enteritidis; Salmonella enterica ser. Hadar, Salmonella enterica ser. Infantis; Salmonella enterica ser. Kedougou, Salmonella enterica ser. Mbandaka, Salmonella enterica ser. Montevideo, Salmonella enterica ser. Neumuenster, Salmonella enterica ser. Newport, Salmonella enterica ser. Ohio, Salmonella enterica ser. Schwarzengrund, Salmonella enterica ser. Senftenberg, Salmonella enterica ser. Tennessee, Salmonella enterica ser. Thompson and Salmonella enterica ser. Typhimurium.

118. A foodstuff comprising an anti-contaminant composition comprising a cell-free fermentation product of one or more Bacillus subtilis strains selected from the group consisting of: LSSA01, 22C-P1, BS18, 15A-P4, 3A-P4, ABP278, and BS 2084; wherein said fermentation product comprises one or more compounds selected from the group consisting of: a polyketide, a lipopeptide, a bacillibactin, a bacilysin, an anticapsin, a plantazolicin, a LCI, a homologue of a plantazolicin and a homologue of a LCI or a product having reduced and/or no microbial contamination as a result of carrying out the method of claim 100.

119. A foodstuff according to claim 118, wherein the foodstuff is a human foodstuff, a pet food or an animal feed.

120. A foodstuff according to claim 118, wherein the foodstuff is a meat product or a pet food.

121. A foodstuff according to claim 118, wherein the polyketide is selected from the group consisting of: a difficidin, a macrolactin, a bacillaene and combinations thereof.

122. A foodstuff according to claim 118, wherein the composition further comprises one or more additional components, wherein preferably the additional component is a carrier, adjuvant, solubilizing agent, suspending agent, diluent, oxygen scavenger, antioxidant and/or a food material.

123. A foodstuff according to claim 118, wherein the polyketide is selected from the group consisting of: a difficidin, a macrolactin, a bacillaene and combinations thereof.

124. A foodstuff according to claim 118, wherein the composition further comprises one or more additional anti-contaminant agents.

125. A method of producing a human foodstuff or a pet food comprising applying an anti-contaminant composition comprising a cell-free fermentation product of one or more Bacillus subtilis strains selected from the group consisting of: LSSA01, 22C-P1, BS18, 15A-P4, 3A-P4, ABP278, and BS 2084; wherein said fermentation product comprises one or more compounds selected from the group consisting of: a polyketide, a lipopeptide, a bacillibactin, a bacilysin, an anticapsin, a plantazolicin, a LCI, a homologue of a plantazolicin and a homologue of a LCI to a human foodstuff or pet food; or one or more constituents of a human foodstuff or pet food.

126. A surface coating material comprising an anti-contaminant composition comprising a cell-free fermentation product of one or more Bacillus subtilis strains selected from the group consisting of: LSSA01, 22C-P1, BS18, 15A-P4, 3A-P4, ABP278, and BS 2084; wherein said fermentation product comprises one or more compounds selected from the group consisting of: a polyketide, a lipopeptide, a bacillibactin, a bacilysin, an anticapsin, a plantazolicin, a LCI, a homologue of a plantazolicin and a homologue of a LCI or a product having reduced and/or no microbial contamination as a result of carrying out the method of claim 100.


SEQUENCE LISTING (11 sequences)

SEQ ID NO: 1 - protein, 41 aa, Artificial Sequence
  plantazolicin
MTQIKVPTALIASVHGEGQHLFEPMAARCTCTTIISSSSTF

SEQ ID NO: 2 - protein, 41 aa, Artificial Sequence
  plantazolicin
MTKITIPTALSAKVHGEGQHLFEPMAARCTCTTIISSSSTF

SEQ ID NO: 3 - protein, 45 aa, Artificial Sequence
  plantazolicin
MITTTALPRAAAVTTTVYGEGLHLFEPMAARCTCSTVISTTCTWG

SEQ ID NO: 4 - protein, 46 aa, Artificial Sequence
  planatzolicin
MSTLINKLPPAVSTDSSKIVSEVQAFEPTAARCSCTTIPCCCCCGG

SEQ ID NO: 5 - protein, 46 aa, Artificial Sequence
  plantazolicin
MSTLISKLPPAVSTDSSKIVSEVQAFEPTAARCSCTTLPCCCCSGG

SEQ ID NO: 6 - protein, 92 aa, Artificial Sequence
  LCI
MKFKKVLTGSALSLALLMSAAPAFAASPTASVENSPISTKADAGINAIKLVQSPNGNFAASFVLDGTKWIFKSKYYDSSKGYWVGIYESVDK

SEQ ID NO: 7 - protein, 94 aa, Artificial Sequence
  LCI
MKFKKVLTGSALSLALLMSAAPAFAASPTASASAENSPISTKADAGINAIKLVQSPNGNFAASFVLDGTKWIFKSKYYDSSKGYWVGIYESVDK

SEQ ID NO: 8 - protein, 47 aa, Artificial Sequence
  LCI
AIKLVQSPNGNFAASFVLDGTKWIFKSKYYDSSKGYWVGIYEVWDRK

SEQ ID NO: 9 - protein, 81 aa, Artificial Sequence
  LCI
MFLLVFLCCLHLVISSHTPDESFLCYQPDQVCCFICRGAAPLPSEGECNPHPTAPWCREGAVEWVPYSTGQCRTTCIPYVE

SEQ ID NO: 10 - protein, 94 aa, Artificial Sequence
  LCI
MKFKKVLTGSALSLALLMSAAPAFAASPTASASVENSPISTKADAGINAIKLVQSPNGNFAASFVLDGTKWIFKSKYYDSSKGYWVGIYESVDK

SEQ ID NO: 11 - protein, 94 aa, Artificial Sequence
  LCI
MKFKKVLTGSALSLALLMSAAPAFAASPTASASAENSPISTKADAGINAIKLVQSPNGNFAASFVLDGTTWIFKSKYYDSSKGYWVGIYESVDK